(19) United States
(12) Patent Application Publication
(10) Pub. No.: US 2012/0065802 A1
(43) Pub. Date: Mar. 15, 2012

(54) SYSTEM AND METHODS FOR AUTOMATIC POWER MANAGEMENT OF REMOTE ELECTRONIC DEVICES USING A MOBILE DEVICE

(75) Inventors: Rene Seeber, Kassel (DE); Josef Brunner, Muenchen (DE); Mark Davidson, Mableton, GA (US)

(73) Assignee: JOULEX, INC., Atlanta, GA (US)

(21) Appl. No.: 13/232,603

(22) Filed: Sep. 14, 2011

Related U.S. Application Data
(63) Continuation-in-part of application No. 13/092,670, filed on Apr. 22, 2011.
(60) Provisional application No. 61/382,764, filed on Sep. 14, 2010.

(51) Int. Cl. G06F 1/26

(52) U.S. Cl. 700/295

(57) ABSTRACT

Systems and methods for managing and monitoring a plurality of disparate electrical and/or electronic devices located at various geographically distributed facilities remotely on the basis of an instantaneous location of a user's mobile device that is associated with one or more electrical and/or electronic devices. Remote management of these devices involve transmitting information corresponding to a current location of a user's mobile device that will be managing the devices, without the need for installing additional software on the devices. An energy management system installed within an organization's infrastructure communicates with users' mobile devices and executes power management commands on the electrical and/or electronic devices, for purposes of monitoring and managing several operational aspects related to such devices. Such power management commands can be on-demand dynamic commands provided by a user's mobile device, or predefined commands stored in the energy management system.

### CROSS-REFERENCE TO RELATED APPLICATIONS

This application is a continuation-in-part application, and claims the benefit of and priority under 35 U.S.C. §120 to U.S. patent application Ser. No. 13/092,670 filed Apr. 22, 2011 and entitled “Systems and Methods for Sustainable Energy Management, Monitoring, and Control of Electronic Devices.” In addition, the present application also claims benefit of and priority under 35 U.S.C. §119(e) of U.S. Provisional Patent Application No. 61/382,764, filed Sep. 14, 2010, and entitled “Automatic Power Management of Remote Electronic Devices Using a Mobile Device.” Both the above-referenced applications are hereby incorporated by reference as if set forth herein in their entireties.

### TECHNICAL FIELD

The present systems and methods relate generally to remote energy management of electronic devices, and more particularly to systems and methods that provide the ability to remotely control the energy consumed by network-connected devices and systems, including computers, VoIP phones, servers, routers, printers, copiers, HVAC systems, lighting systems, or any device or system connected to an information technology (IT) infrastructure, wherein remote energy management of electronic devices is performed according to a physical location of a mobile device.

### BACKGROUND

Providing and administering energy efficiency at buildings and facilities is a major concern for individuals and organizations. Sustained energy efficiency has a financial benefit by realizing reduced energy expenditure, and hence increased profitability and cost savings. In addition, reduced energy consumption has a societal benefit as it results in reduced greenhouse gas emissions and consequently lessens the detrimental effects of climate and ecological changes. Moreover, energy efficiency helps in saving natural resources to ensure secure and sustained energy supplies for the future.

Energy efficiency is commonly achieved by using energy-efficient devices and systems that consume less energy. For example, various kinds of commercially available electrical devices such as light bulbs, computers, monitors, laptops, printers, fax machines, photocopiers, televisions, phones, air conditioning units, washers, dryers, and several other such devices are commercially available that consume lower amounts of power as compared to their predecessor devices. However, as will be understood and appreciated, deploying energy efficient devices can involve an added cost burden to the device purchasers. This additional cost is largely due to the fact that such devices are manufactured with specialized electrical components that are technologically advanced and thereby consume less power, but are also more expensive than common, less-technically-advanced devices. Consequently, large enterprises and organizations that wish to achieve energy efficiency through a full-scale deployment of energy efficient devices will face an enormous cost upfront, and it may take a substantial amount of time to recoup the upfront cost of the devices through the cost savings they provide. Furthermore, even if such devices are deployed, this would be highly ineffective and inconvenient from an operational perspective as a large number of pre-existing devices that were fully functional would need to be replaced, transitioned, and/or potentially discarded.

Recently, the restructuring and deregulation of the global power utility industry has resulted in significant competitive, technological and regulatory changes. Independent power producers, power marketers and brokers have added a new and significant dimension to the task of managing and maintaining a reliable power supply system that also has potential for cost savings. These days, even private households are now able to produce their own self-generated electricity—for example, from solar panels or alternative power generation systems, and feed them into their power supply grid. Thus, a comprehensive and detailed energy efficiency analysis is fundamental to energy efficiency management. Further, such analysis will identify and assess the saving potential across private households and corporate organizations. The completeness of this assessment is of specific importance in order to discover, determine, and to evaluate all available saving potentials and to set right priorities of actions. For example, different saving potentials can be harnessed by using different kinds of electrical equipment in combination with different sources of electrical energy (hydroelectric, nuclear, coal, natural gas, etc.) supplied by different power utilities each having a different energy pricing (measured in price/kilowatt-hour). From this systematic analysis, various energy efficiency projects are developed, which lead to tremendous reduction of the overall energy consumption as well as optimized energy efficiency management methodologies. These projects are of huge benefit to large-sized corporate organizations and enterprises with business divisions, offices, factories and plants distributed worldwide.

Several enterprises and corporate organizations have establishments that are located at different places, e.g., call centers (for handling customer service requests), data processing centers, office buildings, satellite offices or campuses, etc., that are geographically distributed. It is important for an IT manager working at such an organization to perform administrative functions on various types of electrical equipment installed at the facilities. For example, different types of electrical equipment, such as racks and servers, store data at such establishments. These racks and servers typically need to be monitored for consumed electrical power, and if one of these components fails or produces excess heat due to prolonged operation, it may need to be turned off.

Conventional systems for energy management utilize installation of specific software agents on each piece of electrical equipment to be monitored. Sometimes, this installation step is performed manually for each item of equipment. At other times, it is automated via a centralized installation server that manages installation of the software agent on various equipment. In either case, the cost of installation (and subsequent maintenance and upgrade) is typically proportional to the number of devices or pieces of equipment that require monitoring and management. For a large organization, this results in a significant overhead in cost and resources. Furthermore, if additional equipment is installed in such a facility, reconfiguration of every item of equipment in that facility must be performed, which is highly inefficient and cumbersome.

To complicate matters, most facilities have a variety of types of electronic or electrical equipment that is maintained within the facility's IT infrastructure, such as desktop computers, servers, Voice-over-Internet-protocol (VoIp) phones, laptops, routers, HVAC systems, lighting equipment, etc. Each of these devices may be of a different type, brands, or model. For instance, a given organization or facility might utilize DELL™ desktops, COMPAQ™ desktops, IBM™ servers, CISCO™ VoIp phones, APPLE™ laptops, HP™ laptops, CISCO™ switches, NETGEAR™ routers, and various other devices from a variety of manufacturers. Even for a particular brand, there could be several models. Further, entities, corporate organizations and enterprises have business divisions, offices, factories and plants distributed worldwide. In such a scenario, an organization can realize cost savings by intelligently monitoring, analyzing, and managing the power consumed by various network connected devices. A very basic example would be to turn off all unused desktop computers and printers after office hours when they are not in use. Another example would be using an energy management system to measure energy consumption of various devices and map them to their corresponding organizational units. Therefore, it will be appreciated that for the above-mentioned scenarios, a remote, centralized management/administration system that performs measurement/monitoring of energy usage of a wide variety of devices that are distributed across different geographical locations would be a useful technological solution.

Additionally, in many scenarios, corporate organizations desire the ability to control, monitor, and manage the electronic devices of employees at their facilities in a remote manner based on actual use of the electronic devices by the employees in real time. For example, an employer may desire that an employee's office electronic equipment (e.g., computer, printer, VoIP phone, lights, etc.) be turned off when the employee has been away from his office for a period of time (e.g., when the employee is at an out-of-office meeting our out to lunch). Or, alternatively, individual employees may desire to control their physical facility equipment in a remote way. For example, an employee may desire that all of his or her facility equipment be turned on as the employee approaches the office facility in the morning, and automatically turned off at night when the employee has left the facility. Therefore, a “one-solution-fits-all” approach to regulating facility devices across an organization based on wide-sweeping rules may not be advantageous in all circumstances. Thus, it would be beneficial to have a location-based approach to an organizational energy management system that is flexible to accept on-demand requests for power management of electronic devices from persons based on their physical location.

Moreover, as will be appreciated further, the unprecedented world-wide spread of the use of mobile devices and applications has had a significant effect in the ways in which people communicate. As will be understood, most of the mobile smart phones of today are equipped with a location-based sensor such as a global-positioning systems (GPS), etc. These mobile devices are typically able to provide information about the location of their user, such as the physical location of an employee in relation to his or her office building. Aside from mobile phones, various other location-based technologies such as that used in smart cards for entry into buildings, provide information about the location of their user. However, integrating such location-based technologies with an organizational energy management system, which would allow for remote power management of electronic devices based on the physical location of a user (e.g., via a user's mobile device, a user's contactless electronic data item such as a building entry card, a locator chip, etc.), involves a very challenging design, and has not been heretofore addressed.

Therefore, there is a long-felt but unresolved need for a system or method that enables, in virtually real time, monitoring, management, analyzation, and control of a plurality of devices across numerous facilities distributed in multiple geographical locations. Moreover, there is a need for such a system to support multiple device types, brands, vendors and manufacturers, and not remain specific to certain devices, or manufacturers. At the same time, such a centralized, enterprise-wide system should be flexible to adapt to preferences of individual users and accept on-demand power management instructions relating to a user's location without the need for installing additional software on the end devices that are being controlled. Further, the system should enable quick and easy setup and seamless integration with existing devices and infrastructure, and should also have the capability for automatic discovery of new electronic equipment when the equipment is installed at a facility. The system should also provide detailed and comprehensive energy efficiency analysis reports in virtually real time, covering aspects of power consumed by various devices, different power sources, and from various power utilities.

### BRIEF SUMMARY

Briefly described, and according to one embodiment, aspects of the present disclosure generally relate to systems and methods for managing and monitoring (in real time as well as in non-real time) a plurality of electrical and/or electronic devices remotely via a consolidated system without the need for installing additional software on individual devices. According to one aspect of the present disclosure, and described in greater detail herein, an energy management system (EMS) is easily and efficiently installed either at a physical computer located in a facility or a virtual computer located in a cloud computing environment. According to another aspect of the present disclosure, one or more facilities that are to be controlled are connected to each other via a corporate Local Area Network (LAN) or Wide Area Network (WAN). Facilities that are controlled by embodiments of the EMS generally include a variety of discrete types of assets and devices that consume energy or power.

According to one embodiment of the present disclosure, aspects of the present EMS manage, monitor, and control assets housed at one or more facilities. This includes several tasks, for example, retrieval of various kinds of data regarding the assets, including measurement of power consumed by various assets located at different geographically distributed facilities. Furthermore, aspects of the present disclosure relate to sophisticated methods of processing various kinds of asset data retrieved from different type of assets associated with different vendors, makes, and models, for monitoring and management of such assets via a single interactive dashboard interface. According to another embodiment of the present disclosure, management of such a wide variety of distributed assets further includes applying various policies and rules for purposes of providing energy efficiency.

According to one embodiment, aspects of the present EMS additionally provide the ability to remotely control the energy consumed by network-connected assets (devices and systems) based on the physical location of a user's mobile device. As will be understood, such remote location-based energy management involves creating an association between a user's mobile device and assets that will be controlled by a user's mobile device. Also, remote location-based energy management, according to one aspect, involves communication of power management commands by a user's mobile device to an energy management system (EMS) installed at a facility, and the EMS thereafter applying (executing) such power management commands on the associated assets. In another aspect, location information of a user's mobile device is communicated to an EMS, and the EMS utilizes the location information in connection with predetermined energy management policies to control the power state of the user's assets located at a facility.

Additionally, aspects of the present disclosure are directed to generating various reports containing operational information relating to the assets, actual (and projected) cost savings and greenhouse emissions, as a consequence of applying various policies and rules. Moreover, such reports provide detailed as well as summarized analytics related to energy management that are utilized by organizations (entities) and private individuals to develop future strategies for optimum energy management.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment, and wherein:

FIG. 1 illustrates a high-level overview of an embodiment of an energy management system (EMS).

FIG. 2 shows an exemplary EMS architecture comprising various software modules, engines and other similar elements, according to one embodiment of the present system.

FIG. 3 shows a sequence diagram illustrating computer-implemented method steps involving various components of an embodiment of the present system and their interactions with each other.

FIG. 4 is a flowchart showing a summary of high-level, computer-implemented method steps illustrating overall EMS processes, performed by various software modules and engines of the EMS, according to one embodiment of the present system.

FIG. 5 consisting of FIG. 5A and FIG. 5B is a flowchart showing an exemplary computer-implemented process for configuring an embodiment of the EMS (involving integrating devices with the EMS).

FIG. 6 consisting of FIG. 6A and FIG. 6B is a flowchart showing an embodiment of computer-implemented steps performed by an EMS in order to monitor and retrieve information related to power consumed by various devices.

FIG. 7 consisting of FIG. 7A and FIG. 7B is a flowchart showing computer-implemented steps involved in executing various policies for management of energy efficiency for devices, according to one embodiment of the present system.

FIG. 8 is an exemplary policy table (stored in an EMS database) illustrating various policies for management of energy efficiency for devices, according to one embodiment of the present system.

FIG. 9 is an exemplary device table (stored in an EMS database) comprising several attributes related to devices, involved in performing management of energy efficiency for devices, according to one embodiment of the present system.

FIG. 10 is an exemplary power table (stored in an EMS database) comprising power and energy profile information for various devices, according to one embodiment of the present system.

FIG. 11 consisting of FIG. 11A and FIG. 11B includes screenshots of exemplary EMS interfaces showing overviews of management of energy efficiency for devices, according to one embodiment of the present system.

FIG. 12 consisting of FIG. 12A, FIG. 12B and FIG. 12C includes screenshots of exemplary EMS interfaces for creating policies for management of energy efficiency for devices, based on several conditions related to time, location, etc., according to one embodiment of the present system.

FIG. 13 is a screenshot of an exemplary EMS interface for management of energy efficiency for devices, according to one embodiment of the present system.

FIG. 14 is a screenshot of an exemplary EMS interface showing summary reports and statistics obtained by performing management of energy efficiency for devices, according to one embodiment of the present system.

FIG. 15 consisting of FIG. 15A, FIG. 15B, FIG. 15C, and FIG. 15D are screenshots of exemplary EMS interfaces for configuring various settings/options for an EMS, according to one embodiment of the present system.

FIG. 16 illustrates a high-level overview of an exemplary environment wherein automatic remote power management of various electrical devices housed in a facility is performed based on the location of a user's mobile device, in accordance with an alternative exemplary embodiment of the disclosure.

FIG. 17 shows an exemplary EMS architecture comprising various software modules, engines and other similar elements, wherein the EMS exemplarily manages one or more electronic devices housed in a facility and automatic remote power management of such devices is performed based on the instantaneous location of a user's mobile device, in accordance with an alternative exemplary embodiment of the disclosure.

FIG. 18 consisting of FIG. 18A, FIG. 18B, and FIG. 18C illustrates different spatial geometries indicative of exemplary active regions at which automatic remote, power management of devices can be performed by a user's mobile device.

FIG. 19 shows a sequence diagram illustrating computer-implemented method steps involving various components of an embodiment of the present system and their interactions with each other, for purposes of automatic remote power management of devices housed in a facility based on the instantaneous location of a user's mobile device, in accordance with an alternative exemplary embodiment of the disclosure.

FIG. 20 consisting of FIG. 20A and FIG. 20B, is a flowchart showing a summary of high-level, computer-implemented method steps illustrating an exemplary EMS processes, performed by various software modules and engines of the EMS, for purposes of automatic remote power management of devices housed in a facility based on the instantaneous location of a user's mobile device, in accordance with an alternative exemplary embodiment of the disclosure.

FIG. 21 consisting of FIG. 21A, FIG. 21B, and FIG. 21C is a flowchart showing steps of an exemplary computer-implemented method for processing information received from an user's mobile device, in accordance with an alternative exemplary embodiment of the disclosure.

FIG. 22 is a flowchart showing an embodiment of computer-implemented steps performed by a user's mobile device in order to perform location-based energy management, in accordance with an alternative exemplary embodiment of the disclosure.

FIG. 23 is an exemplary device table (stored in a mobile device memory or database) showing various active region parameters utilized to perform location-based energy management of assets housed in a facility by a user's mobile device, in accordance with an alternative exemplary embodiment of the disclosure.

FIG. 24 is a flowchart showing computer-implemented steps performed by a registration service in an exemplary association process involving creating associations between devices housed in a facility with a user's mobile device, in accordance with an alternative exemplary embodiment of the disclosure.

FIG. 25 is a flowchart showing an embodiment of computer-implemented steps performed by a user's mobile device in order to perform an exemplary association process, in accordance with an alternative exemplary embodiment of the disclosure.

FIG. 26 is an exemplary association table (stored in an EMS database) illustrating associations created between devices with a user's mobile device.

FIG. 27 is an exemplary device table (stored in an EMS database) comprising several attributes related to devices housed in a facility, for purposes of automatic remote power management of devices housed in a facility based on the instantaneous location of a user's mobile device, in accordance with an alternative exemplary embodiment of the disclosure.

FIG. 28 is an exemplary policy table (stored in an EMS database) illustrating various policies for management of energy efficiency for devices, including policies that allow automatic remote power management of devices housed in a facility based on the instantaneous location of a user's mobile device, in accordance with an alternative exemplary embodiment of the disclosure.

FIG. 29 is an exemplary screenshot of an association process prior to creating associations between devices housed in a facility with a user's mobile device, from the perspective of a registration service, in accordance with an alternative exemplary embodiment of the disclosure.

FIG. 30 is an exemplary screenshot of an association process prior to creating associations between devices housed in a facility with a user's mobile device, from the perspective of a user's mobile device, in accordance with an alternative exemplary embodiment of the disclosure.

FIG. 31 is an exemplary screenshot of a user's mobile device showing various configuration options for performing remote power management of devices housed in a facility based on an instantaneous location of a user's mobile device, in accordance with an alternative exemplary embodiment of the disclosure.

FIG. 32 is an exemplary screenshot of a user's mobile device after being associated with devices (housed in a facility) with a user's mobile device, in accordance with an alternative exemplary embodiment of the disclosure.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims.

### DEFINITIONS/GLOSSARY

Action: an activity or task that is executed under the direction of an energy management system (EMS) in connection with performing energy efficiency management or monitoring of an asset. Examples of actions performed on assets include, but are not limited to, changing the power state of the asset, viz. from power on mode to hibernate mode, notifying an EMS administrator via email regarding the change of the power state of an asset, running a script written by a programmer, etc.

Active Region: a geographic, physical, spatial, or temporal area that, when a user's mobile device is contained therein, triggers an action with respect to the user's assets.

Active Region Parameters: data, information, or other criteria defining to the specifics of a given active region. Generally, active region parameters correspond to physical boundaries that define an active region (e.g., latitude and longitude coordinates, geometric shapes, virtual areas, rooms within a building, cities, counties, city blocks, etc.). Active region parameters may also include power management commands or actions to be taken with respect to certain assets. Generally synonymous with active region information.

Active Region State: an indication of whether or not a mobile device is physically located within an active region. Generally, an active region state is defined by “INSIDE” or “OUTSIDE” (indicating whether or not the mobile device's physical location is inside or outside of an active region), “YES” or “NO” (again indicating that “yes,” the mobile device is within an active region, or “no,” the mobile device is not within an active region), or other similar indicators.

Asset: electrical or electronic equipment that is connected to an information technology (IT) infrastructure. Generally represents a unique network-attached component which is managed by an EMS. For example, assets may include, but are not limited to, laptop computers, desktop computers, servers, mainframe computers, Voice-Over-Internet-Protocol (VoIP) phones, routers, switches, printers, copiers, scanners, lighting equipment (bulbs, lamps, fluorescent tubes, etc.), HVAC equipment, fans, generators, motors, electrical machines, etc. An asset may also comprise a device that can be controlled over an IT network. Generally, assets are identified with several attributes, for example, a device identifier, a device type, a network address, a location, a business unit, power state, power consumed, etc. Information relating to assets within a facility or facilities is generally maintained within an asset management system. Generally synonymous with device.

Asset Connectors: a suite of software tools in an EMS that is used to discover and import information relating to assets into the EMS, with the help of one or more asset management systems. An exemplary function of an asset connector includes importing information relating to all WINDOWS™ computers from an asset management system, such as “Active Directory”, into the EMS. Generally synonymous with asset connector modules.

Asset Management System: a suite of asset management tools provided by an existing network system and/or facility infrastructure. For example, asset management systems generally include elements of software and hardware that manage information relating to assets or devices operating in a facility. Examples of asset management systems include, but are not limited to, MICROSOFT™ Active Directory, or CISCOWORKS™.

Association Information: data or attributes used to create an operative link between a user's mobile device and the user's assets. Examples of association information include, but are not limited to: information identifying a user's mobile device, a network address of the user's EMS, a network address (e.g., URL, IP address, MAC address, I2C bus address) or any similar identifier which can be used to identify and access devices via a network, etc. In some embodiments, association information may comprise predefined active regions.

Business Unit: a division or unit of a corporation or entity associated with performing one or more functions. Examples of different types of business units include, but are not limited to, Sales, IT, Engineering, Marketing, etc.

Condition: a mode of operation or working state of an asset that is used to determine one or more action(s) to be taken with respect to the asset. Generally, conditions can be based on date/time, asset type, applications or programs running/not running on assets, custom scripts written by a programmer, business units, asset locations, etc. A rule (defined below) generally includes one or more conditions.

Database Connector: a standard software interface that allows an application to have access to data made available by an online service, a database management system (MS SQL, ORACLE™, FIREBIRD™, MYSQL™, etc.) or a standard Internet service such as email. Database Connectors allow programmers to treat disparate data sources as if they were sets of database tables. Typically, they are made to be independent of programming languages, database systems, and operating systems.

Device: Generally synonymous with Asset.

Device Information: data or attributes pertaining to a specific device within a facility. Examples of device information may include, but are not limited to, device type, device model number, manufacturer, network name/address associated with device, location of device, business unit associated with the device, operating system running (if any) on the device, etc. Generally synonymous with asset information.

Device Profile: an abstract representation comprising several attributes of information associated with an asset or device as obtained using a combination of asset management systems, asset connectors, and device proxies. Generally, device profiles are stored in an EMS database to enable subsequent retrieval of information and actions with respect to the device. Examples of different attributes of information may include, but are not limited to, device type, device model number, manufacturer, network name/address associated with device, location of device, business unit associated with the device, operating system running (if any) on the device, etc.

Device Proxy: a software tool or module in an embodiment of the EMS that implements low-level communication protocols for communication with discrete types of devices or asset management systems. Examples of functionalities of device proxies include, but are not limited to, support for protocols such as WINDOWS™ Management Instrumentation (WMI) to communicate with WINDOWS™ machines, support for Secure Shell (SSH) for LINUX™ and/or APPLE™ machines, and other such protocols. Generally synonymous with device communications module.

Energy Information: data or information relating to energy characteristics of a given electronic device. Examples of energy information include, but are not limited to, power consumed by a device, energy state of the device (e.g., on mode, off mode, standby mode, hibernate mode, startup mode, shutdown mode), utilization of the device (e.g., high usage, idle usage, etc.), and the like. Generally synonymous with current energy information.

Energy Pricing Rate: price of energy as charged by a power utility company, expressed in price/kWh, where kWh is an abbreviation for kilowatt hour.

Energy Management System (EMS): a system constructed as described in this document, that enables remote energy efficiency management, monitoring, control, and analysis of a collection of assets that are housed in one or more facilities.

Facility: an abstraction that represents a collection of one or more assets housed together. For example, a facility may include a hospital, university, airport, one or more business units, a factory, a laboratory, a data center or some other similar site, and may also include one or more buildings (or floors inside a building) that houses assets. A facility may comprise a virtual or physical segregation of assets. Generally, one or more facilities are connected to an EMS via an IT network.

IP: abbreviation for Internet Protocol (IP), which is a communications protocol that enables delivery of data across a digital network.

Location: a physical (geographical) place where a facility is located. A location may include a continent, country, city, town, street, building, room, or any other geographical place. A location may also represent the physical (geographical) place where a user's mobile device is located.

Location Information: data or information relating to the physical location of something, generally an EMS user's mobile device. Examples of location information include, but are not limited to, latitude and longitude coordinates, coordinates on a grid or map, certain rooms or areas within a facility, cities, counties, states, countries, and the like. Location information also may include an indication whether or not a mobile device is physically within an active region. Generally synonymous with location-based information.

Mobile Device: a device associated with a user that provides location information about the user and/or device. Generally, information relating to a mobile device's real time physical location is used to perform automatic remote power management of assets that are housed in a facility and associated with a user of the mobile device. Examples of mobile devices include, but are not limited to, mobile phones, cellular phones, “smart” phones, personal digital assistants (PDAs), tablet computing devices, building entry cards, intelligent employee name badges, etc. Generally synonymous with remote control device.

Policy: a collection of one or more rules (defined below) relating to management and/or control of one or more electronic devices. Sometimes synonymous with rule and energy management policy.

Power Management Command: a pre-determined power management instruction provided on-the-fly to assets housed in a facility, either by an energy management system (such as the EMS) or by a user's mobile device (defined below), with the help of location-based technologies via users' mobile devices. Generally speaking, power management commands represent the preferences of individual users or corporate organizations to regulate the power consumption of the assets associated with individual users. Generally synonymous with command.

Power Profile: a set of information attributes pertaining to power usage of an asset, as obtained using a combination of asset management systems, asset connectors, and device proxies. Examples of different attributes of information include, but are not limited to, real-time power consumption of device, duration of time for which a device has been operational, power state of device (on/off/hibernate modes), and various other power-related details.

Rule: an instruction to conduct a specific action relating to one or more assets depending on satisfaction of a set of conditions. For example, rules may be used to automatically change the power state of an asset depending on the satisfaction of various predetermined conditions. Generally, rules are created by an EMS user or system administrator to accomplish various energy management goals within an organization and/or facility. In on case, rules can have mutual interdependencies. Rules generally include at least one condition and one corresponding action, but may include a variety of conditions and/or set of actions. Generally, rules for an asset are executed according to a pre-specified sequence, before moving on to a next asset specified in the rule. Examples of rules include, but are not limited to, hibernate all assets during lunch hour and on weekends, turn off power for assets at a specific business unit for a predetermined time interval, send an email communication to an EMS user when a given device is manually activated, hibernate or turn off a given device if its power output eclipses a predefined level, and numerous others.

Software Agent: a software program (sometimes called a service or daemon) that is installed and runs on an IP-enabled device for collecting information and transferring it over a network to a central location, typically according to a standard format so that it can then be collected over the network from the central location.

VoIP: abbreviation for Voice-Over-Internet-Protocol. VoIP is a family of Internet technologies, communication protocols, and transmission technologies for delivery of voice and/or multimedia data over Internet Protocol (IP) networks.

Widget: a reusable tool used in graphical user interfaces, usually for the purposes of customization of displayed information on an interface.

### OVERVIEW

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

Aspects of the present disclosure generally relate to systems and methods for managing and monitoring a plurality of assets (in real time as well as in non-real time) using an energy management system (EMS). Additional aspects relate to easily and efficiently installing (for example, with a simple plug-and-play mechanism) an EMS to manage, monitor, and control pre-existing assets at one or more facilities. Also, aspects of the present disclosure relate to normalizing asset information across varying vendors, makes, and models of assets that are located at various geographically distributed facilities, for management of heterogeneous, distributed assets via a single interactive dashboard interface. Additionally, aspects of the present disclosure relate to remote management and control of power consumed by assets located at various geographically distributed facilities on the basis of an instantaneous or real-time location of a user's mobile device that is associated with one or more assets housed in a facility. Further, aspects of the present disclosure are directed to generating various reports containing operational information relating to the assets, actual (and projected) cost savings and greenhouse emissions based on actions taken with respect to the assets, and analytics related to energy management that are utilized by organizations (entities) and private individuals to develop strategies for optimum energy efficiency management.

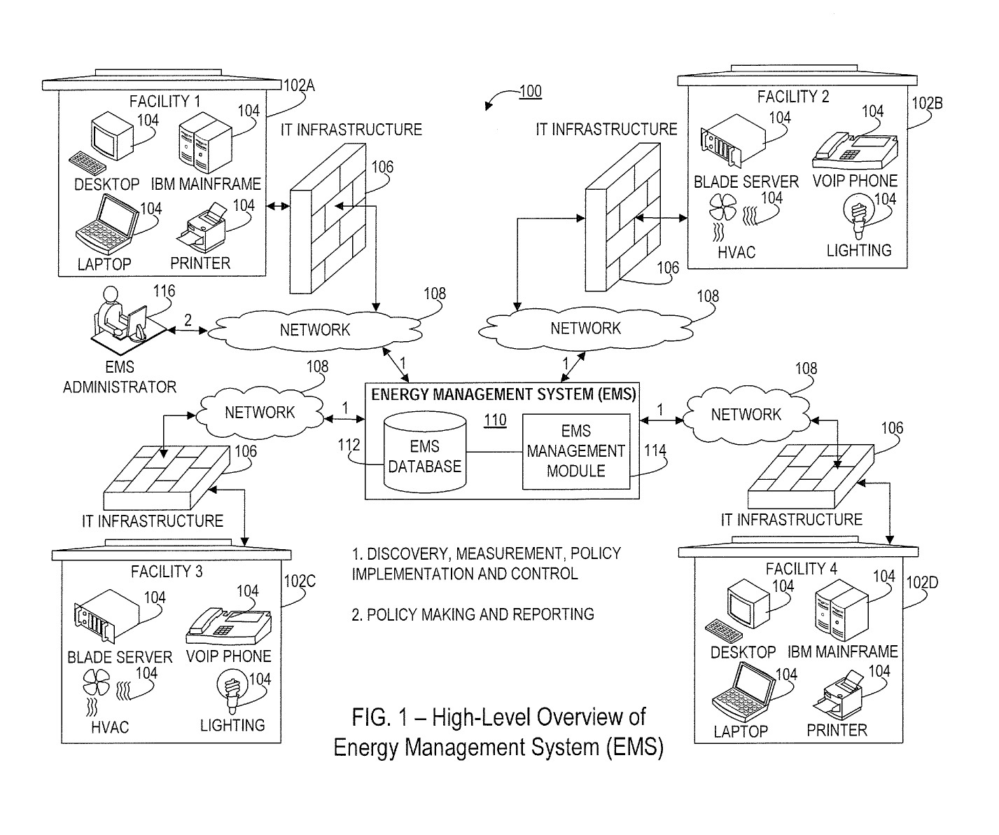

Referring now to the figures, FIG. 1 illustrates an overview 100 of an embodiment of an energy management system (EMS) 110 in an exemplary environment, constructed and operated in accordance with various aspects of the present disclosure. According to one exemplary embodiment, an organization has multiple facilities 102A, 102B, 102C and 102D at different geographical locations. Such facilities are interconnected via network(s) 108. According to the embodiment shown, the EMS monitors, manages and controls power consumed by assets 104 housed in facilities 102A, 102B, 102C and 102D via a network 108. As will be understood and appreciated, these facilities could be co-located at the same geographic location, for example, the facilities could indicate various floors in a building, or they may be distributed geographically at various locations. For example, a facility could be in Atlanta, another facility could be in Tokyo, and so on.

Generally, facilities may include airports, hospitals, universities, military bases, government structures, communications service installations, data processing centers, office buildings, scientific laboratories, sewage pumping stations, retail outlets, residential complexes, private homes, and other similar facilities. A facility usually houses multiple electrical or electronic assets 104 belonging to different device types, brands, vendors and manufacturers, connected to an IT infrastructure 106. As shown, for example, in FIG. 1, hypothetical facility 102A includes a desktop, an IBM™ mainframe computer, a laptop and a printer. A facility 102B comprises a blade server, a VoIP phone, a HVAC system and lighting equipment. Hypothetical facilities 102C and 102D include various other types of equipment and devices. As will be understood, various numbers and types of electrical and electronic devices can be housed in a facility, and there is no limitation imposed on the number of devices, device types, brands, vendors and manufacturers that may be included within an organization or the organization's facilities. Further, no limitation is imposed on the number of facilities that can be controlled by the EMS, or the locations of such facilities.

Additionally, as will be understood, many types of assets contain central processing units (CPU's) or microprocessors that are driven by multiple software programs and/or operating systems, for example in laptops, desktops, switches, routers, and other such assets. Examples of common operating systems include (but are not limited to) MICROSOFT WINDOWS™, APPLE™ OS X, or any UNIX/LINUX™ based operating system. It will be further understood that virtual assets, for example, PCs running multiple operating systems like WINDOWS 7™, LINUX™, WINDOWS XP™, etc. can also be monitored and managed by embodiments of the EMS.

According to one embodiment of the present disclosure, an EMS 110 is installed on a physical server or a general purpose computer in a facility 102 that is connected to an IT infrastructure 106. According to another embodiment, the EMS 110 is hosted on a virtual computer (connected to an IT infrastructure 106) housed in a facility 102. According to yet another embodiment, the EMS 110 resides in a third party server in a cloud computing environment and communicates with assets 104 housed in facilities 102 via networks 108. Although not shown in FIG. 1, it can be understood that IT infrastructure 106 at facilities 102 may include one or more gateways/firewalls that provide information security (from unwarranted intrusions and cyber attacks) to facilities and also ensures operating compatibility between an IT infrastructure 106 and networks 108. Generally, in those embodiments in which a firewall is used, the EMS operates behind the firewall of the organization.

As shown in FIG. 1, an embodiment of the EMS 110 includes an EMS management module 114 and an EMS database 112 for performing the tasks of energy efficiency management of a plurality of assets 104 housed in multiple geographically distributed facilities. Generally, the EMS management module 114 includes various software algorithms and sub-modules that enable energy efficiency management, including monitoring, analyzing and control of various aspects related to power or energy states of assets (on/off/hibernate), energy consumed by assets in real-time, effect of energy consumption on carbon emissions into the environment, cost as well as savings (if any) associated with energy consumption, and various other such aspects. In addition, in some embodiments of the EMS 110, a user can remotely manage and monitor (e.g., turn off, turn on, etc.) the power consumed by assets located at a facility based on the physical, remote location of a user's mobile device (e.g., cell phone). As will be understood, the EMS database 112 stores various types of device data, power consumption data, predetermined power management commands, location information, and other information relating to a user's mobile device and/or the EMS.

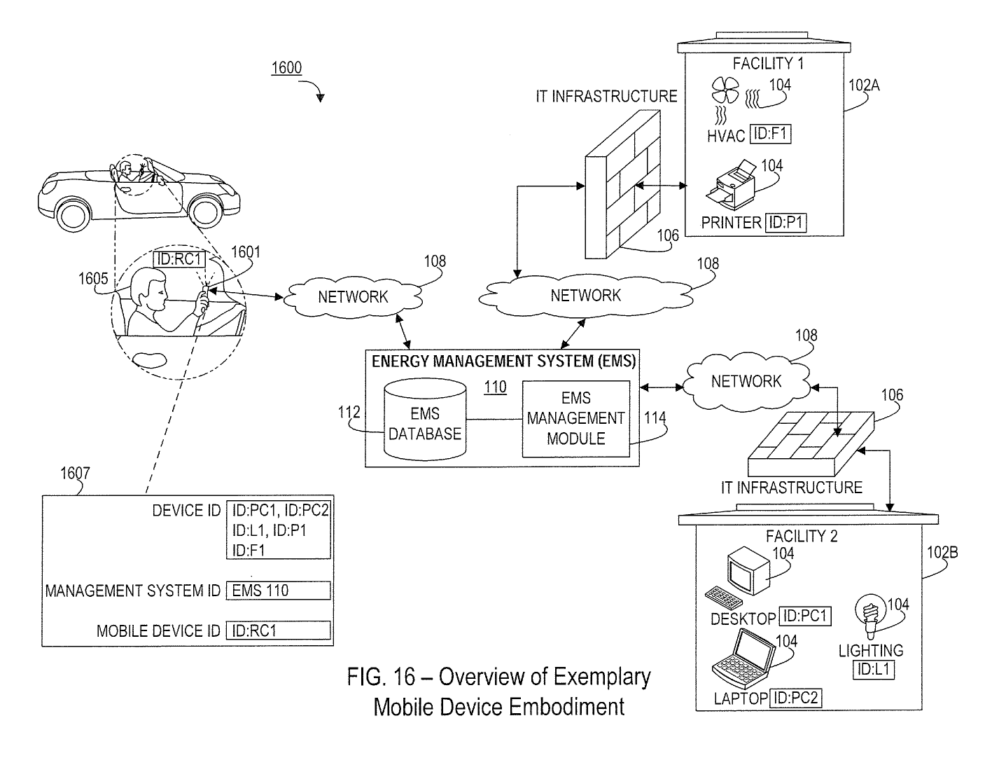

In an exemplary alternate embodiment of the disclosed EMS, aspects of the present disclosure relate to remote management of power consumed by assets located at various geographically distributed facilities, on the basis of an instantaneous or real-time location of a user's mobile device that is associated with the assets housed in a facility. Specifically, in some embodiments, the assets 104 of an EMS user may be turned off, turned on, and otherwise manipulated based on the physical location of the EMS user (and, specifically, the EMS user's mobile device). For example, a mobile device user's work assets located at the user's facility (e.g., place of employment) can be automatically turned on in the morning as the user approaches work, or automatically turned off in the evening as the user leaves the workplace. Such an exemplary embodiment and related aspects are discussed in greater detail herein and in connection with FIG. 16-FIG. 32.

As will be understood by a person skilled in the art, remote energy efficiency management generally entails two-way communication of power related information between assets 104 and the EMS 110. This communication proceeds over a network 108 using one or the other services, such as a Web-deployed service with client/service architecture, a corporate Local Area Network (LAN) or Wide Area Network (WAN), or through a cloud-based system. Information generally travels through an IT infrastructure 106 that is pre-installed at facilities 102. IT infrastructure 106 is retrofitted or pre-installed with asset management systems (not shown in FIG. 1) that provide a two-way communication link between individual assets 104 and EMS 110 that is external to individual assets 104. An asset management system typically includes information relating to an inventory of devices or assets maintained within the asset management system. (Further details of asset management systems are described in the glossary above and elsewhere in this document.) Typically, multiple assets 104 are connected to an asset management system. Generally, several asset management systems form an integral part of IT infrastructure 106 at facilities 102.

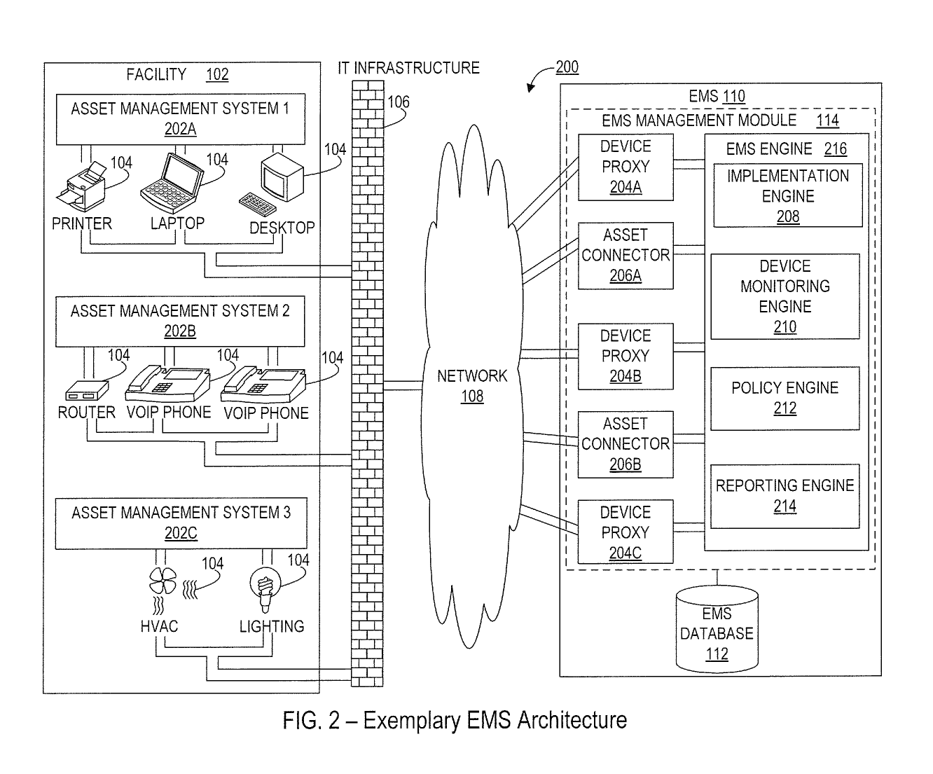

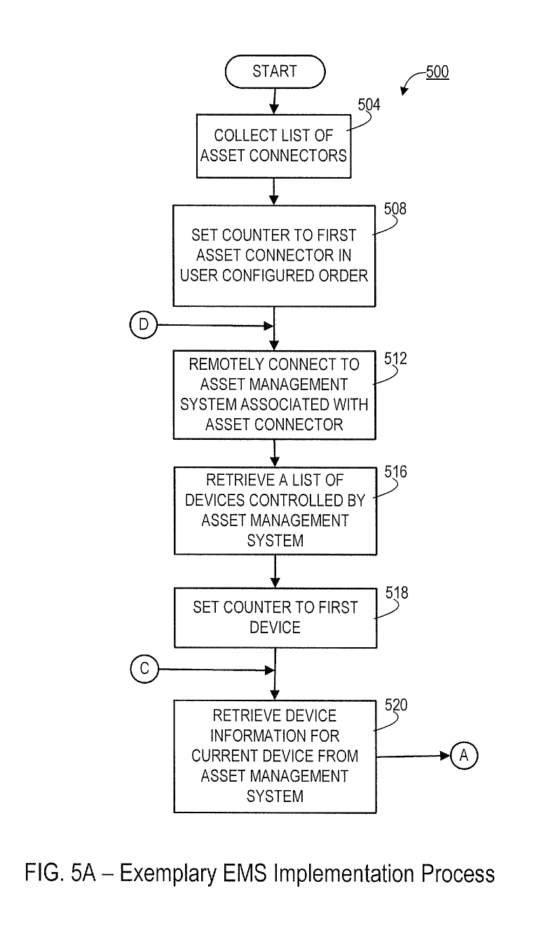

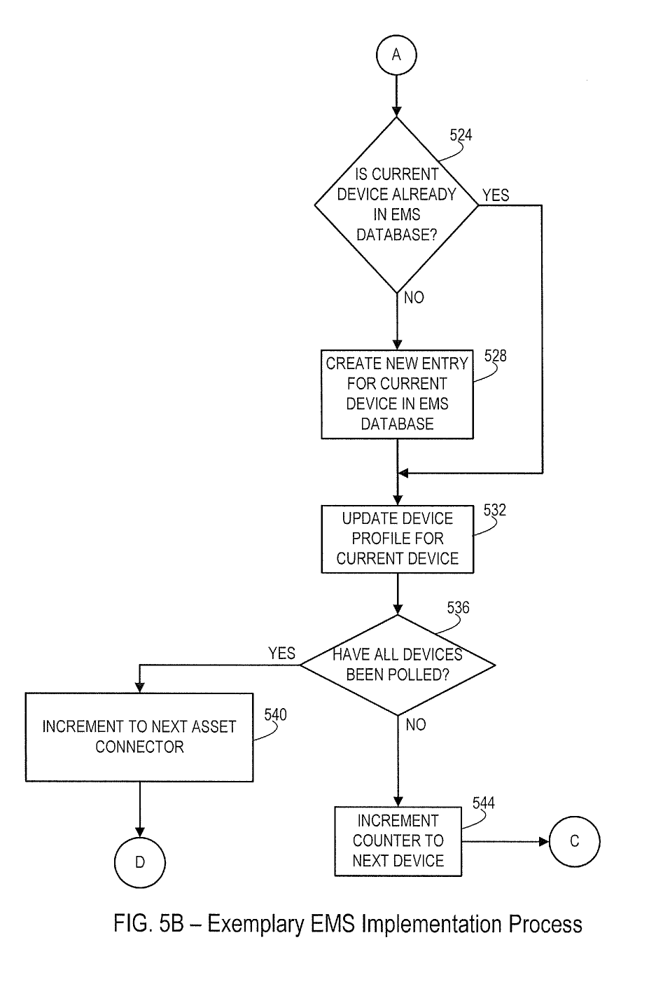

As mentioned above, the EMS 110 (specifically, various components of EMS management module 114) generally leverages functionalities of asset management systems in order to integrate individual assets 104 into an unified framework for the purposes of managing and monitoring individual assets 104. Architectural details of one embodiment of the EMS 110 showing constituent software modules/components of the EMS management module 114 are shown in FIG. 2, and flowcharts showing processes performed by the various modules are described in FIGS. 5A-7B (and described in detail below). According to one embodiment, in an exemplary facility 102, assets such as computers and printers are connected to an asset management system (as can be seen in FIG. 2) that controls such assets. Similarly, VoIP phones, routers/switches/access points are connected to another asset management system, and even further, HVAC, lighting equipment and fans are connected to yet another asset management system. Examples of commercially available and standard asset management systems used in most facilities 102, include (but not limited to) MICROSOFT™ Active Directory, MICROSOFT™ System Center Configuration Manager, ENTERASYS™ Netsight, CISCOWORKS™, and many other such systems. Furthermore, in case assets are not managed by standard asset management systems, such assets can be integrated manually or using database connectors (for example, using ODBC import) or file connectors (for example, using CSV file import) into an EMS 110.

In accordance with aspects of the present disclosure, when an embodiment of the EMS 110 is running under normal operating conditions, information is continually retrieved from assets, at periodic intervals of time by components of the EMS management module 114. Such information is utilized by components of EMS management module 114 to monitor various attributes of assets, for example, power consumed, duration for which an asset has been operational, power state of the asset (on/off/hibernate modes), and various other attributes related to the power profile of an asset. Additionally, as will be understood by a person of ordinary skill in the art, when the EMS 110 is first installed/configured, or when new assets are introduced for the first time, information retrieved from assets 104 is imported automatically into the EMS 110 via the asset management systems. This information is periodically synchronized/updated in order to ensure all device data is up-to-date. Examples of such information includes asset type, model number, manufacturer, network name/address associated with an asset, business unit and various such details and device profile attributes.

Information pertaining to individual assets, retrieved during configuration/implementation of the EMS as well as during asset monitoring, is stored in the EMS database 112 for subsequent processing relating to energy efficiency management those individual assets. During implementation of the EMS, such data is provided by asset management systems that provide a communication link for the EMS 110 to acquire data about individual assets 104. During monitoring and control of the assets, an asset management system may or may not be necessary (as described in greater detail below). As shown in FIG. 1, a summary of high-level functions (indicated by numbers “1” and “2”) performed by the EMS 110 include discovery of new assets, measurement of power consumed by newly introduced as well as pre-existing assets, implementation of various policies and monitoring/control of various assets.

After various assets 104 have been integrated into an embodiment of the EMS 110, management and control of individual assets 104 is effected by the EMS 110 by applying various pre-determined rules/policies that govern how and when assets 104 are to be controlled (e.g., turned off/on) in order to achieve energy efficiency, with the help of information stored in the EMS database 112. Actions associated with these rules are communicated to individual assets for executing on individual assets. For example, a rule could indicate turning off assets in a certain facility at 7 pm and turning them on at 6 am. Another rule could indicate turning off all assets at a specific business unit for a certain number of days. Yet another rule could indicate turning off laptops and desktops that are not running a particular application, for example programs like MICROSOFT™ OFFICE™ or MICROSOFT™ POWERPOINT™. Further, another rule could be to hibernate VoIP phones and workstations/servers on weekends. Another rule might include notifying a system administrator when a certain event occurs.

In one embodiment of the disclosed EMS, a rule involves the EMS receiving power management commands and/or location information from a user's mobile device. For instance, if a current location of a user's mobile phone (and likely the user) is beyond 2 (two) miles of a facility, and a predetermined rule indicated that certain assets in the user's facility be turned off when the user exceeds a 2-mile radius of the facility, then, for example, phones, laptops, and printers in the user's office inside the facility will be turned off once the user exceeds the 2-mile radius. As will be appreciated, one goal of such location-based functionality is to ensure that assets are not left on when a user is no longer at a facility. Another alternative goal would be to reduce “ramp-up” time as a user approaches a facility (i.e., by turning on all assets as the user nears a facility or enters a facility). As will be understood, applying such rules involves continuous or periodic monitoring of a current location of user's mobile phone. Such monitoring can be performed by location-based service providers, or by a GPS receiver embedded in the user's mobile phone, or by other similar location-detection devices.

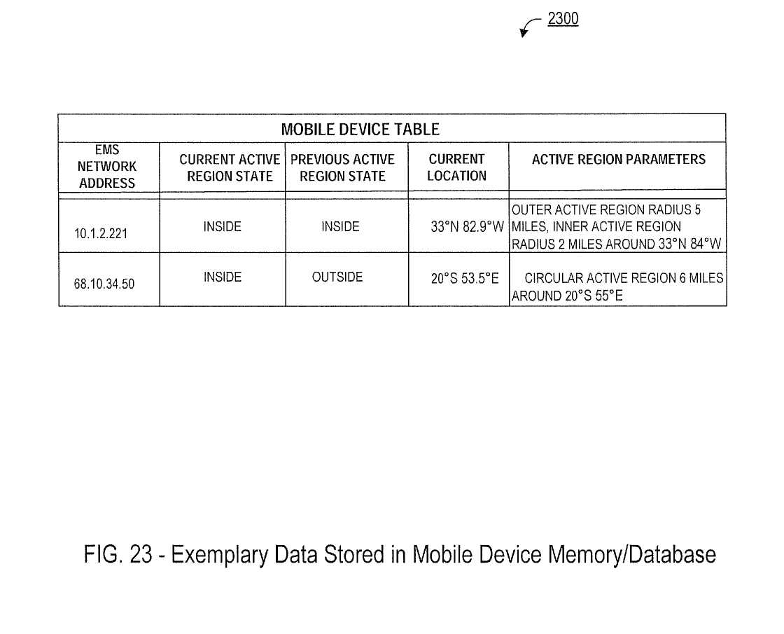

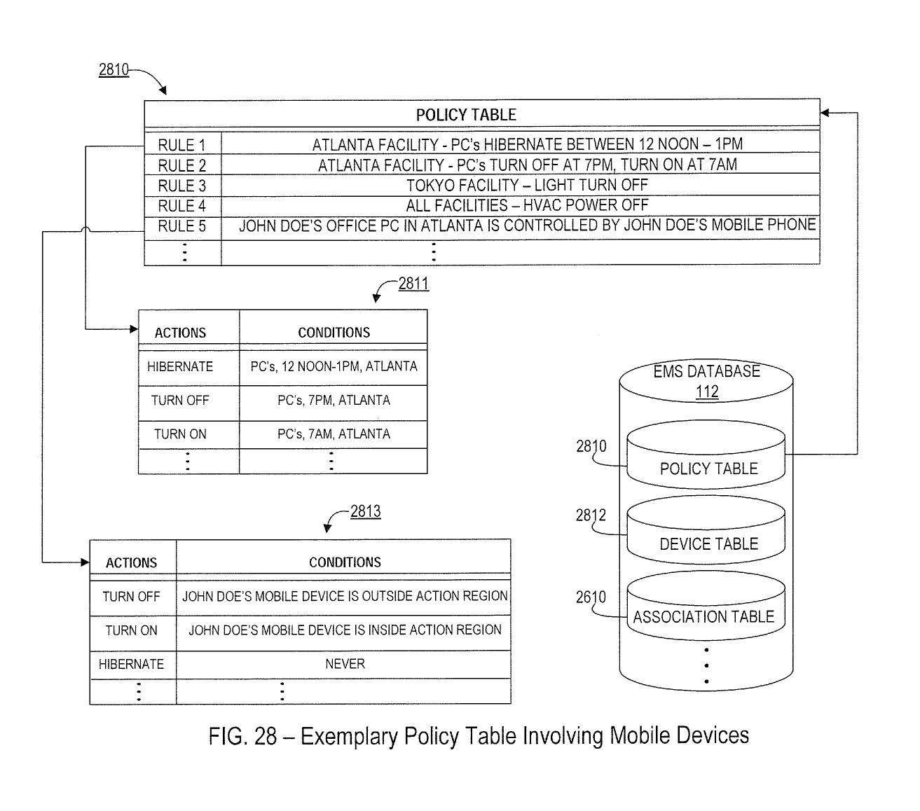

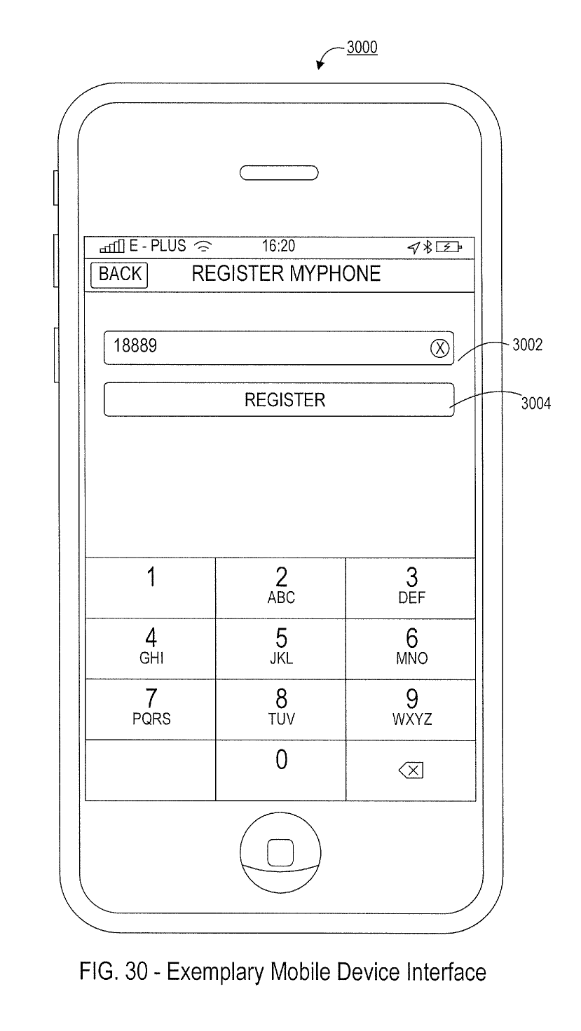

According to an embodiment of the EMS, a system user can remotely manage and monitor the energy consumed by assets housed in a facility and that are associated with a user's mobile device via the EMS. Such remote management and monitoring can be on the basis of on-demand power management commands transmitted by a user's mobile device, or rules that are pre-stored in the EMS that dictate how to manage power for assets that are associated with a mobile device. An exemplary policy table comprising rules that involve a user's mobile device is displayed in FIG. 28. Exemplary data tables illustrating power management information stored within a user's mobile device are shown and described in connection with FIG. 23. Exemplary screenshots of an interface of a user's mobile device in connection with remote management of assets are displayed in FIGS. 30-32.

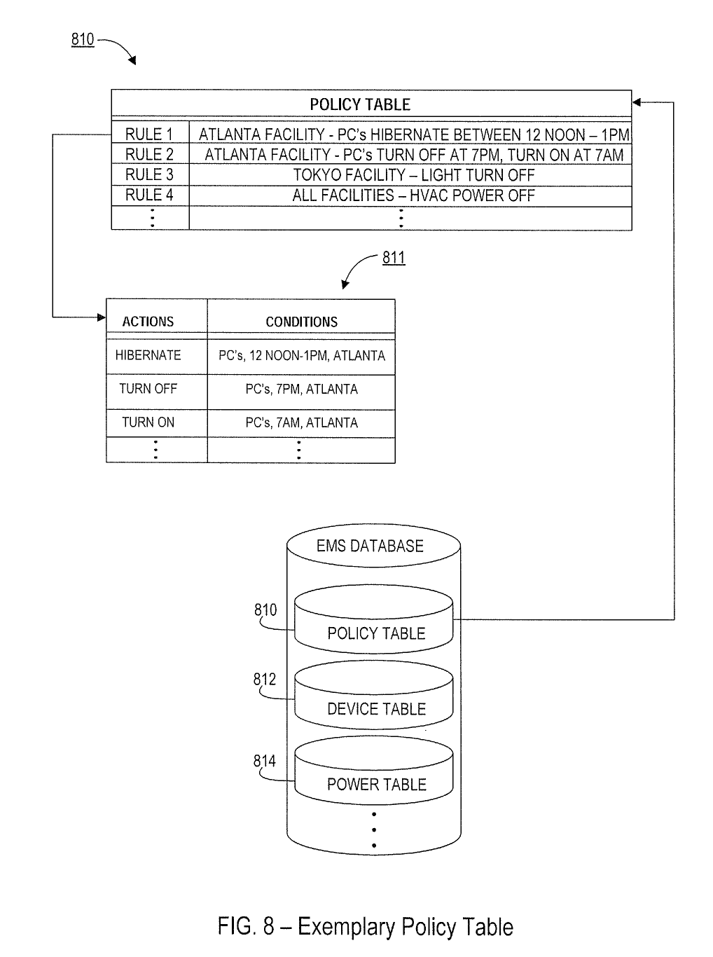

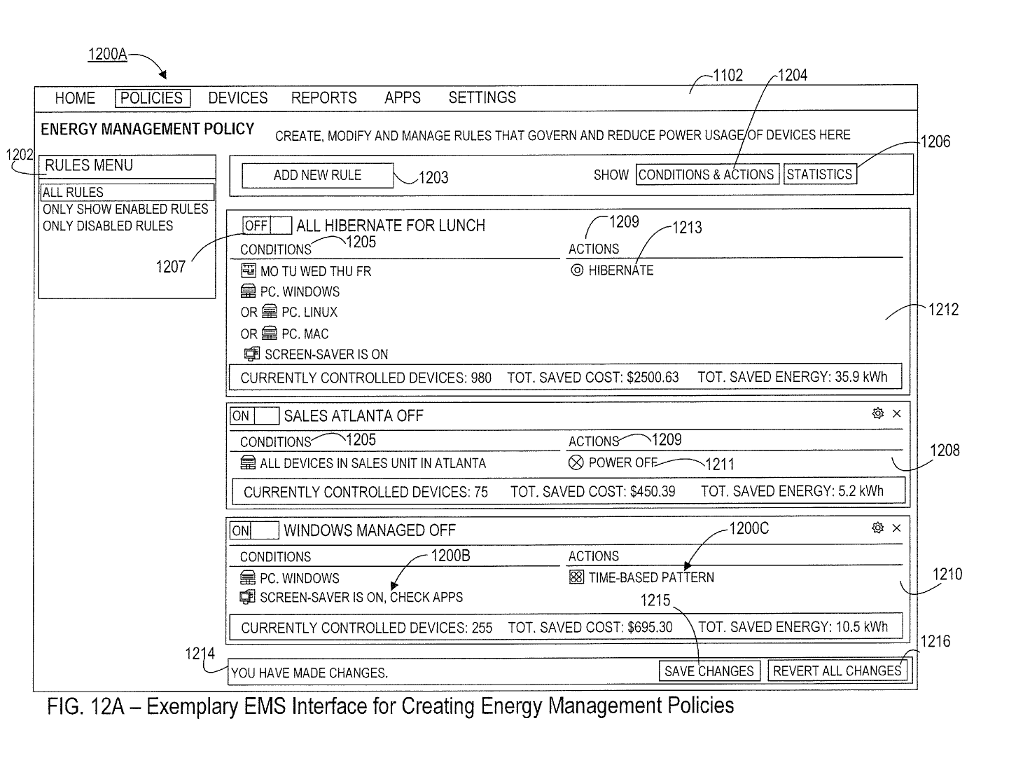

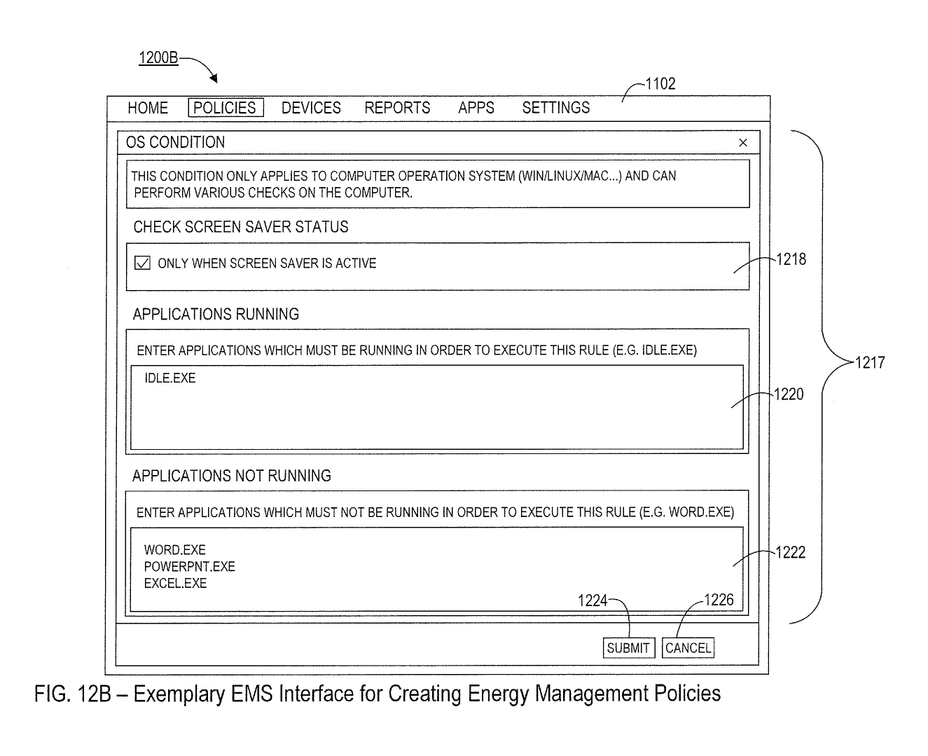

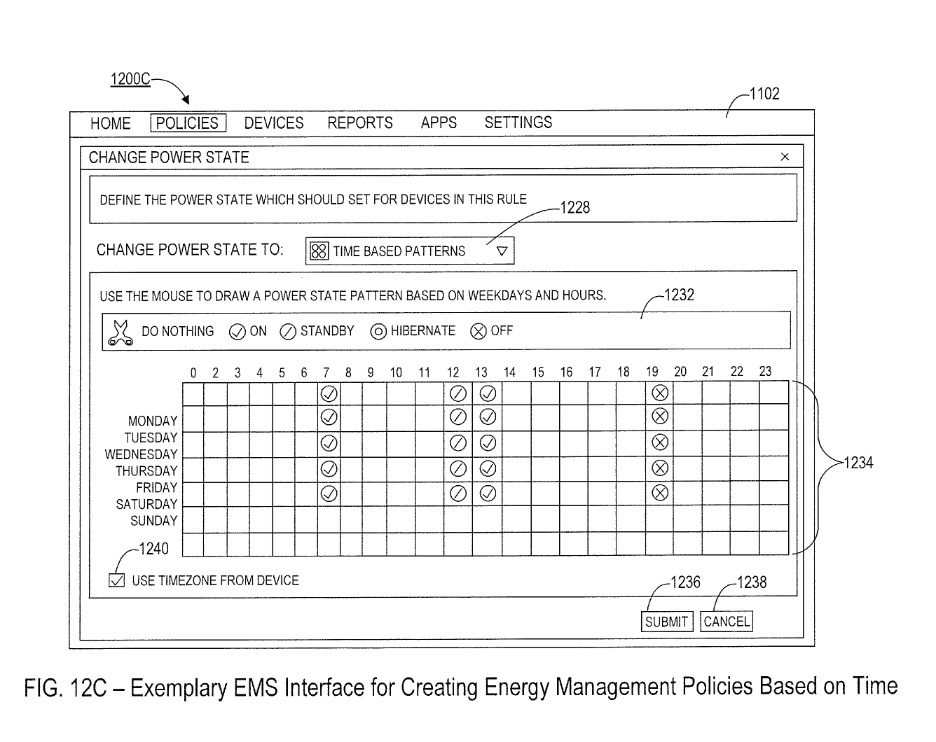

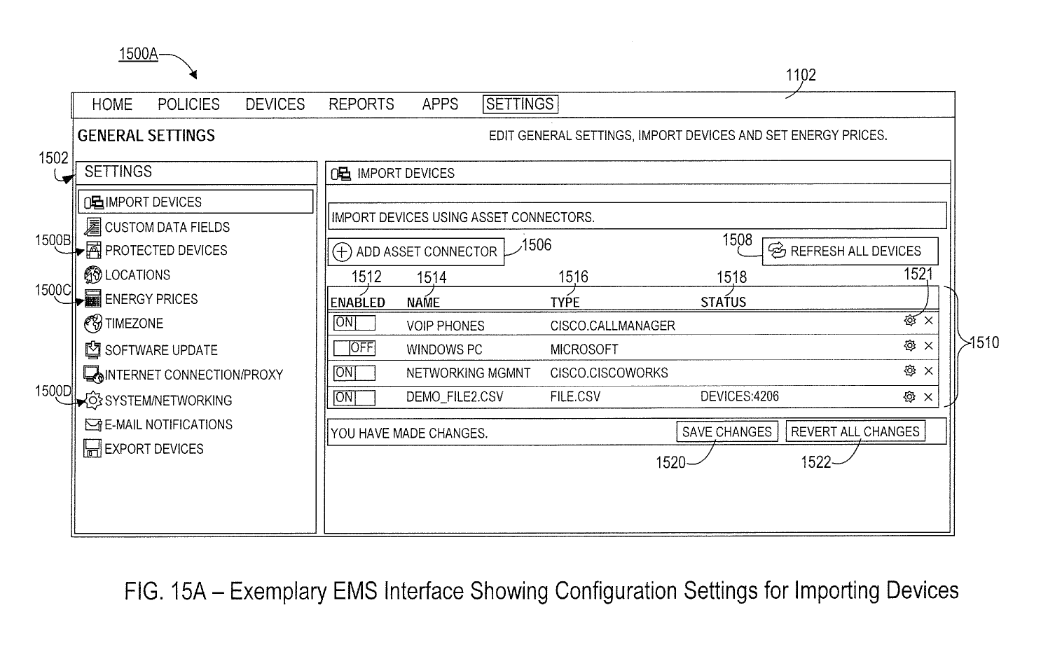

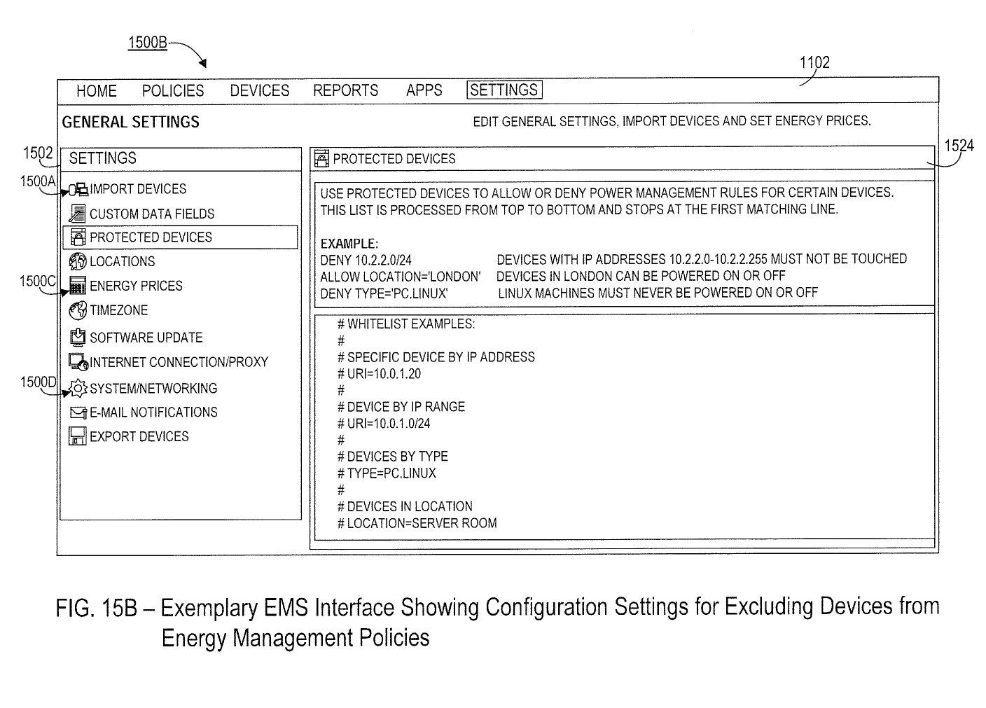

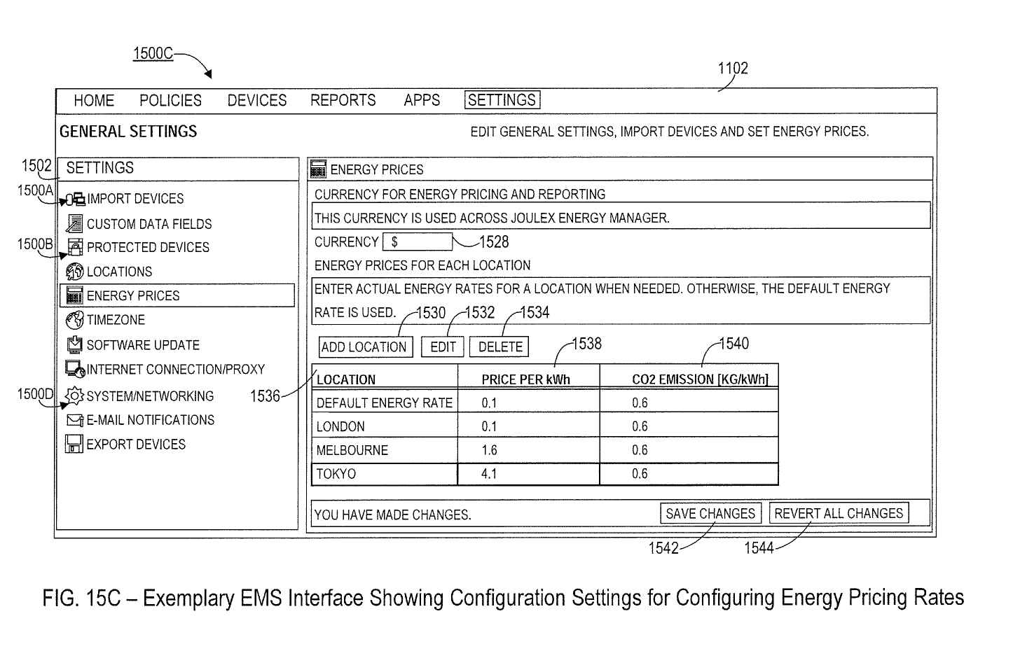

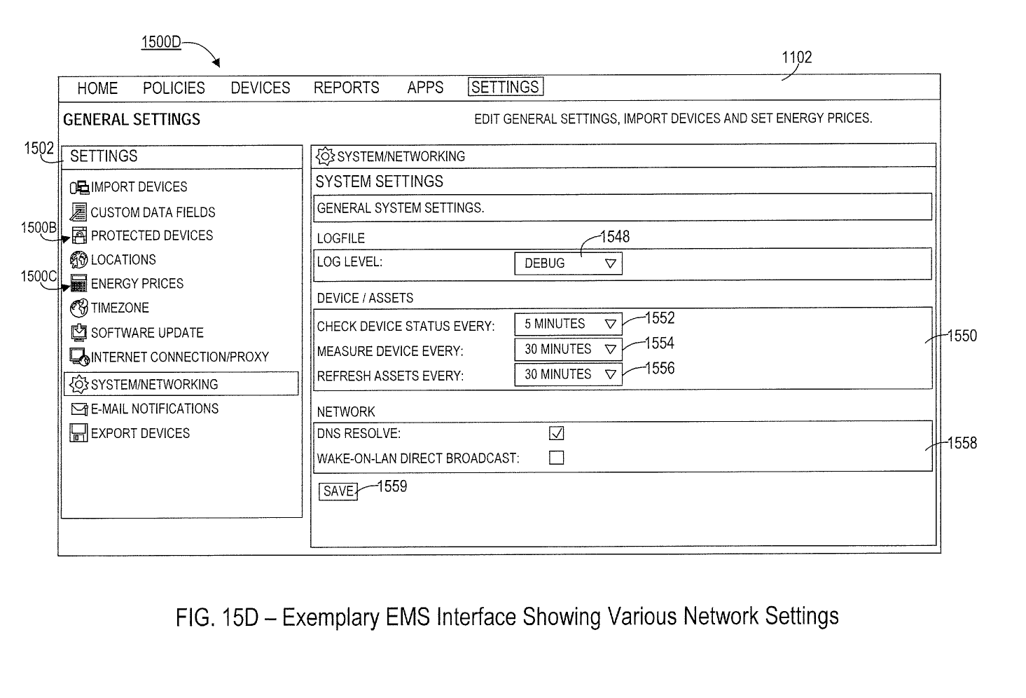

According to one embodiment of the present disclosure, various rules (as described exemplarily above) are specified/created by an EMS administrator or user 116 within the EMS, and then these rules are executed on individual assets 104 based on satisfaction of certain conditions or criteria. Generally, the EMS administrator 116 specifies such policies (or, generally speaking, rules) and reviews the outcome of executing such policies via the use of energy efficiency management reports provided by EMS 110. An exemplary high-level summary of tasks performed by an EMS administrator 116 are indicated with a number “2” in FIG. 1. Examples of exemplary policies are shown in FIG. 8 and FIG. 28 in a data table saved in the EMS database 112. Further, screenshots of exemplary policies are provided in FIGS. 12A-12C, and FIG. 15B. These policies and figures are described in greater detail elsewhere in this document.

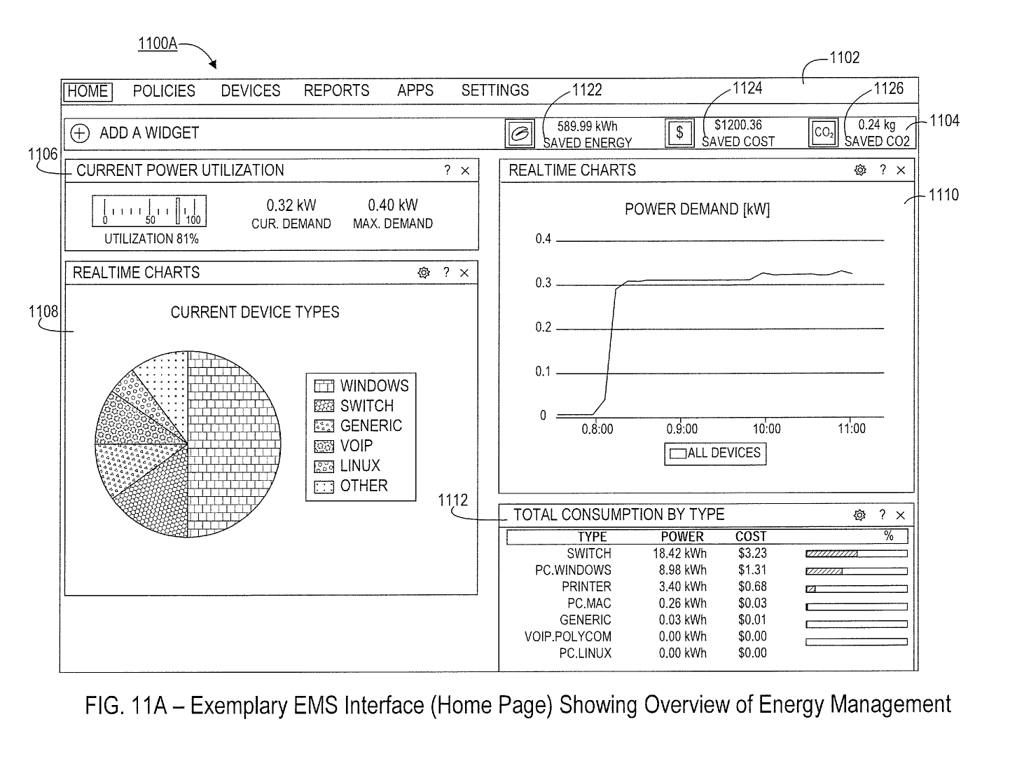

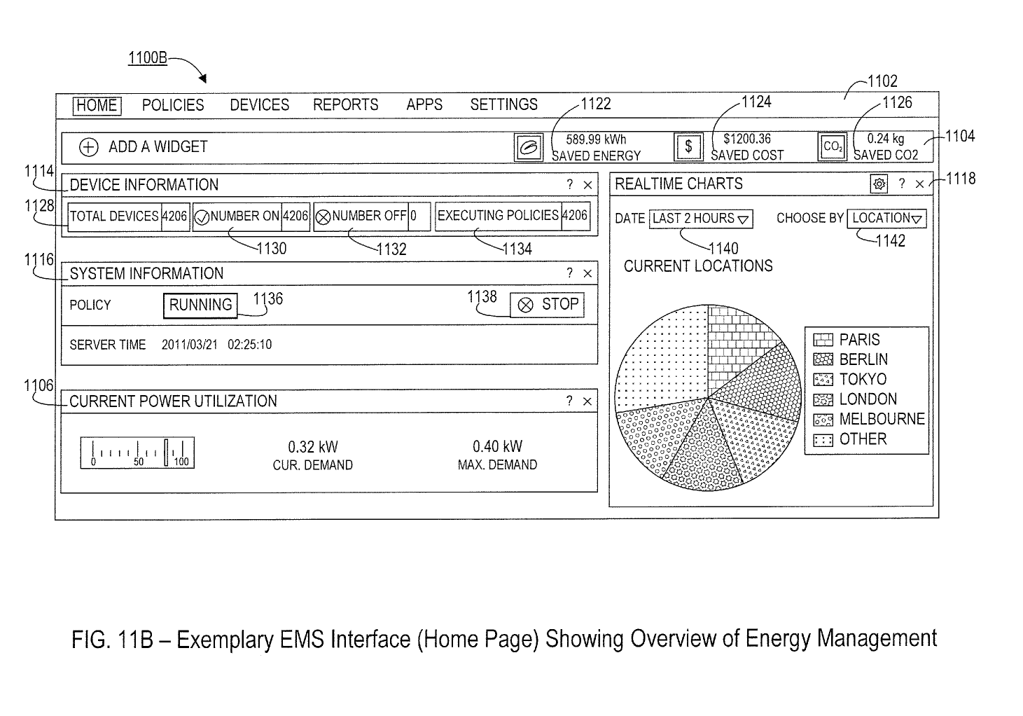

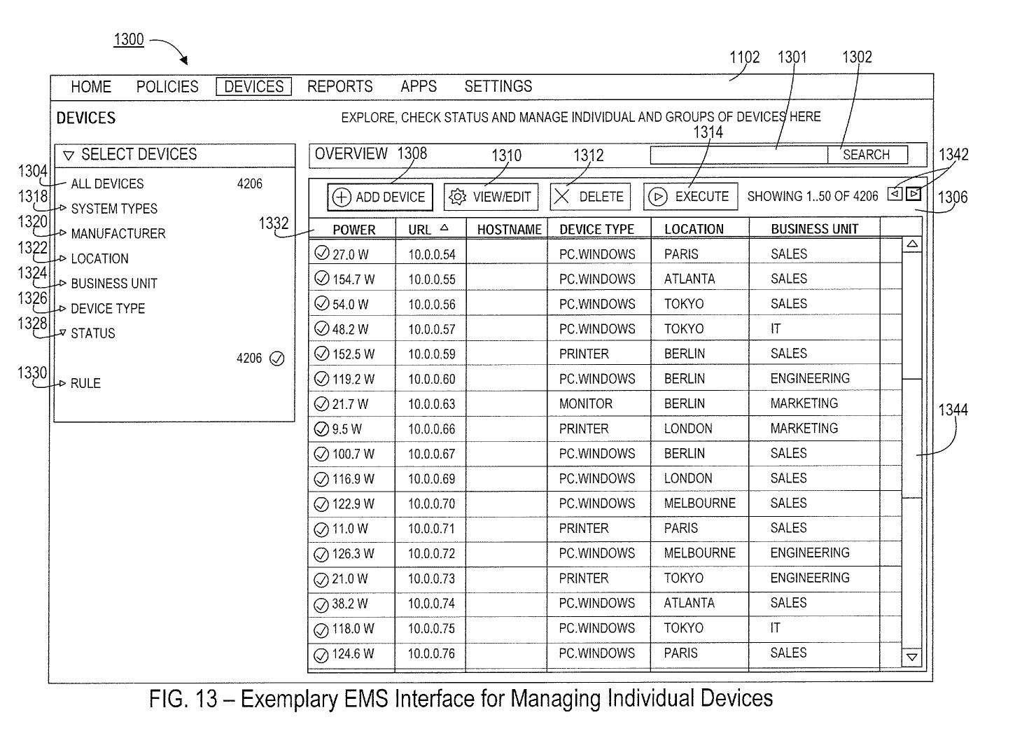

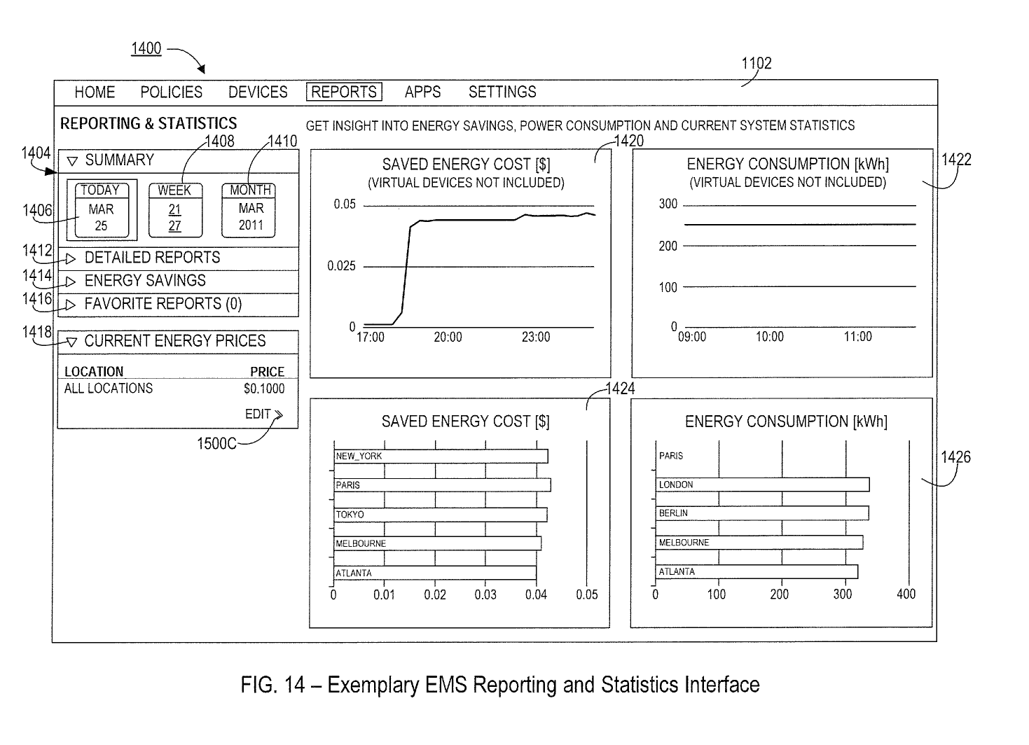

Exemplary screenshots of various embodiments of an EMS 110 interface are illustrated in FIGS. 11A-15D. In particular, FIG. 11A, FIG. 11B, FIG. 13 and FIG. 14 illustrate exemplary screenshots displaying reports of power consumed by various types of assets in multiple business units at different geographical locations. Thus, an EMS administrator can obtain reports containing power consumed by various assets according to asset type, date/time, location, region, department, business unit, region, etc. Additionally, reports can also provide analytics extracted from power-related information of assets involving savings in energy, savings in financial costs, carbon emissions and the like. As will be understood and appreciated by one skilled in the art, various other reports can be obtained and can even be customized to suit the requirements of an individual or an organization that intends to make use of such reports. These reports are utilized by individuals and organizations in making informed choices for planning and optimization of resources.

Furthermore, a screenshot showing interface settings/options for integrating assets (initially during setup) with the EMS 110 is indicated in FIG. 15A. Screenshots showing additional exemplary interface settings/options for an embodiment of the EMS 110 are illustrated in FIGS. 15B-15D. The screenshots shown in FIGS. 11A-15D are for the purposes of illustration only. As will be understood and appreciated, various widgets and tools can be added to a user interface of the EMS 110, depending on the choice of reports or display of information as desired by a person reviewing such an interface.

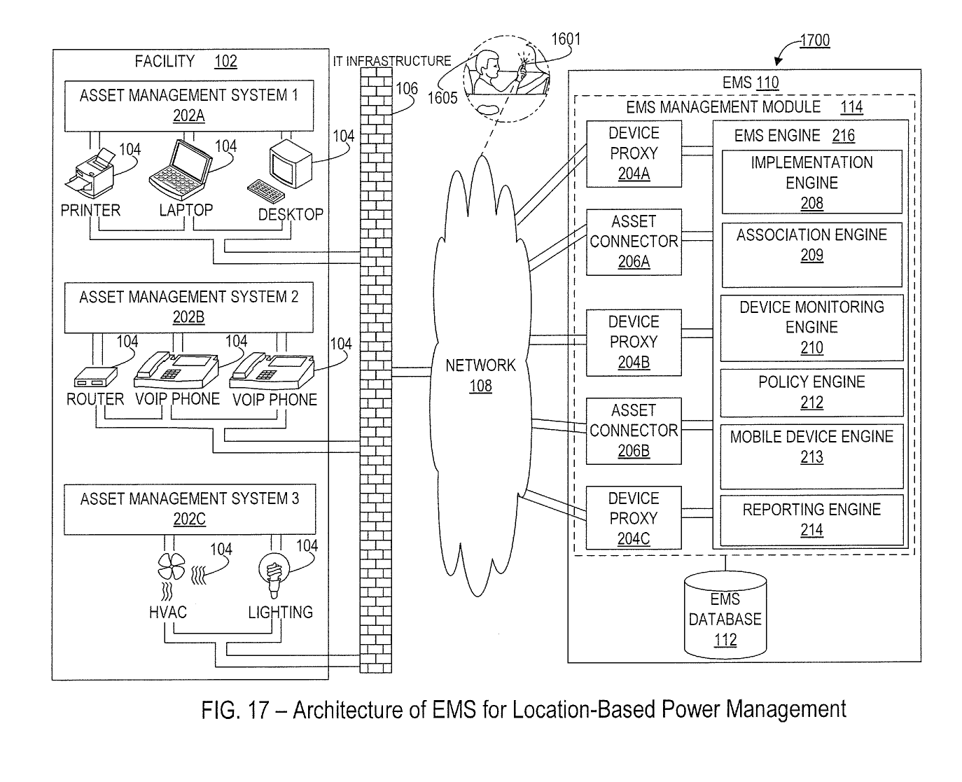

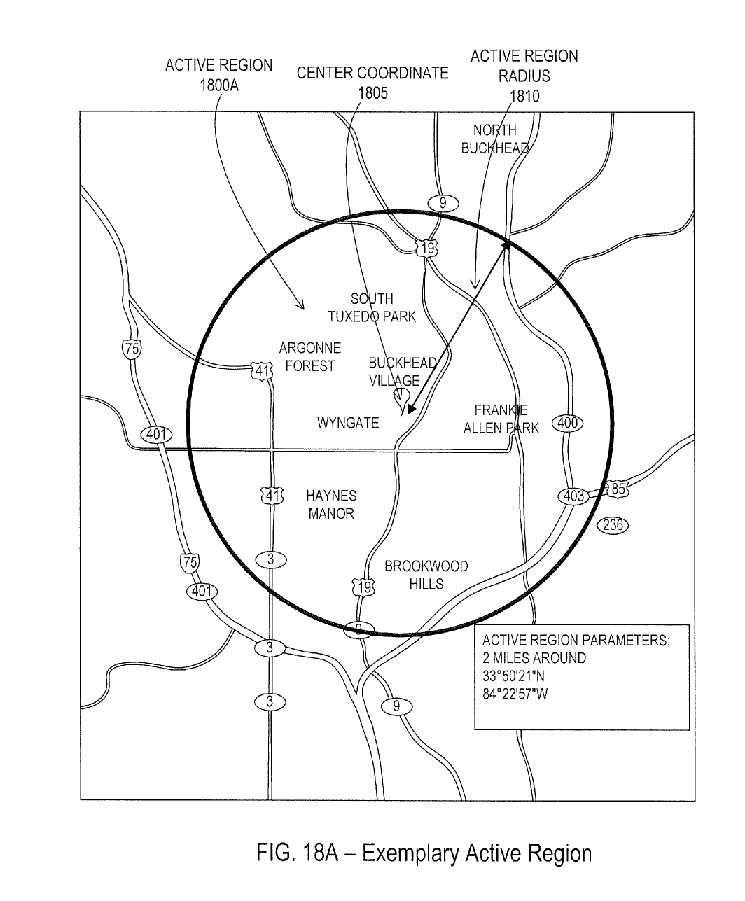

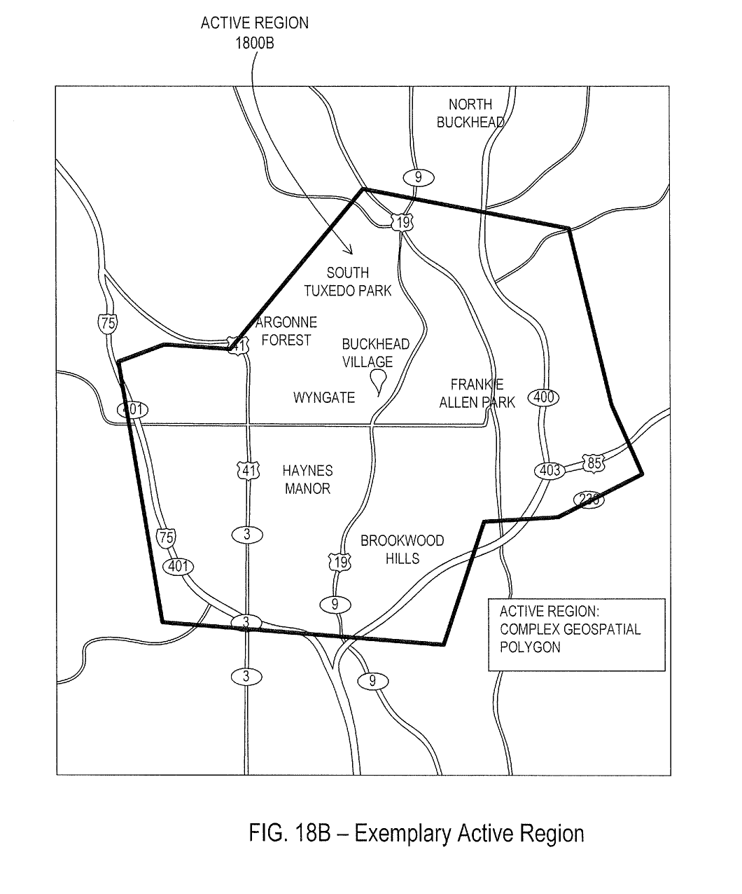

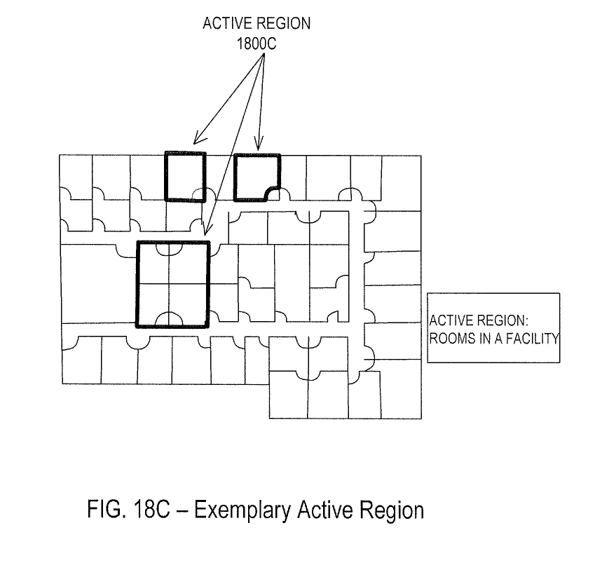

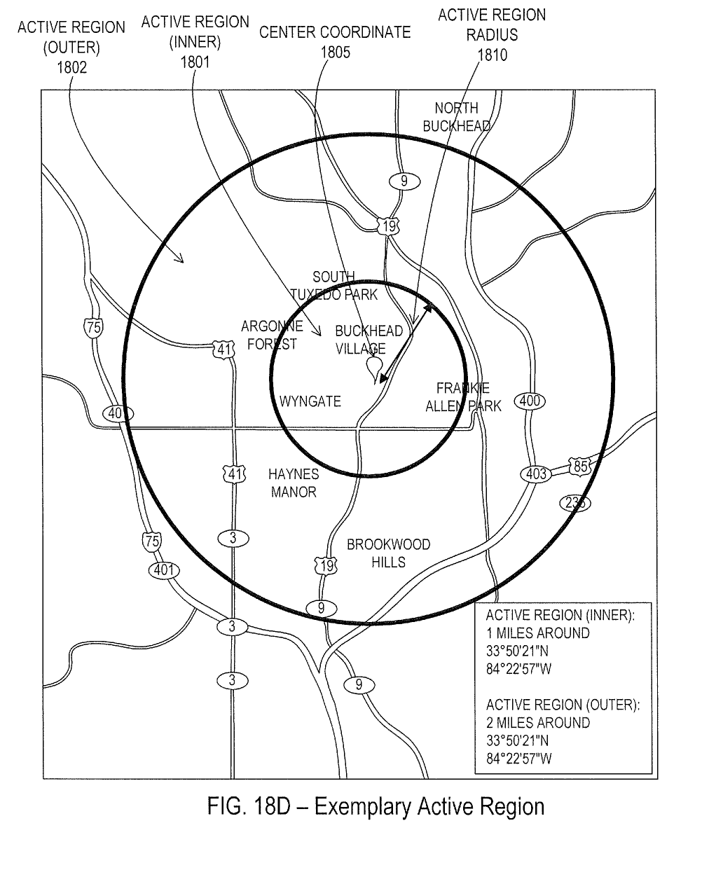

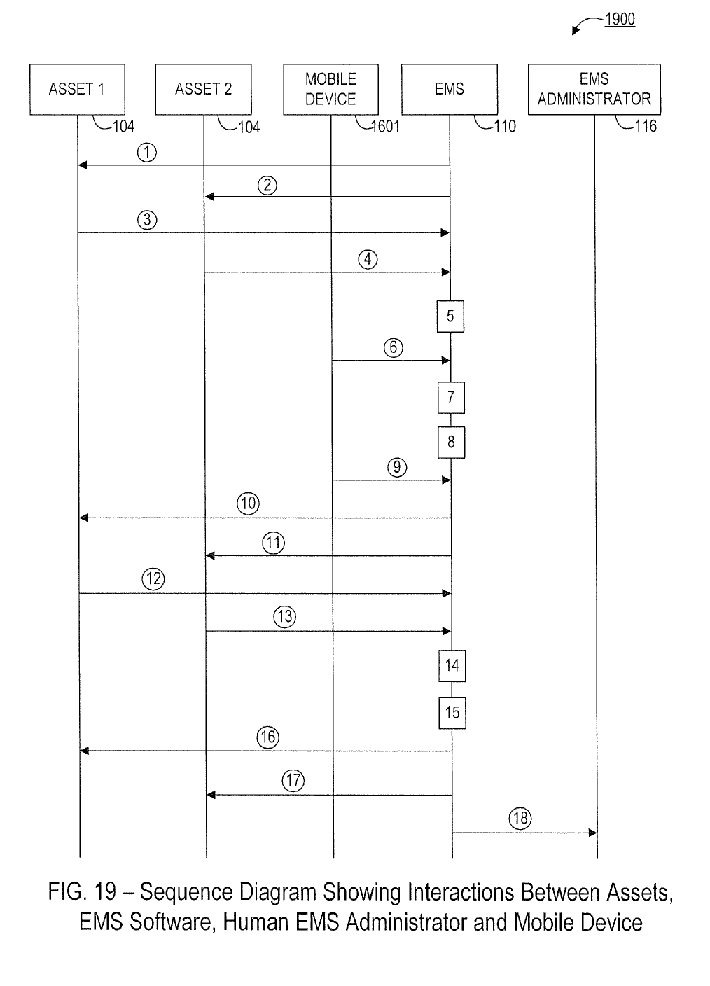

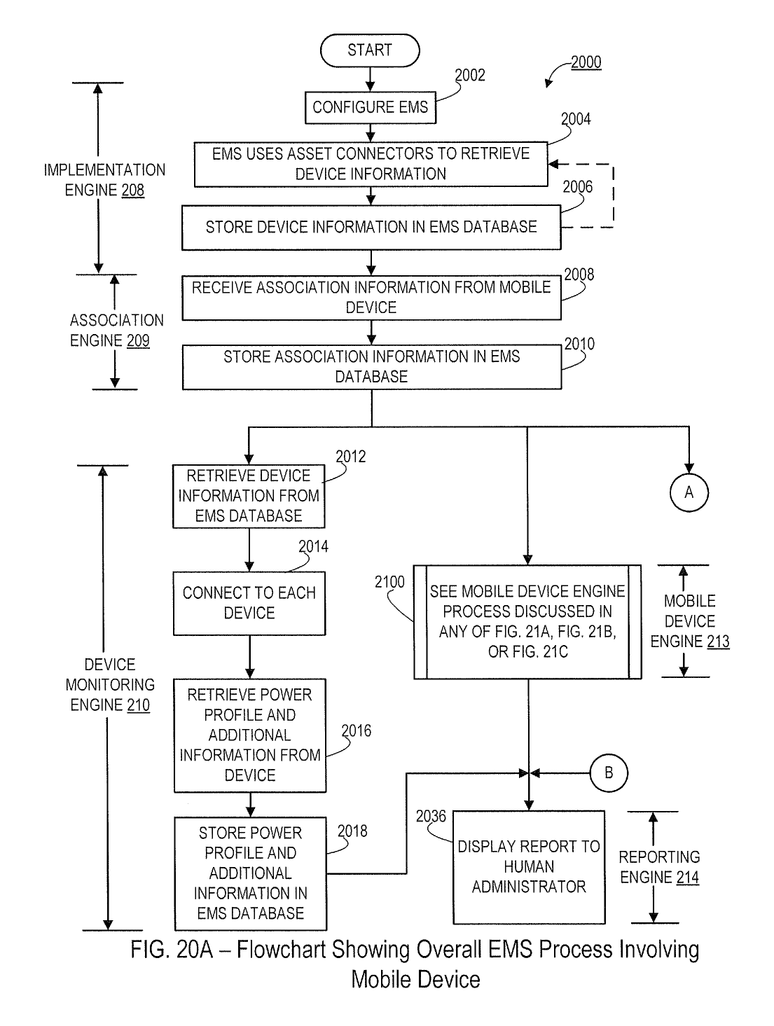

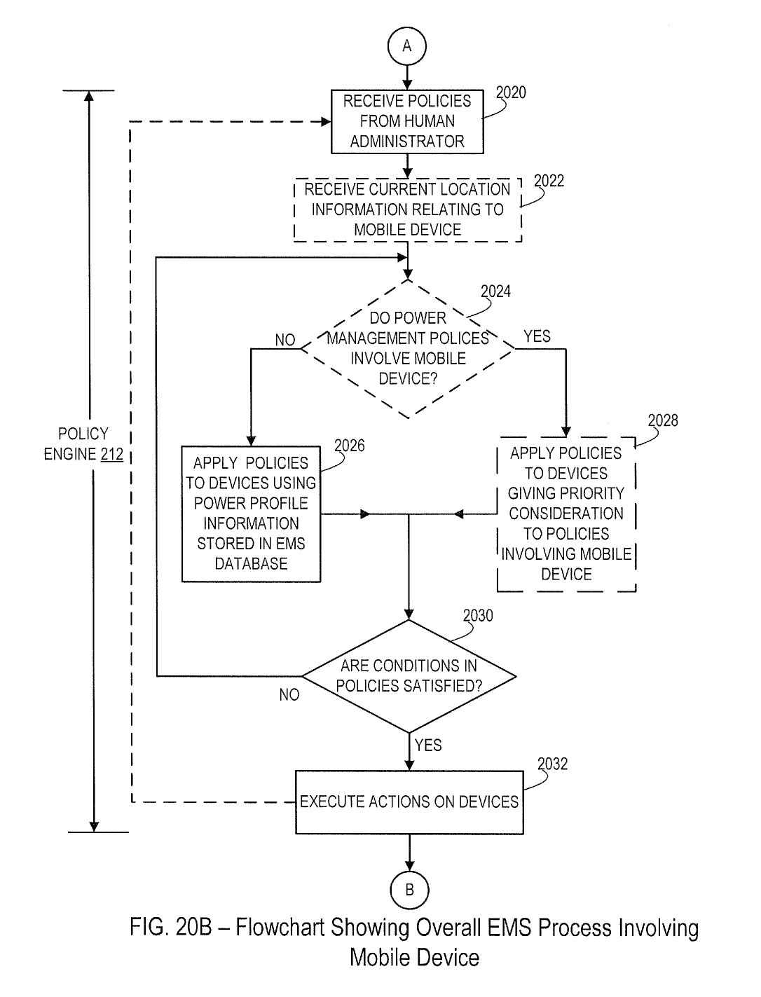

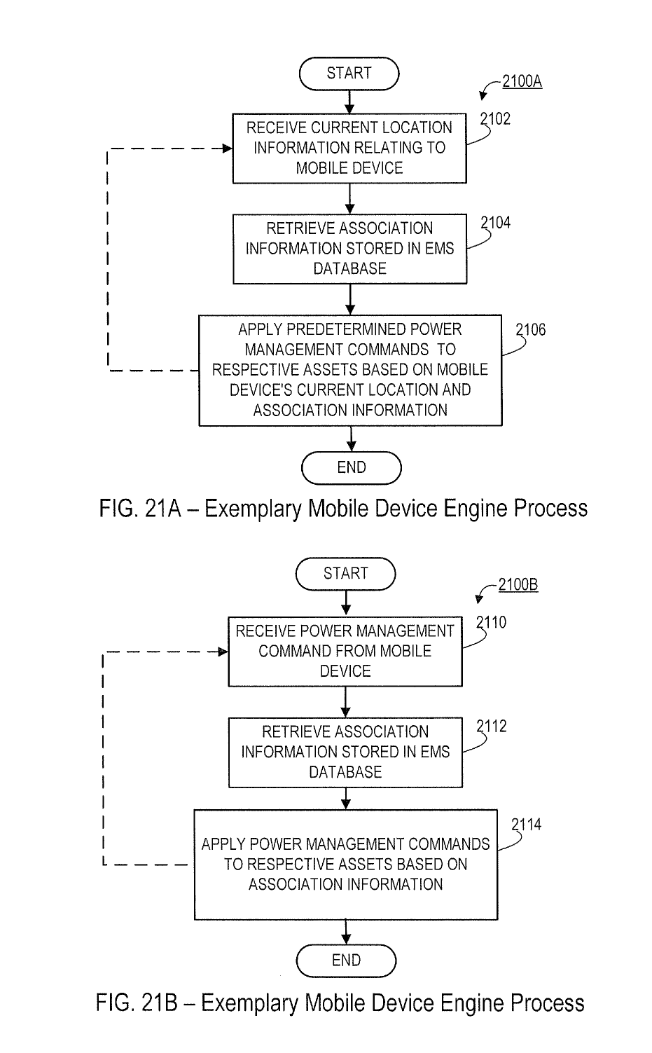

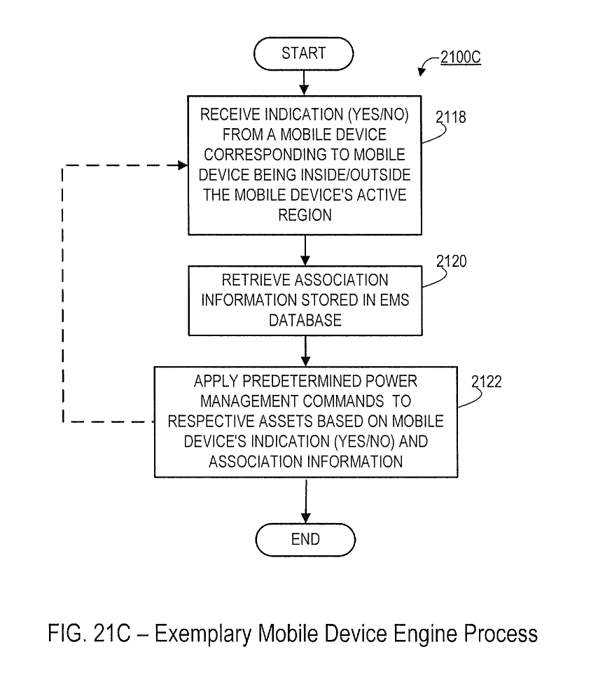

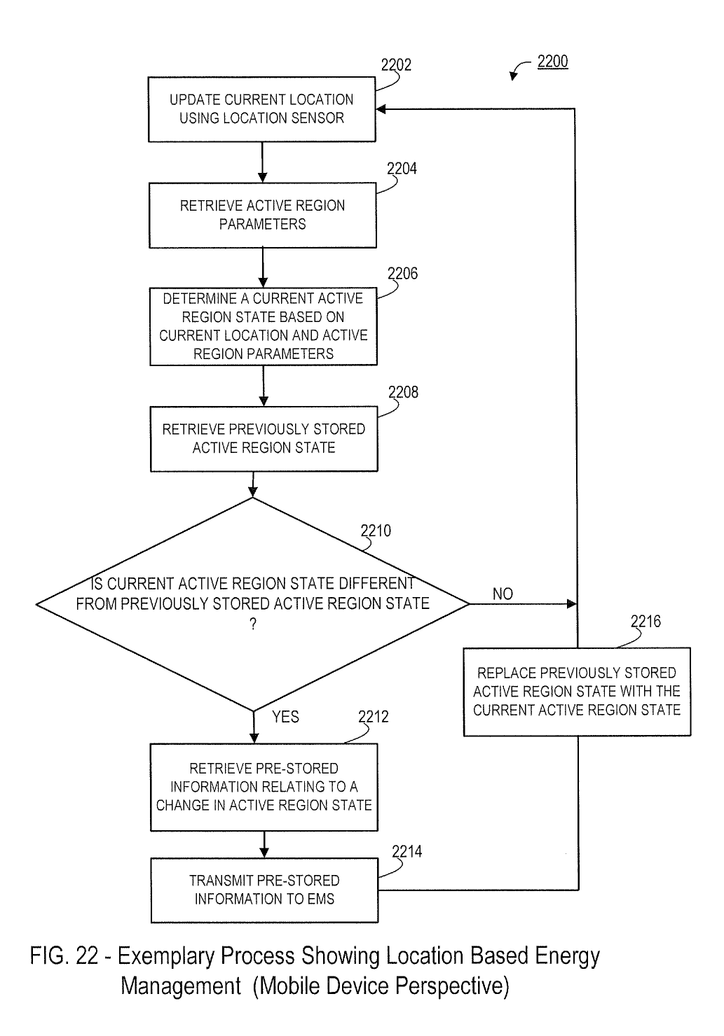

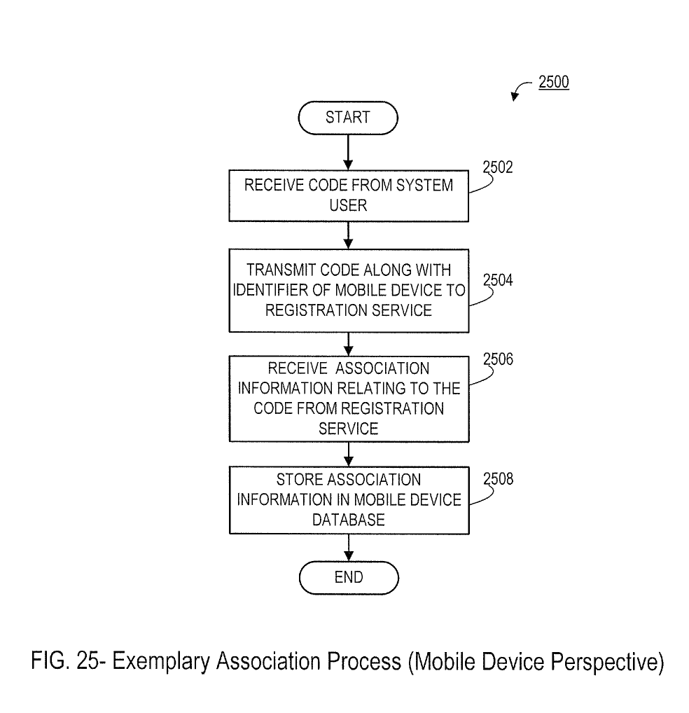

As recited above, various embodiments of the EMS involve remote management of assets from a user's mobile device. Generally, such remote management is based on the mobile device's movement (and, consequently, the user's movement) within predetermined, geographic “active regions.” These active regions are typically predefined and indicate when the power states of a user's assets at a facility should be changed, updated, or modified. These embodiments are discussed herein in connection with FIGS. 16-32. In particular, an alternate embodiment of the EMS in an exemplary environment wherein a user remotely manages assets housed in a facility will be discussed in connection with FIG. 16. Various software modules included in an alternate embodiment (involving remote management of assets from a user's mobile device) is shown in FIG. 17. Geographical regions showing areas for location-based remote management of assets is displayed in FIGS. 18A-18D. A sequence diagram displaying interactions between an embodiment of the EMS, and various other components involved in remote management of assets from a user's mobile device, is shown in FIG. 19. In FIG. 20 (consisting of FIGS. 20A and 20B) and FIG. 21 (consisting of FIGS. 21A-21C), flowcharts are shown illustrating exemplary process steps performed by several software modules in an EMS in remote management of assets from a user's mobile device. Flowcharts from the perspective of a user's mobile device illustrating remote management of assets from a user's mobile device are shown in FIGS. 22, and 25. Various data tables showing exemplary data stored by the EMS in remote management of assets from a user's mobile device are shown in FIGS. 23 and 26-28. Screenshots showing an interface of a user's mobile device displaying several aspects of remote management of assets from a user's mobile device are shown in FIGS. 30-32.

The materials discussed above in association with FIG. 1 merely provide an overview of an embodiment of the present system for energy efficiency management, and are not intended to limit in any way the scope of the present disclosure. Accordingly, further embodiments of the systems and methods and more detailed discussions thereof is provided below and in the accompanying figures.

### EXEMPLARY EMBODIMENTS

Generally, one form of the present disclosure describes a system for monitoring, managing, controlling, and analyzing energy consumption of a collection of assets that are housed in different facilities. Turning to FIG. 2, an exemplary EMS architecture 200 is shown, including a detailed view of connections involving assets 104 and asset management systems 202 in a facility 102, along with architectural details of the EMS management module 114, which includes various software modules and components. (Architectural details of an alternate embodiment of the EMS involving remote management of assets housed in a facility, based on a real-time location of a user's mobile device will be discussed in FIG. 17.)

In the embodiment shown in FIG. 2, a facility 102 houses various assets 104 such as desktops, laptops, HVAC equipment, lighting equipment etc. Generally, a collection of similar assets in a facility are grouped together and connected to an asset management system 202 corresponding to that type or group of assets. For example, desktops, laptops, printers are connected to asset management system 202A, which may relate to personal computing devices. Similarly, assets such as routers and VoIP phones are connected to another asset management system 202B. And, assets such as HVAC systems and lighting equipment may be connected to yet another asset management system 202C.

Generally, individual assets 104 as well as asset management systems 202 are also connected to an IT infrastructure 106 at facility 102. As recited previously, asset management systems may include elements of software and hardware that manage information relating to assets or devices operating in a facility. As will be understood and appreciated, assets listed in FIG. 2 are for the purposes of illustration only. Various other asset types from a wide variety of vendors and manufacturers can be used in a facility.

Still referring to FIG. 2, IT infrastructure 106 is connected to an embodiment of the EMS 110 via a network 108. As previously recited, the EMS 110 monitors, analyzes, and controls individual assets 104 at a facility or facilities. As further shown in FIG. 2, the EMS 110 includes an EMS management module 114 and EMS database 112. The EMS management module 114 further comprises device proxies 204 for communicating with individual assets in the facility 102, and asset connectors 206 to enable communication with the asset management systems for retrieval of data relating to the assets. The embodiment of the EMS management module shown in FIG. 2 further comprises an EMS engine 216 that includes various sub-modules including an implementation engine 208, device monitoring engine 210, policy engine 212 and reporting engine 214. These engines and modules generally comprise software algorithms for carrying out specific EMS functionalities, as described in greater detail below.

Generally, asset connectors 206 are connected with network 108 in order to discover and import assets 104 into the EMS 110, with the help of asset management systems 202. When provided with identifying attributes such as a network address and hostname, an asset connector opens a remote connection with one or more asset management systems in order to communicate with assets. For instance, the EMS 110 may use asset connector 206A to import all WINDOWS™ computers from an asset management system like Active Directory. In another example, asset connector 206B is used to automatically discover monitors and printers housed in a facility. Further, in another example, an asset connector is used to import VoIP phones from another asset management system such as CISCO™ Call Manager, and so on. Generally speaking, asset connectors 206 integrate with asset management systems in order to extract preexisting information relating to individual assets 104 for purposes of inventory management of assets in a facility. Arbitrary configuration settings for importing exemplary assets are shown in an exemplary screenshot in FIG. 15A.

As will be understood by a person skilled in the art, in many situations, some assets are not IP enabled, or assets may be unique to some organizations. For example, lighting equipment or specific mechanical machinery in a factory might not have the ability to connect to a network. In such situations, an asset connector can be combined with data sources like SAP to retrieve information from such assets, using database connectors (like ODBC, or Comma Separated File for example), for importing such assets into an embodiment of the EMS 110.

As will be understood, asset management systems provide information (about assets) in the form of various attributes, for example, IP addresses of assets, hostnames of assets, locations, business units, etc. In many situations, asset management systems are not configured to group assets based on specific attributes. For example, in many organizations, Active Directory is not configured to organize assets according to location or business unit of assets. In such situations, asset connectors can be used to assign locations and business units to assets. Furthermore, in another example, asset connectors can be used to assign various assets in an organizational hierarchy into subnets or sub domains of an IP network. As will be understood and appreciated, this methodology of abstracting assets with a standard set of attributes provides a way of importing and further classifying various assets into an embodiment of the EMS.

As can be further understood by a person skilled in the art, several asset connectors can retrieve information about a given asset. For example, in one embodiment, the implementation engine 208 performs the task of configuring the EMS 110 and initiating retrieval of information (specifically, various attributes, as explained previously) from assets (or, from asset management systems) using asset connectors 206. Information retrieved from several asset connectors is merged by implementation engine 208 into a single profile for an asset (a “device profile”) in the EMS in order to limit multiple copies of identical information retrieved from several asset connectors. This “merging” of information can be accomplished according to predefined hierarchies or ranks determined by an EMS user, or according to other predefined protocols. Details of steps performed by the implementation engine 208 are described below in connection with an exemplary flowchart in FIG. 5A and FIG. 5B.

Still referring to FIG. 2, according to one embodiment, device proxies 204 work hand-in-hand with asset connectors 204 to implement low-level communication protocols with existing assets 104. Device proxies generally comprise predetermined algorithms that enable communication with a particular type of device. For instance, in the example architecture 200 shown in FIG. 2, assume device proxy 204A supports an industry protocol such as WINDOWS™ Management Instrumentation (WMI) to communicate with WINDOWS™ machines, device proxy 204B supports Secure Shell (SSH) for LINUX™ and APPLE™ machines, device proxy 204C supports Simple Network Management Protocol (SNMP) for networking equipment like switches and routers and many more such protocols. Multiple device proxies exist because embodiments of the EMS 110 communicates with a wide variety of assets on different platforms and operating systems. According to one embodiment of the present disclosure, the EMS 110 communicates with individual assets using device proxies associated with such assets, for purposes of monitoring and control of individual assets 104. According to another embodiment of the present disclosure, for purposes of monitoring and control, the EMS 110 communicates with individual assets using a combination of associated device proxies, and associated asset connectors for such assets. In this second embodiment, generally, the device proxy communicates with an asset connector, that in turn communicates with an asset management system, that yet in turn communicates directly with the device. It is the use of these device proxies and asset connectors that enables normalized and standardized information retrieval, storage, and monitoring within an EMS by a system user.

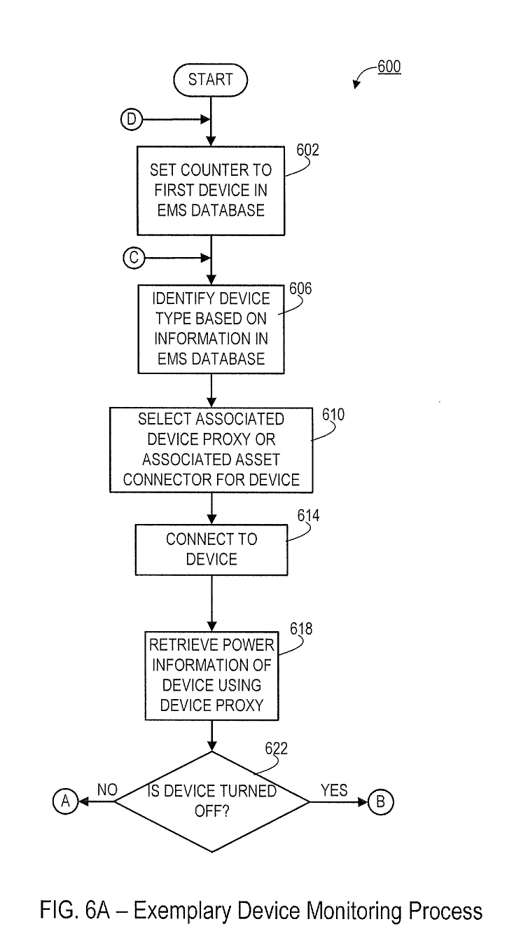

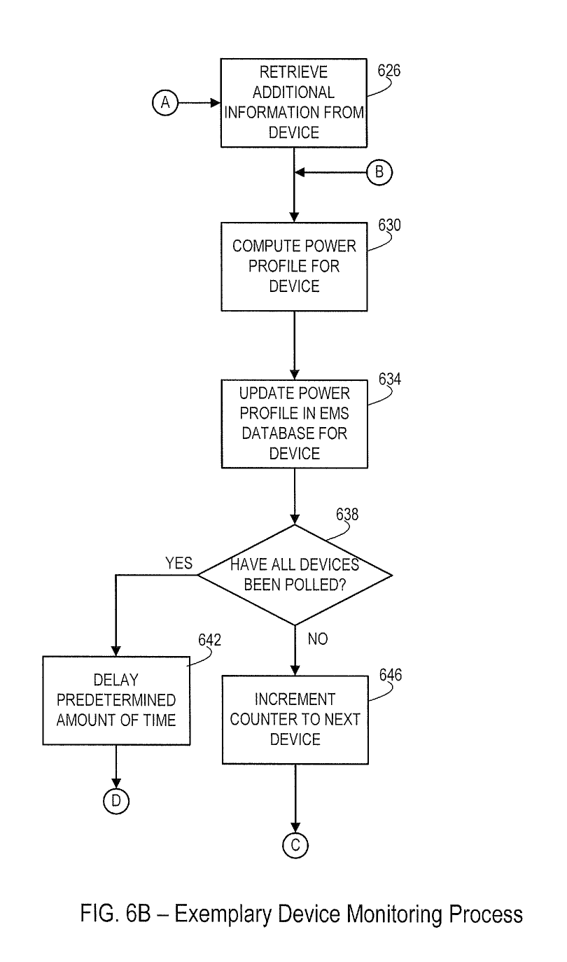

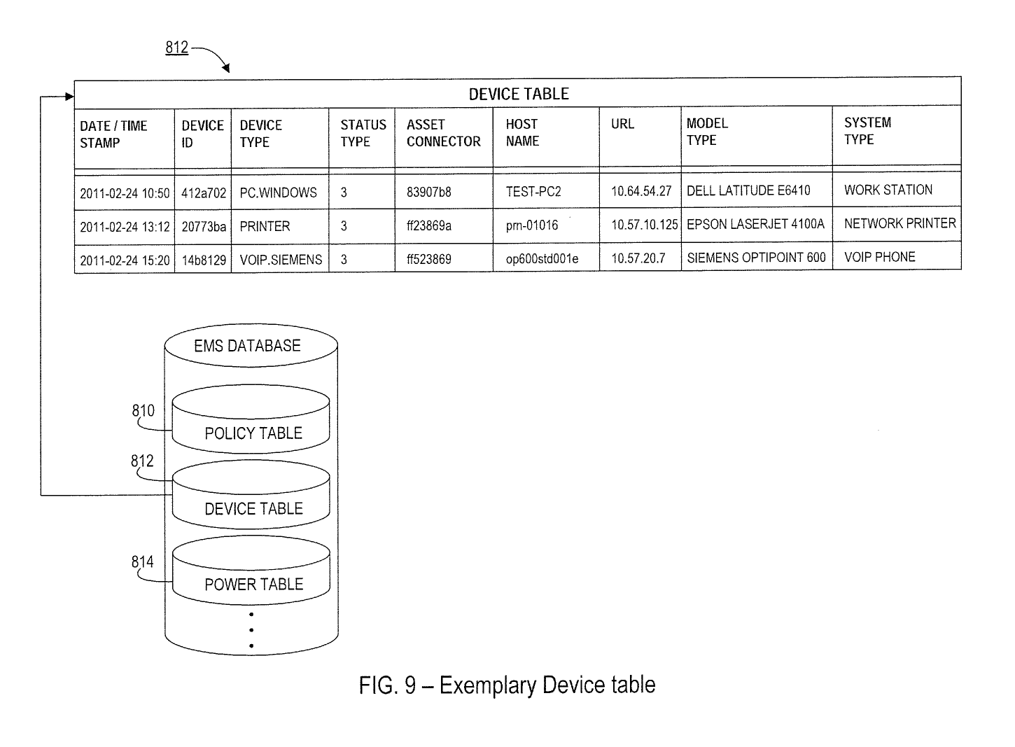

Still referring to the modules maintained within the EMS engine 216, an embodiment of the device monitoring engine 210 performs the task of monitoring energy information and other information of individual assets 104. Monitoring generally involves periodic polling of assets for their power status (for example, on/off/hibernate), power consumption, load and utilization, hardware and software configuration changes, or even to changes of attached assets (for example, if a monitor is disconnected from a computer, and various such changes). Power consumption data, along with other information collected from assets via the device monitoring engine 210 is stored in the EMS database 112 for subsequent processing. Exemplary data and columns storing such data is shown in database tables in FIG. 9. Details of steps performed by an embodiment of the device monitoring engine 210 are described in connection with an exemplary flowchart in FIG. 6A and FIG. 6B.

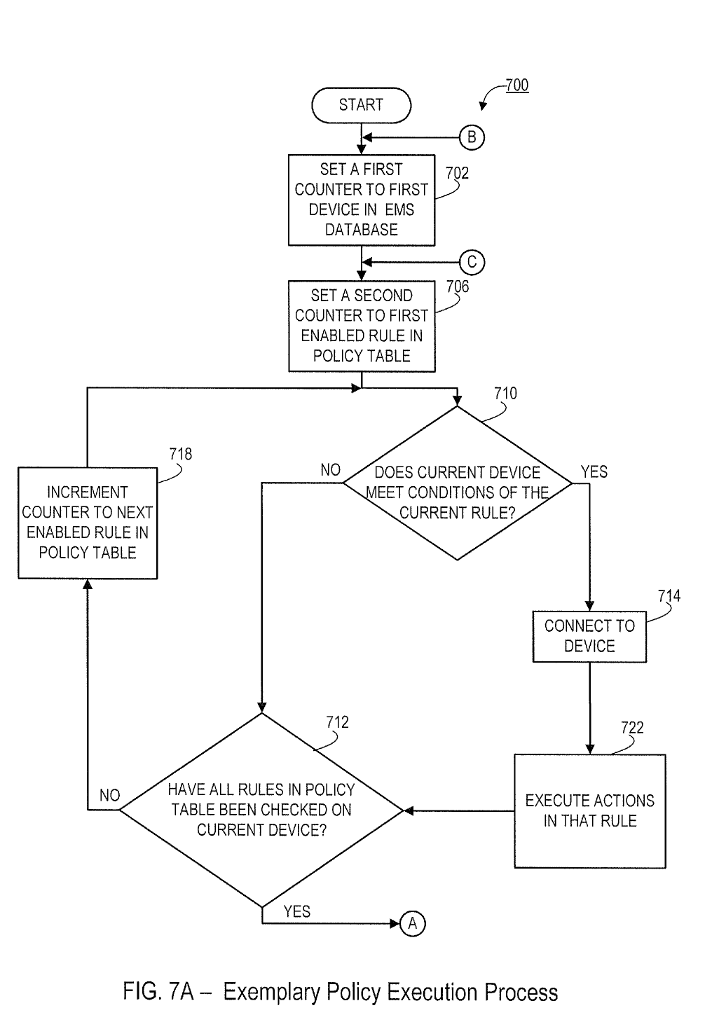

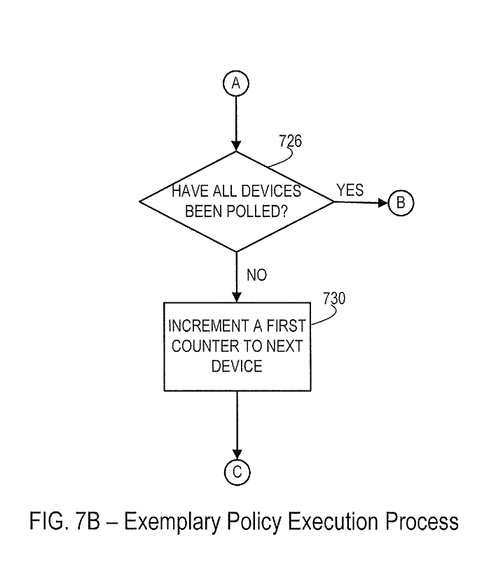

Further, as described in greater detail below, control of assets includes various measures to save energy by dynamically powering off or reducing energy consumption of devices. According to one embodiment, these measures are crafted and implemented via a policy engine 212 that provides a flexible framework to create sophisticated power management rules. Such rules are received by the EMS 110, either during initialization of the EMS 110, or during normal operation, and stored in the EMS database 112. Exemplary rules are illustrated in FIG. 8. Details of steps involved in executing such rules on various assets is described in FIG. 7A and FIG. 7B.

In an exemplary alternate embodiment, aspects of the present disclosure relate to remote management of power consumed by assets located at various geographically distributed facilities, on the basis of an instantaneous location of a user's mobile device that is associated with one or more assets housed in a facility. Such an exemplary embodiment and related EMS modules and software engines will be discussed in greater detail in connection with FIGS. 16 and 17. Exemplary rules corresponding to the alternate embodiment are displayed in FIG. 28. Details of process steps involved in the alternate embodiment will be discussed in connection with FIG. 20 (consisting of FIGS. 20A and 20B) and FIG. 21 (consisting of FIG. 21A-21C).

Still referring to FIG. 2, data collected from assets, both in real time as well as non-real time, is used for extensive reporting on energy consumption, energy savings, carbon emissions and various other such attributes. In the embodiment shown in FIG. 2, the reporting engine 214 provides various reports involving various statistics and analytics extracted from collected data. Further, reports can also be customized to suit the requirements of an individual or an organization who wishes to review such reports.

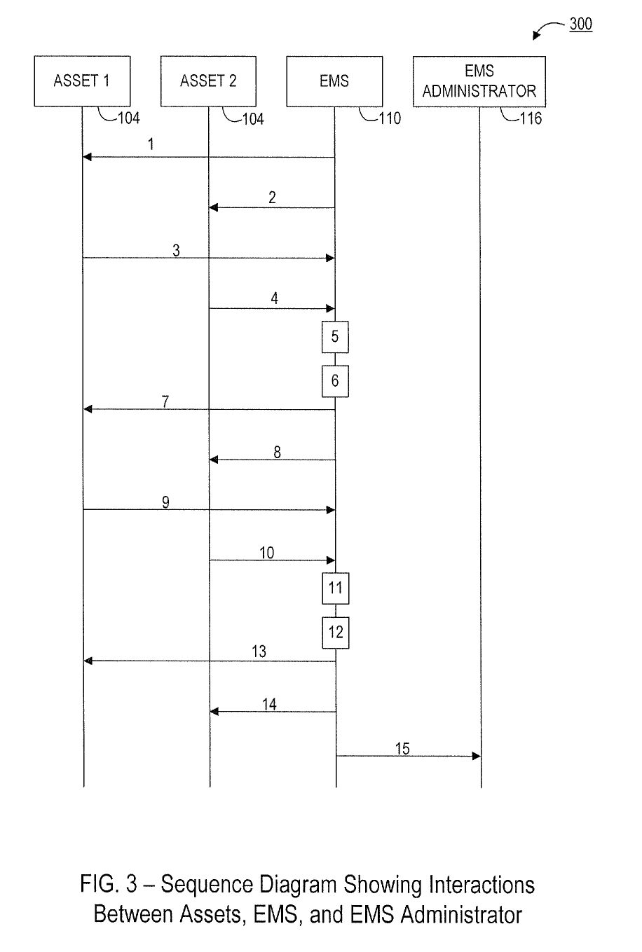

FIG. 3 is an exemplary sequence diagram illustrating the steps involved in the interactions between various components of an embodiment of the present system, for purposes of energy efficiency management of assets housed in a facility, according to an exemplary embodiment of the present system. As explained in greater detail below, the components of the system are involved in various aspects of energy efficiency management involving monitoring, analysis, control, data collection, and display/reporting of power consumption related information of assets in a facility.

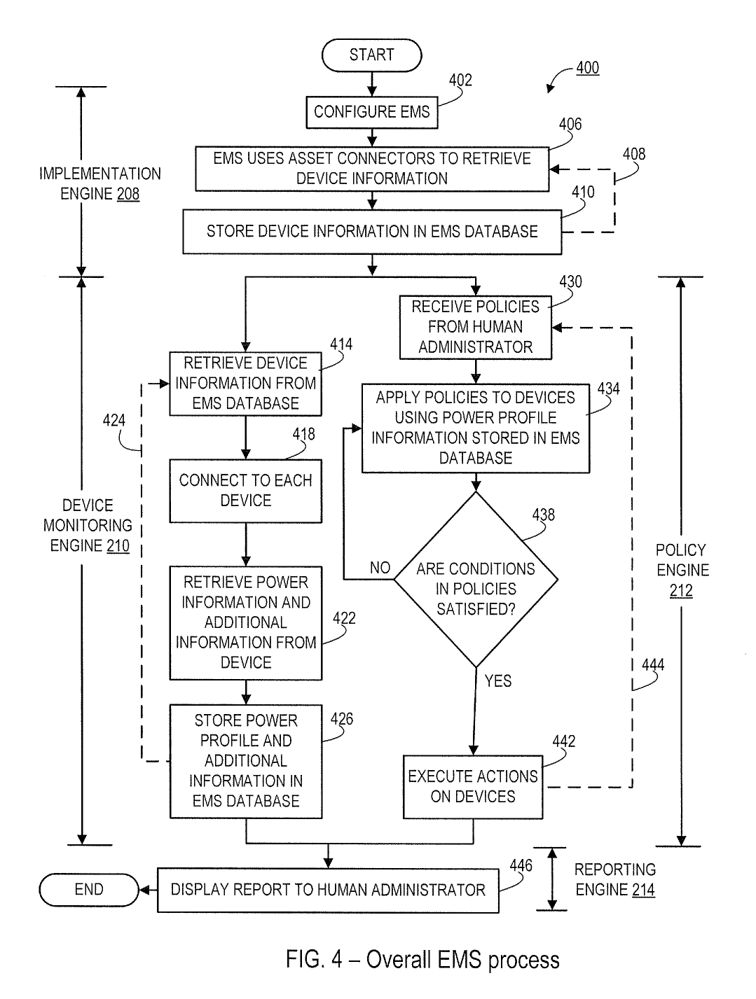

Starting at step 1 in FIG. 3, during an initial configuration phase, the EMS management module 114 (specifically, the implementation engine 208) polls an Asset 1 using asset connectors and asset management systems over an IP network to retrieve device information relating to Asset 1. Details of steps performed by an embodiment of the implementation engine are explained with flowcharts in FIGS. 4, 5A and 5B. Similarly, during another initial configuration phase at step 2, an Asset 2 is polled by the EMS management module 114. As recited previously, Asset 1 and Asset 2 are connected to asset management systems at a facility, and the EMS management module 114 uses asset connectors to poll Asset 1 and Asset 2. At steps 3 and 4, information from both assets is retrieved by asset management systems connected to these assets and transferred over a network to the EMS 110. In one embodiment of the present disclosure, retrieved information includes (but is not limited to) network address (URI/URL) of the assets, hostnames of assets, locations, business units, etc. As will be understood and appreciated, embodiments of the present disclosure are not limited to the energy efficiency management of two (2) assets. Embodiments of the present disclosure are applicable on any number of assets, comprising a variety of asset types, brands, vendors and manufacturers, and the simplistic view of two assets shown in FIG. 3 is provided for illustrative purposes only.

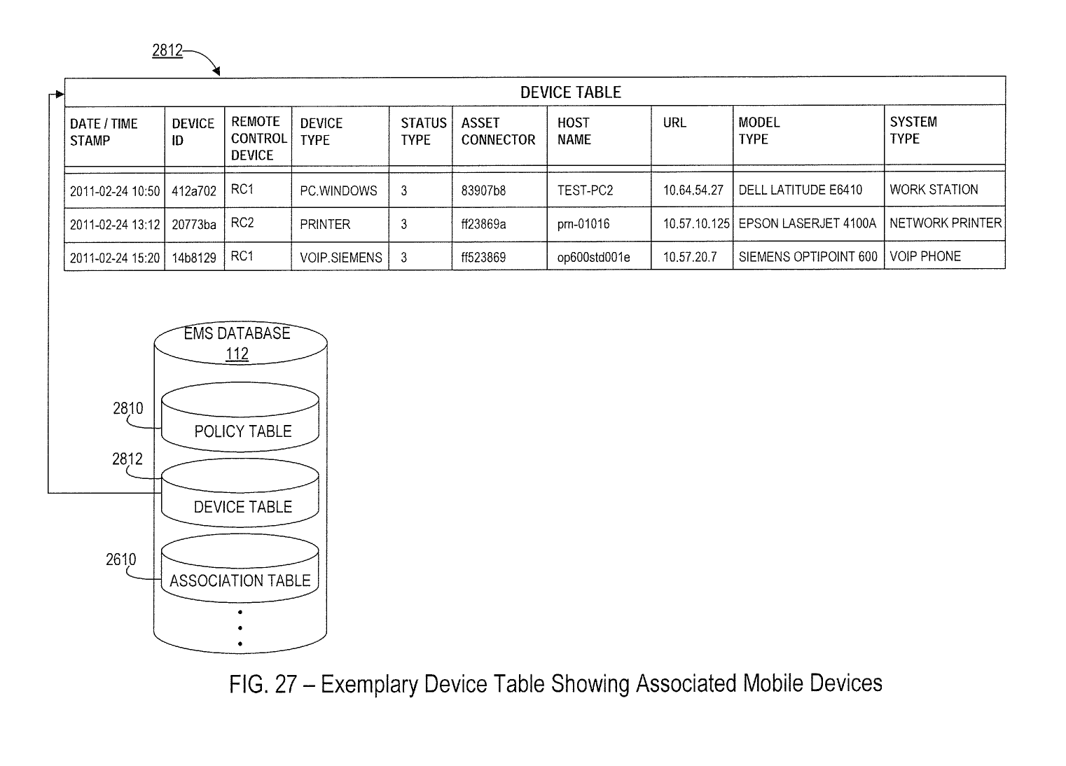

At step 5, the EMS management module 114 (specifically, the implementation engine 208) stores (saves) retrieved asset information (related to both assets in this example) in the EMS database 112 to enable subsequent monitoring and control by various software modules, as explained below. Exemplary data tables showing asset information stored in the EMS database are shown in FIG. 9 and FIG. 27. At step 6, the EMS management module 114 (specifically, the device monitoring engine 210) retrieves asset information from the EMS database 112. This information is used to locate/identify (using various attributes like IP address, hostname, etc.) individual assets and connect to them with the help of asset connectors and/or device proxies. Thus, at following steps 7 and 8, the EMS management module 114 connects to Asset 1 and Asset 2 with the help of asset connectors and/or device proxies, as necessary. Next, at steps 9 and 10, information relating to energy usage or consumption of Asset 1 and Asset 2 is retrieved from Asset 1 and Asset 2 by the EMS management module 114 (specifically, the device monitoring engine 210) and stored in a respective power profile for each respective device. Summary snapshots of power profile information as in exemplary reports to an EMS administrator are shown in FIGS. 11A, 11B, 13 and 14.

In addition to power profile information, embodiments of the EMS management module 114 also collect other types of information from assets. Examples of additional information include the hardware configurations of assets, additional devices connected to assets like printers, monitors, scanners, audio speakers, current load/utilization information of respective asset, operational temperatures of assets, etc. After such information is obtained from the assets, the EMS management module 114 saves or updates the device profile and/or power profile corresponding to the newly-identified information, at step 11. As will be understood, this information may be utilized by an embodiment of the policy engine 212 to execute various energy management policies for various devices. As described above, these policies are generally created by a system user within the EMS 110 during initialization, or during normal operation, and stored in the EMS database 112 for subsequent use.

Still referring to FIG. 3, at step 12, the EMS management module 114 (specifically, an embodiment of the policy engine 212) retrieves energy management policies, power profile information, device profile information, and additional information (if any) that has been saved earlier. According to one embodiment of the present disclosure, these energy management policies were created by a (human) EMS administrator 116 and saved in the EMS database 112. Exemplary data tables saved in the EMS database 112 including exemplary policies are shown in FIG. 8 and FIG. 28. Screenshots of exemplary policies are provided in FIGS. 12A-12C, and FIG. 15B. Policies for performing energy efficiency management of assets govern how and when assets are to be turned off/on in order to achieve energy efficiency. These rules are communicated to asset management systems (connected to individual assets) for executing on individual assets. For example, a policy could indicate turning off assets in a certain facility at 7 pm and turning them on at 6 am. Another policy could involve turning off a user's desktop computer if a user's current location (as determined by the user's employee security badge, for example) is on a different floor from the user's office (and, hence, most of the user's assets).

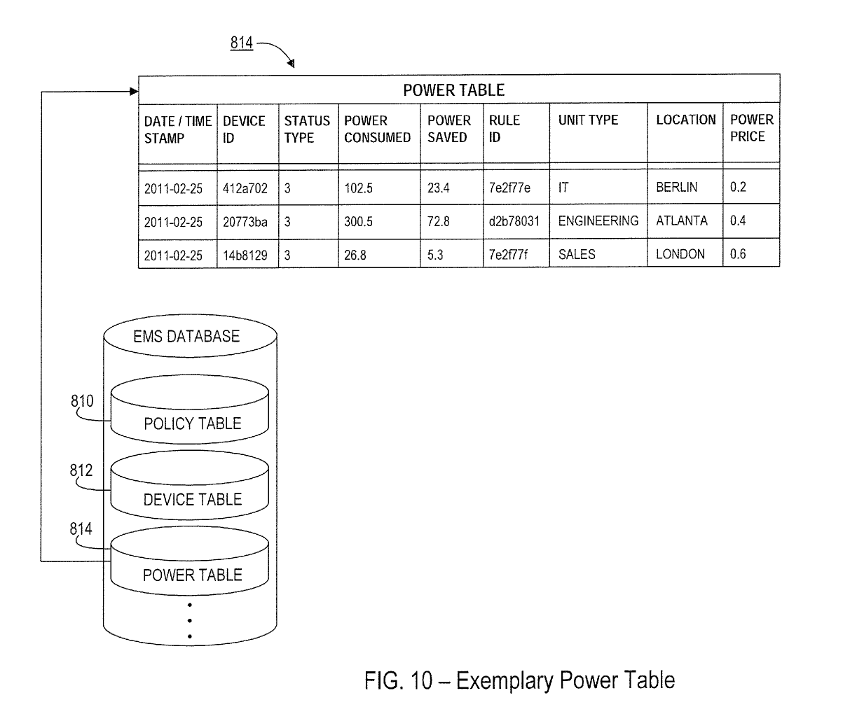

At steps 13 and 14, respectively, the EMS management module 114 connects to individual assets located at facilities, using asset connectors and/or device proxies maintained within the EMS, and applies/executes energy management policies on respective assets. Finally, at step 15, the EMS displays energy management reports of assets to an EMS administrator 116. A data table showing exemplary report saved in the EMS database 112 is shown in FIG. 10. Exemplary reports are illustrated in FIGS. 11A, 11B, 13 and 14. As will be understood and appreciated, embodiments of the present disclosure are not limited to the specific processes or sequences for energy efficiency management as discussed in FIG. 3, and other embodiments may implement other processes as will occur to one of ordinary skill in the art.

In an exemplary alternate embodiment, aspects of the present disclosure relate to remote management of assets or power consumed by assets located at various geographically distributed facilities, on the basis of an instantaneous location of a user's mobile device that is associated with one or more assets housed in a facility. Such an exemplary embodiment is described in FIG. 16, and other subsequent figures described herein. A sequence diagram displaying interactions among various system components in the alternate embodiment, is shown in FIG. 19.

Turning now to FIG. 4, a flowchart representing a high-level process 400 of energy efficiency management performed by various modules and software components that comprise an embodiment of the EMS is shown. Details of steps performed by individual software components are explained in FIGS. 5A-7B. As will be understood and appreciated, the steps of the process 400 shown in FIG. 4 are not necessarily completed in the order shown, and various processes of the EMS may operate concurrently and continuously. Accordingly, the steps shown in FIG. 4 are generally asynchronous and independent, computer-implemented, tied to particular machines (including various modules/engines of the EMS management module 114, EMS servers, and end devices), and not necessarily performed in the order shown.

Starting at step 402, the EMS 110 (specifically, the implementation engine 208) is configured by retrieving asset information from various assets and storing the retrieved information in the EMS database 112 using asset management systems and asset connectors. As recited previously, during this configuration phase, asset information retrieved may comprise various attributes related to asset type, model number, manufacturer, network name/address associated with device, and the like. At step 410, retrieved asset information is stored in the EMS database 112. As can be seen from FIG. 4, in one embodiment, steps 402, 406 and 410 are performed by an implementation engine 208 in a repetitive and iterative fashion (indicated with dotted line 408). In other words, asset information is periodically synchronized/updated in order to ensure all device data is up-to-date. Details of steps performed by the implementation engine are explained with a flowchart in FIGS. 5A and 5B.

Continuing with FIG. 4, it can be further seen that a sequence of next steps executed within the EMS are performed by an embodiment of the device monitoring engine 210 and policy engine 212 concurrently. Generally, the steps performed by the policy engine 212 include applying/executing policies for energy efficiency management of individual assets, whereas, steps performed by the device monitoring engine 210 are executed primarily for purposes of monitoring power consumption of individual assets. Thus, it can be understood that, in one embodiment, the steps performed by the device monitoring engine 210 and policy engine 212 occur in parallel and may be dependent upon each other. For the sake of explanation in this document, steps performed by the device monitoring engine 210 (comprising steps 414, 418, 422, and 426, and shown as the left sub-branch of the flowchart 400) are explained first, and then the steps performed by the policy engine 212 (comprising steps 430, 434, 438 and 442, and shown as the right sub-branch of the flowchart) are explained thereafter.

At step 414, the EMS (via the device monitoring engine 210) retrieves asset information stored in the EMS database 112. Retrieved asset information is generally used to connect (at step 418) to individual assets, for the purposes of monitoring individual assets. According to one embodiment of the present disclosure, device proxies are used to connect to individual assets. As describe above, a device proxy generally comprises a communication algorithm that is specific to a particular device type to enable communications with a given device. According to another embodiment of the present disclosure, both asset connectors and device proxies are used to connect to individual assets. In embodiments in which both device proxies and asset connectors are used, asset management systems connected to such assets provide power profile information of respective assets. As mentioned above, examples of power profile information include (but are not limited to) real-time power consumption of the device, duration of time for which device has been operational, etc.

At step 422, current energy information or power profile information (and potentially other information relative to the device) is retrieved by the device monitoring engine 210. As mentioned above, examples of additional information include information relating to peripheral devices (monitors, printers, etc.) connected to the assets, hardware configurations of the assets, etc. Generally, power profile information and additional information retrieved from assets is stored in the EMS database 114 at step 426. As recited previously, the device monitoring engine 210 periodically monitors assets in order to keep up-to-date information of assets in the EMS database 112, and thus reverts back to step 414 periodically (indicated with dotted line 428). In one embodiment, this periodic execution of the device monitoring process may be executed every few seconds, or minutes, or hours, etc., depending upon the desires of a system user or administrator. Details of steps performed by the device monitoring engine 210 are explained with the help of a flowchart in FIG. 6A and FIG. 6B.

Described next is a high-level summary of steps performed by an embodiment of the policy engine 212 for executing energy management policies, in parallel with the device monitoring engine 210. (An alternate embodiment of the policy engine 212 relating to remote power management of devices housed in a facility based on an instantaneous location of a user's mobile device is described subsequently herein in connection with FIG. 20B.) Continuing with FIG. 4, at step 430, policy engine 212 receives policies for performing energy efficiency management. According to one embodiment of the present disclosure, such policies are generated or created by an EMS administrator 116 or user through a policy-creation interface (not shown) and pre-stored in the EMS database 114. (Exemplary policies are shown in FIG. 8, FIGS. 12A-12C, and FIG. 28.) At next step 434, the policy engine 212 applies policies for performing energy efficiency management of assets, using associated power profile information and/or device profile information stored in the EMS database 114. Policies or rules for performing energy efficiency management of assets govern various aspects of the energy state or power state of a device, including how and when assets are to be turned off/on in order to achieve energy efficiency. Various other embodiments of rules relate to other actions to be taken with respect to devices, including providing information relating to the device to a system user, or storing certain information automatically in a database, or providing an alert to a system user, etc. These rules are processed by the EMS and actions associated with rules are communicated with the help of asset connectors and/or device proxies in order to be executed on the individual assets/device in step 442.

In an exemplary alternate embodiment, aspects of the present disclosure relate to remote management of power consumed by assets located at various geographically distributed facilities, on the basis of an instantaneous location of a user's mobile device that is associated with one or more assets housed in a facility. A flowchart showing process steps performed by various software modules and components in the alternate embodiment, is shown in FIG. 20 (consisting of FIG. 20A and FIG. 20B).

Continuing with the discussion of FIG. 4, it will be understood that a policy (or synonymously, a rule) is comprised of one or more associated conditions and actions. Generally, rules include directions to conduct one or more specific actions on one or more assets depending on satisfactions of one or more conditions. Generally, conditions are criteria that are required to be satisfied to enable actions for energy efficiency management to be executed with respect to assets. For example, in an exemplary rule that dictates turning off assets in an Atlanta office at 7 pm and turning them on at 6 am on weekdays, the action involved is turning off and turning on assets. The set of conditions comprises (a) dates and times, i.e., every weekday 7 pm, every weekday 6 am, and (b) location, i.e., an Atlanta office; at which actions (turning off and turning on take place) are executed.

At step 438, the policy engine verifies that the set of conditions in a give rule have been satisfied. In the above example, all assets in Atlanta office satisfy these conditions and hence are turned off on weekdays at 7 pm, and turned back on at 6 am. If the assets do not satisfy the conditions, the policy engine 212 proceeds to process the next rule by reverting back to step 434, until all rules have been processed. According to one embodiment, one or more rules are generated within and/or provided to the EMS 110 either during initialization of the EMS 110, or during normal operations of the EMS. These rules are generally stored in a policy table in the EMS database 112.

In an alternate example of a policy involving a user' mobile device, a rule could indicate turning off assets in a certain facility on weekends. However, another rule in the policy table could indicate that such assets are to be turned off if a current location of a user's mobile phone is beyond 2 (two) miles from the facility, and such assets are to be turned on otherwise (i.e., if the user's mobile phone is within 2 miles of the facility). In one aspect of the present disclosure, a predetermined priority consideration sequence would assign a higher priority to policies involving the location of a user's mobile device. So, if, for example, the instantaneous location of a user's mobile device indicates that the user is within 2 (two) miles of the facility on a weekend, then the assets associated with that mobile device will be turned on. Of course, priority could work in the opposite way as well (i.e., an overarching policy relating to weekend activation of assets could be controlling, such that the user's location would be given secondary considerations). Further information relating to such location-based policies is provided in greater detail subsequently herein. Exemplary policy tables are shown in FIG. 8 and FIG. 28.

Still referring to FIG. 4, it will be understood that if the conditions of a given rule have been satisfied, then action(s) associated with that rule are executed (at step 442) with respect to aspects that are encompassed by the rule. As recited previously, policy engine 212 periodically synchronizes with assets for the purposes of applying rules vis-à-vis controlling individual assets, and thus reverts back to step 434 periodically (indicated with dotted line 444 in FIG. 4).

Finally, it can be seen from FIG. 4 that resultant effects of monitoring and control of assets are displayed in the form of reports at step 446, by (in one embodiment) reporting engine 214. According to one embodiment of the present disclosure, the EMS generates various reports and analytical tools relating to device profile information and power profile information, and a system user reviews the energy efficiency management reports through a graphical-user-interface, along with detailed analytics related to power consumption and cost savings. Exemplary screenshots showing various reports are indicated in FIGS. 11A, 11B, FIG. 13 and FIG. 14.

Now referring to FIG. 5A and FIG. 5B, a flowchart 500 showing computer-implemented method steps involved in configuring an EMS at one or more facilities is described. Starting at step 504, an embodiment of the implementation engine 208 retrieves a list of asset connectors from within the EMS. As can be seen in FIG. 2, in use, asset connectors are connected with a network in order to discover and import information relating to assets into the EMS 110, with the help of asset management systems 202. As will be described later, given identifying attributes like a network address and hostname, an asset connector opens a remote connection with an asset management system in order to communicate with assets. Generally, asset connectors comprises predetermined algorithms that are specific to a given device type or other predefined criteria, and enable communication with specific, predetermined types of assets. For instance, the EMS may us asset connector 206A to import all WINDOWS™ computers from an asset management system like Active Directory. In another example, asset connector 206B are used to automatically discover monitors and printers housed in a facility, and so on.

As will be understood by a person skilled in the art, in many situations, some assets are not IP enabled, or assets may be unique to some organizations. For example, lighting equipment or specific mechanical machinery in a factory might not have the ability to connect to a network. In such situations, an asset connector can be combined with data sources like SAP to retrieve information from such assets, using database connectors (like ODBC, or Comma Separated File for example), for importing such assets into EMS 110.

At step 508, a counter is initialized to a first asset connector in a list of asset connectors. Then, at step 512, the EMS remotely connects to an asset management system associated with said asset connector. After connection is established, the EMS (e.g., via the implementation engine 208) retrieves (at step 516) a list of assets connected with respective asset management system. For example, an asset connector is used to communicate with an asset management system like Active Directory to retrieve/import all WINDOWS™ computers into the EMS 110. After retrieval of list of assets, at step 518, the EMS initializes a counter to point to a first device in that list. Next, at step 520, the EMS retrieves device information for said device from an asset management system. As will be understood, asset management systems provide information (about assets) in the form of various attributes, for example, IP address of assets, hostname of assets, location, business unit, etc. Exemplary attributes (indicated in columns) along with representative device data are shown in FIG. 9 and FIG. 27.

In an exemplary alternate embodiment, aspects of the implementation engine 208 are used in remote management of power consumed by assets located at various geographically distributed facilities, on the basis of an instantaneous location of a user's mobile device that is associated with one or more assets housed in a facility. Such an exemplary embodiment is described in FIG. 16. A flowchart showing process steps performed by various software modules including the implementation engine 208, is shown in FIG. 20 (consisting of FIG. 20A and FIG. 20B).

In many situations, asset management systems are not configured to group assets based on specific attributes. For example, in many organizations, Active Directory (an asset management associated with WINDOWS™ computers) is not configured to organize assets according to the location or business unit of the assets. In such situations, asset connectors can be used to assign locations and business units to assets. Furthermore, in another example, asset connectors can be used to assign various assets in an organizational hierarchy into subnets or sub domains of an IP network. As will be understood and appreciated, this methodology of abstracting assets with a standard set of attributes provides a way of importing and further classifying various assets in EMS, and further enables normalized monitoring and control of assets.

In one embodiment, several asset connectors are used to import assets and communicate with asset management systems. Generally, asset connectors are configured to communicate with particular asset management systems, and will include communication protocols and criteria corresponding to the particular asset management systems. According to one embodiment of the present disclosure, assets are imported by an EMS administrator through an interface, by using one or more asset connectors. An exemplary screenshot showing exemplary asset connectors as displayed through an interface to an EMS administrator for importing assets into the EMS 110 is shown in FIG. 15A. According to another embodiment, a scripting language (for example, JavaScript) can be used to import assets into an EMS 110, using several asset connectors. In one embodiment, information retrieved from several asset connectors is merged by the EMS into a single device profile for an asset in order to limit multiple copies of identical information retrieved from several asset connectors, and in order to consolidate and aggregate all available asset information.

Referring to FIG. 5B, at step 524, the EMS verifies if a device profile (retrieved at step 520) corresponding to a given asset already exists in the EMS database 112. As will be understood and appreciated, a device profile generally comprises a collection of data stored within an embodiment of the EMS relating to the characteristics of a given device. If device profile does not exist in the EMS database 112 for the given device, then a new entry for said device is first created at step 528. If, however, a device profile already exists for the given device, or after a new entry for the device is created, the device profile is updated (at step 532) based on the device information retrieved at step 520. After the device profile has been updated, the EMS (via the implementation engine 208) verifies (at step 536) that all devices (in list of devices obtained from asset management system at step 516) have been polled. In case all devices have been polled, the EMS moves on to a next asset connector (in list of asset connectors collected at step 504) by incrementing (at step 540) a counter to point to the next asset connector, and reverts back to step 512. Alternatively, if at step 536, the EMS determines that all devices have not been polled, then the EMS moves to the next device in list of devices, and thus reverts back to step 520.

As recited previously in FIG. 4, embodiments of the EMS periodically synchronize with assets in order to retrieve device information, and update the corresponding device profiles. In other words, the steps of the process explained in FIG. 5 are generally performed at periodic intervals of time. This ensures that the device profile stored in the EMS database 112 is current and up-to-date for purposes of monitoring power consumption (as performed by an embodiment of the device monitoring engine 210 and explained in FIGS. 6A, 6B and 20A) and execution of energy efficiency management policies (as performed by a policy engine and explained in FIGS. 7A, 7B and 20B).

Now referring to FIGS. 6A and 6B, a flowchart illustrating computer-implemented steps performed in monitoring power consumed by individual assets is described. According to one embodiment, the steps shown in FIG. 6 are performed by a device monitoring engine 210 maintained within an embodiment of the EMS. Starting at step 602, the EMS initializes a counter to point to a first device in a list of devices that are to be monitored. (As will be understood, a list of devices that are to be monitored have their device profile information pre-stored in the EMS database 112, as explained in FIG. 5). At next step 606, based on information stored in the device profile, an asset type is identified for a given asset. At next step 610, a device proxy associated with the asset is selected by the EMS. In other words, the EMS maps an asset type to an associated device proxy. Generally, device proxies are predetermined algorithms that enable communications with individual devices based on the device type or other device attributes. For instance, if a device profile indicates an asset is a WINDOWS™ computer, then a device proxy supporting Windows Management Instrumentation (WMI) associated with WINDOWS™ computers is selected for communication.

Next, at step 614, the EMS connects to asset to enable information retrieval from the asset. According to one embodiment of the present disclosure, the EMS connects with individual assets using device proxies associated with such assets. According to another embodiment of the present disclosure, the EMS connects with individual assets using a combination of associated device proxies, and associated asset connectors for such assets. In this second embodiment, the asset connector communicates with an asset management system associated with a facility to enable information retrieval from the device. As will be understood, other communication mechanisms can be used as will occur to one of ordinary skill in the art.

After a connection is established with an asset, various attributes related to power or energy information is retrieved for a respective asset, at step 618. Examples of different attributes of power information include real-time power consumption of device, duration of time for which device has been operational, power state of device (on/off/hibernate modes), and various other such power-related details. Power information retrieved from an asset is utilized by the EMS to determine whether the asset is turned off or on, or is in some other power state. In one embodiment, if the asset is not turned off, additional information is retrieved from the asset (step 626). In addition to power information, the EMS also collects additional information from assets, such as hardware configurations of assets, additional devices connected to assets like printers, monitors, scanners, audio speakers, etc., current load/utilization information of a respective asset, operational temperature of an asset, etc. After such information is obtained from assets that are turned on, or, in case, an asset is turned off, the EMS computes a power profile for the asset at step 630 to arrive at a value for power consumed by an asset (either currently or over a predetermined time period). Generally, a power profile is a collection of information relating to power attributes of a given device at a certain time (or over a period of time), and the power profile is stored in a database for subsequent processing and use.

According to one embodiment of the present system, a value for power consumed by an asset includes actually measuring power consumed by an asset in real-time, by sensors that are pre-installed on an asset. For example, manufacturers of computing devices like computers and servers often pre-install on-board sensors that measure total power consumed by such devices. Hence, assets which have sensors to measure power can provide the EMS with a direct measurement of power consumed by such assets.

According to another embodiment of the present system, a pre-existing proprietary software algorithm is used to estimate power consumed by assets, determined by power consumed by various physical hardware components of an asset. Examples of such hardware components may include: a type of processor, type of graphic card, and various other such components. As will be understood by one skilled in the art, various hardware components measure their respective power consumption. According to one embodiment, a software algorithm is designed to arrive at a low estimate and a high estimate of the power consumed by an asset, using measured values of power reported by various hardware components within the asset. High and low estimates of power consumed by various hardware components are further used along with current load/utilization values of a respective asset, to arrive at an actual estimate of power consumed by the respective asset.

According to yet another embodiment of the present disclosure, typical or average values of power consumed by various types of assets at given loads, energy states, or utilizations are pre-stored in an EMS database 112 or in a “cloud” database. Thus, given a particular energy state of a given asset (e.g., on, off, or hibernate mode), an estimated value of power consumed by that assets can be obtained using a database lookup.

At next step 634, the EMS saves or updates the power profile of the given asset based on the retrieved and/or calculated power information in the EMS database 112. As will be described in greater detail below, this information is utilized by a policy engine 212 to execute various energy management policies, as explained with a flowchart in FIGS. 7A and 7B. At step 638, the EMS verifies whether or not all devices (with pre-stored device profile in the EMS database 112) that are to be monitored have been polled. In case all devices have not been polled, the EMS moves on to a next device by incrementing (at step 646) counter to point to next device, and reverts back to step 606.

Once all devices have been polled, the EMS delays a pre-determined interval of time, and then reverts back to step 602. According to one embodiment of the present disclosure, this pre-determined interval of time can be set by an EMS administrator through an interactive user interface. As will be understood, this predetermined interval of time could be virtually continuous (polling every few seconds or less), or could be longer (once every hour or few hours) depending upon the system capabilities of the given EMS and the desires of the system user. An exemplary screenshot showing settings for adjusting the pre-determined interval of time is shown in FIG. 15D. According to another embodiment of the present disclosure, a scripting language (like JavaScript) can be used to set or adjust the pre-determined interval of time for performing monitoring of power consumed by assets. As recited previously, the EMS performs periodic monitoring of devices in order to ensure that power consumption information of assets is up-to-date in the EMS database 112.

In an exemplary alternate embodiment, aspects of the device monitoring engine 210 are used in remote management of power consumed by assets located at various geographically distributed facilities on the basis of an instantaneous location of a user's mobile device that is associated with one or more assets housed in a facility. Such an exemplary embodiment is described in FIG. 16. A flowchart showing process steps performed by various software modules including the device monitoring engine 210, is shown in FIG. 20 (consisting of FIG. 20A and FIG. 20B).

Turning now to FIGS. 7A and 7B, a flowchart is shown that describes a computer-implemented method of executing various policies for energy efficiency management of assets. According to one embodiment, the processes and steps 700 shown in FIG. 7 are carried out by a policy engine 212 within an embodiment of the EMS. An alternate embodiment of the policy engine 212 relating to remote power management of devices housed in a facility based on an instantaneous location of a user's mobile device is described in connection with FIG. 20B.

As recited previously, policies comprise rules (directions) that incorporate conditions that govern, for example, how, where and when assets are to be controlled (e.g., turned off), or govern certain actions to be taken with respect to assets. According to one embodiment of the present disclosure, policies are created by an EMS administrator, through an interactive graphical user interface (GUI) provided by the EMS. According to another embodiment, a scripting language (for example, JavaScript) can be used to specify rules for energy efficiency management. One or more policies are received by the EMS and executed on assets, as indicated in the policy.

As recited previously, a policy/rule is an abstract collection of conditions and actions. In one embodiment, rules are directions to conduct one or more specific actions on one or more assets depending on satisfaction of a set of conditions. Conditions are criteria that are required to be satisfied so that actions for energy efficiency management can be executed on assets. For example, in an exemplary rule that states turning off assets in Atlanta office at 7 pm and turning them on at 6 am, the action involved is turning off and turning on assets. The set of conditions comprise of (a) dates and times, i.e., every weekday 7 pm, every weekday 6 am, and (b) location, i.e., Atlanta office; at which actions (turning off and turning on take place) are executed.

Moreover, it can be observed that in this exemplary policy recited immediately above, a terminating condition is not specified, i.e., when said policy will cease to be executed. As a result, in one embodiment, such a policy will continue to be executed until it is terminated by an EMS administrator. As will be understood, more than one policy for performing energy efficiency management can be executed on a given asset or group of assets. According to one embodiment of the present disclosure, multiple policies can be ordered according to a predetermined sequence so that one policy has higher priority over other policies. In such a case, a policy that has a higher priority will first execute its associated actions for energy efficiency management, before a policy that has a lower priority. As will be understood and appreciated, the priority or hierarchy of policies may be dictated by an EMS user, or EMS administrator, or preconfigured within the EMS, etc. As will be further understood by a person skilled in the art, this ranking mechanism could automatically render a policy that has a lower priority as being inoperative. This is better illustrated with an example: assume a higher priority policy indicates “Turning off all assets in a Sales department for one week”, and a lower priority policy indicates “Hibernating all assets between 12 noon and 1 pm.” Because all assets have been turned off, based on the higher priority policy, the lower priority policy is rendered inoperative automatically. This, and various other aspects of the process of executing energy efficiency management policies will be better understood with the help of process 700 as discussed below.

Still referring to FIG. 7A, starting at step 702, the EMS initializes a first counter to a first device in a list of devices that are to be managed/controlled. As previously mentioned in relation to FIGS. 5 and 6, in one embodiment, devices that are to be managed and/or controlled have their device profile information and power profile information pre-stored in the EMS database 112. As will be understood, a policy table (for example as shown in FIG. 8 and FIG. 28) contains several energy management rules for execution on assets. In one embodiment, the policies are ranked according to a predetermined sequence so that one rule has higher priority over other rules in the policy table. Thus, if two or more policies apply to a given asset simultaneously, the higher “ranked” (e.g., more important) policy is the one that will control and ultimately be implemented with respect to the asset. According to one embodiment of the present disclosure, a rule in a policy table can be disabled or enabled by a human EMS administrator. Enabling/disabling a rule causes a rule to be activated/deactivated. In other words, if a rule is disabled, it is not executed by the EMS 110, although it is specified in a policy table in the EMS database 112 for potential later use. Accordingly, at step 706, a second counter is initialized to point to a first enabled rule in a policy table. As mentioned previously, a rule is associated with one or more conditions that are to be satisfied for the rule to be executed. Generally, conditions are specified when a policy is created. Conditions typically depend on asset type, associated business unit, asset location, date/time when policies are to be executed, power state (on/off/hibernate etc.) of assets, power consumed by assets, software and programs running on assets, usage of a user's mobile device to remotely monitor and manage assets associated with a user's mobile device, and several other such factors. (Exemplary policies (rules) and conditions are illustrated with a policy tables in FIG. 8 and FIG. 28, and also with screenshots in FIGS. 11A, 11B.)

Hence at step 710, policy engine 212 determines whether a current asset satisfies conditions specified in a current rule. For example, a rule could indicate turning off assets in a certain facility at 7 pm and turning them on at 6 am. Another rule could indicate turning off all assets at a specific business unit for a certain number of days. Yet another rule could indicate turning off laptops and desktops that are not running a particular application, for example programs like MICROSOFT OFFICE™ or MICROSOFT POWERPONT™. Generally, whether or not a policy has been satisfied is determined by comparing information for a given asset maintained in its respective power profile and/or device profile to criteria (conditions) included in the given policy. If the conditions are satisfied based on information in the respective profiles, then the policy may be deemed satisfied (and the corresponding action may be executed).

As will be understood by a person of ordinary skill in the art, a given device may not satisfy conditions specified in a rule. For example, if an action associated with a rule comprises turning off assets in an Atlanta facility, then assets located in a New York facility, for example, will not satisfy this rule. However, it could be possible, for example, that another rule in a set of rules indicates hibernating all assets in North America. Accordingly, conditions in such a rule are satisfied by assets located in the Atlanta facility as well as assets located in the New York facility. Thus, in one embodiment, if a given device/asset does not satisfy conditions specified in a current rule, the policy engine 212 will check whether or not any other rule in a policy table is remaining to be checked for execution with respect to the current asset. In other words, at step 712, the EMS determines whether or not all rules in a policy table have been checked for execution with respect to a given device. As will be understood and appreciated, a policy table generally comprises one or more policies or rules.

If all rules have not been checked with respect to a given device, then a second counter is incremented (at step 718) to point to the next enabled rule in a policy table, and subsequently the process reverts back to step 710. If information associated with the current asset satisfies conditions specified in the current rule at step 710, the policy engine 212 provides instructions to said device (e.g., via a device proxy), and executes actions in that rule at step 722. As previously recited, asset connectors and/or device proxies in the EMS 110 are used to connect with said asset for executing actions in a rule. Further, execution of energy management policies involves performing action(s) on an asset, for example, changing the power state of an asset (on/off/hibernate). It will be understood that the EMS can perform various other changes to the power state of an asset, and not limited to those discussed herein. Even further, conditions can depend on several factors like date/time, location, network address, business unit, processor installed on asset, operating system running on asset, programs running on asset, runtime conditions on asset, etc, and are not limited to the embodiments disclosed herein. According to one embodiment of the present disclosure, a script developed by a programmer is used to specify conditions for executing energy management rules. According to another embodiment of the present disclosure, conditions are specified through a user interface by an EMS administrator.

After a current rule has been executed (at step 722) on a current asset, the EMS determines whether or not all rules in a policy table have been checked for application on the current asset. For example, in some circumstances, a given asset may be subject to more than one rule (i.e., the conditions in more than one rule may be satisfied by device information or power information associated with the given asset). Because of this possibility, in one embodiment, all rules are checked against a given asset, even if a rule is encountered that includes conditions that are satisfied by information associated with the asset. In this situation, and as will be understood and appreciated, although many rules may be executed against a given asset, only one rule will ultimately prevail and control (and its corresponding action will be executed). Specifically, in one embodiment, the steps shown in process 700 are executed virtually instantaneously and simultaneously, such that only the rule with the highest priority is truly implemented with respect to an asset. All other rules that might be satisfied by the asset are preempted before the action (e.g., changing the power state of a device) can be actually implemented, or the attempt at execution simply returns an error message to the EMS.

In an alternate example of rules involving a user' mobile device, a rule could indicate turning off assets in a certain facility on weekends. However, another rule in the policy table could indicate such assets are to be turned off if a current location of user's mobile phone is beyond 2 (two) miles of the facility, and such assets are to be turned on otherwise. In one aspect of the present disclosure, a predetermined priority consideration sequence would assign a higher priority to policies involving a user's mobile device. So, if for instance, instantaneous location of a user's mobile device indicates that the user is within 2 (two) miles of the facility on a weekend, then the assets associated with that mobile device will be turned on. An exemplary policy table involving usage of a user's current location is shown in FIG. 28.

Once no rules remain to be checked against the current asset (no branch of decision step 712), the EMS moves to step 726 in which it determines whether all assets have been polled for execution of energy management policies. If all assets have been polled, process 700 reverts back to step 702 and the entire process 700 re-starts (e.g., after a pre-determined time delay, or immediately). An exemplary interface to configure a pre-determined time delay, and various other settings is shown in FIG. 15D.

Still referring to FIG. 7B, at step 726, if the policy engine 212 determines that all assets have not been polled, process 700 moves on to increment (at step 730) a second counter to point to the next asset in a list of devices (in the EMS database 112) that are managed. Then, step 706 is executed and rules are again checked against information associated with devices, starting from a first rule in a policy table. As will be understood, the steps of execution of rules (policies) of energy management as described in FIG. 7 are provided for exemplary purposes only. Execution of rules of energy management can be performed according to various alternate embodiments, as will be apparent to a person skilled in the art. For example, rather than iterating through devices for a given rule, a particular policy rule can be selected, and the devices that could pertain to that rule may be iterated. Once complete, a second rule could be selected, and so on.

Now referring to FIG. 8, an exemplary policy table 810 (stored in an EMS database 112) comprising a collection of policies or rules, is shown. An alternate embodiment of a policy table relating to remote power management of devices housed in a facility, based on an instantaneous location of a user's mobile device will be described in connection with FIG. 28.

As recited previously, policies relating to power management (remote or otherwise) are generally created either during initialization of the EMS 110, or during normal operation, and stored in the EMS database 112. These policies/rules can be created/specified by an EMS administrator, or can be configured through a script developed using a scripting language, or preconfigured within the EMS, or developed in some other manner.

As described above, rules provide directions for performing actions with respect to an asset. A rule generally includes one or more conditions. Conditions represent criteria that are used to execute an action with respect to the device. Conditions for actions can be based on date/time, asset type, applications or programs running/not running on assets, custom scripts written by a programmer, business units, locations, run time conditions (for example, power consumed by assets, power state) of assets, etc. As can be seen from FIG. 8, an exemplary first rule indicates hibernating PC's housed in an Atlanta facility between the hours of 12 noon and 1 pm. In this exemplary rule, the action involved with changing the power state of devices is “hibernate”. Conditions include the type of assets (i.e., PC's), location (i.e., Atlanta) associated with such assets, and time duration (i.e., between 12 noon and 1 pm) for application of this exemplary rule. Actions and conditions associated with various rules are further illustrated in data table 811.

As can be seen, a second exemplary rule in policy table 810 indicates turning off PC's in an Atlanta facility between the hours of 7 pm and 7 am. As will be understood, conditions associated with this rule are asset types (PC's), times of application of this rule (between 7 pm and 7 am), and the actions involved comprise of “turning off” and “turning on” assets (PC's).

Furthermore, a third exemplary rule in policy table 810 is illustrated that involves actions (turning off) with asset type (lights) at locations (Tokyo facility). Even further, a fourth exemplary rule in policy table 810 indicates actions (turning off) with asset type (HVAC) at locations (all facilities). As will be understood by a person skilled in the art from these exemplary rules, a variety of rules can be created, each rule further comprising of one or more conditions, in order to perform action(s) for the purposes of providing energy efficiency at homes and organizations. Further, rules, conditions and actions described herein are for the purposes of illustration only. Various other rules, conditions and actions involving different embodiments of the present disclosure can be created/specified. For example, actions need not necessarily relate to physically controlling a given asset—they might dictate that an email notification be sent to a system administrator, or that a certain item of information be stored in a database.

Turning now to FIG. 9, an exemplary device table 812 is shown comprising exemplary attributes associated with devices. An alternate embodiment of a device table relating to remote power management of devices housed in a facility based on an instantaneous location of a user's mobile device will be described in connection with FIG. 27.

The information shown in the device table 812 generally represents the types of information maintained in a device profile for each asset. As shown, the device table comprises attributes named “Date/Time Stamp”, “Device ID”, “Device Type”, “Status Type”, “Asset Connector”, “Host Name”, “URL”, “Model type”, and “System Type”. For example, the Date/Time Stamp column indicates a date and a time when a device was polled, or when a device profile was last updated. A Device ID column is a unique identifier for a device, a Device Type column identifies a type of device, a Status type column indicates a power state (for example, on/off/hibernate etc.) of a device at the date and time it was polled, an Asset Connector column specifies an associated asset connector for the device, a Host Name indicates a device label for various forms of IT network communication that a device utilizes, a URL (Uniform Resource Locator) identifies a network address for a device, a Model Type column indicates a model number for a device, and a System Type specifies a generic system or purpose associated with a device.

For example, as can be seen from the data entries in device table 812, on a Date/Time Stamp “2011-02-24 10:50 AM”, a device identified by a Device ID “412a702” is associated with a Device Type “PC.Windows”, i.e., a WINDOWS™ PC, in a Status Type (power state of device) “3”. As will be understood by a person skilled in the art, various power states may be represented in the EMS 110 as numbers, for example “0” may indicate a device is powered off, “1” indicates a device is on standby power mode, “2” indicates a device is in hibernate power mode, “3” indicates a device is powered on, etc. It will be understood that other numbering schemes can be used to represent various power states of a device, or that no numbering scheme be used.

Continuing with further attributes of a device identified by a Device ID “412a702” in device table 812, an Asset Connector “83907b8” is associated with this device, a Host Name “Test-PC2” labeling the device at a URL “10.64.54.27”. Further, Model Type for said device is specified as “DELL LATITUDE™ E6410”, said device having a System Type “Workstation”. It can be seen in FIG. 9 that values for Device ID and Asset Connector are expressed in hexadecimal number format, as is customarily used in representation of most electronic computing devices. However, as will be understood, other numbering systems can also be used, for example, decimal number format, etc. Additionally, it will be further understood that a URI (Uniform Resource Identifier) column can alternatively be used to identify a network address for a device, in place of URL (Uniform Resource Locator) column, as shown in device table 812. Furthermore, as will be understood by one having ordinary skill in the art, the device table 812 is presented for illustrative purposes only, and embodiments of the present system 110 are not limited to data, information, and fields in the specific data table shown.

Now turning to FIG. 10, an exemplary power data table 814 for storing data relating to power profiles of devices in connection with generating energy efficiency management reports, is shown. As shown, a power profile including various types of energy or power data is provided in table 814. As shown in FIG. 10, in one embodiment, power data table 814 includes columns named as “Date/Time Stamp”, “Device ID”, “Status Type”, “Power Consumed”, “Power Saved”, “Rule ID”, “Unit Type”, “Location” and “Power Price”. As recited previously, Date/Time Stamp column indicates a date and a time when a device was last polled, or when the power profile was last updated. Also, as previously recited, a Device ID column is an unique identifier for a device, and a Status type column indicates a power state (for example, on/off/hibernate etc.) of a device at the date and time it was polled. A Power Consumed columns indicates power consumed by a device, for a pre-specified duration of time. It will be understood by a person skilled in the art that power consumed by a device will vary depending on the duration of time a device has been operational, and thus for generating energy management reports, a duration is defined in the form of a date and time range. According to one embodiment of the present disclosure, an EMS administrator indicates such a duration through an interface. According to another embodiment of the present disclosure, a script developed by a programmer is used to specify such a duration.

Still referring to the power table 814 in FIG. 10, a Power Saved column indicates the power saved by executing energy management policies (for example, by hibernating, powering off, etc.) for a pre-specified duration of time. This column provides helpful measure of energy saved using various policies associated with the given device. Rule ID identifies a rule (more specifically, an energy management policy) that is executed on a device when it was polled. Thus, the Power Saved column generally relates to energy saved based on execution of the rule in the Rule ID column.

Continuing with FIG. 10, Unit Type column indicates a business unit or department associated with a device, Location column specifies a geographical location where a device is located, and Power Price column specifies a energy pricing rate (in price/kilowatt-hour, for example) for energy that is consumed by the device. As can be seen from the power table 814, on a Date/Time Stamp “2011-02-24 10:50 AM”, a device identified by a Device ID “412a702” was in a Status Type (power state of device) “3”. As will be understood by a person skilled in the art, various power states are represented in EMS 110 as numbers, as described above.

Further, as seen from power table 814, a device identified by Device ID “412a702” is characterized with fields in Power Consumed column as “102.5”, indicating that said device has consumed 102.5 watts of power. Further, it can be seen that by executing an energy management policy identified as Rule ID “7e2f77e”, power saved by said device, as indicated in Power Saved column is “23.4” watts. Additionally, it can be seen that said device is located in a Unit Type “IT”, at a location “Berlin” and consuming energy with Power Price “0.2”, i.e. energy pricing rate for power consumed by device is $0.2/kilowatt-hour. As will be understood by one skilled in the art, energy pricing can be expressed in terms of other currencies as well. Again, it will be understood that the types of data and information shown in table 814 are presented merely for illustrative purposes only, and other types of data may be included. It will be further understood that by providing various energy and power measures for various types of device across an organization in one central system enables the organization to easily and efficiently manage power of all its devices organization-wide.

FIG. 11A and FIG. 11B illustrate different exemplary screen views 1100A and 1100B respectively, of a home page (dashboard summary of energy management) of an embodiment of the EMS 110 that are visible to an EMS administrator 116 for review and analysis purposes. As will be understood, these screen shots characterize energy-related information and associated analytics of assets that are housed in one or more facilities, often distributed at several geographical locations. As will occur to those skilled in the art, the EMS (e.g., via reporting engine 214) retrieves values of power consumed by various devices (pre-stored in the EMS database in device profiles and power profiles) along with additional device attributes from the EMS database and displays this information through an interface as displayed in screen shot 1100A and 1100B.

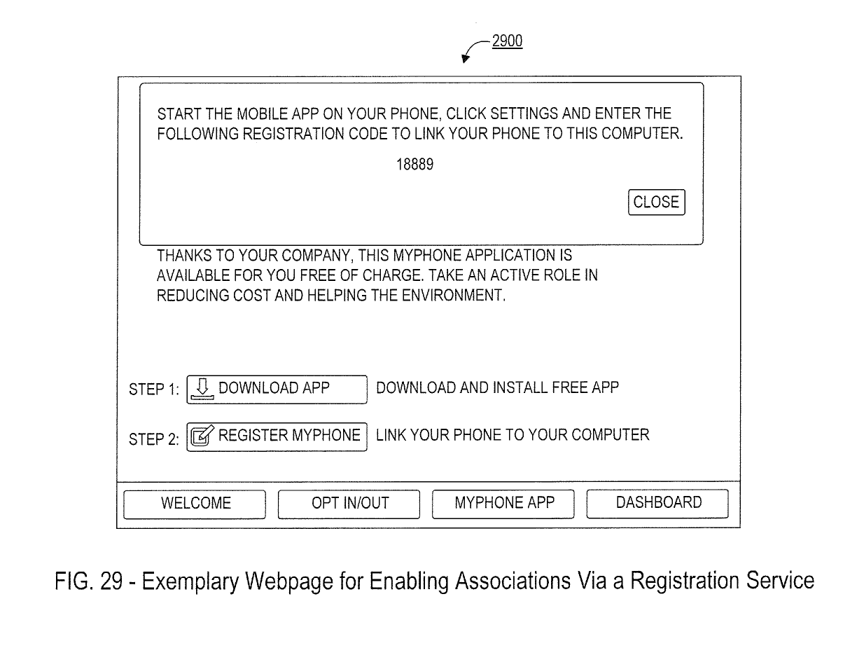

In an exemplary alternate embodiment of the EMS, aspects of the EMS are used in remote management of power consumed by assets located at various geographically distributed facilities on the basis of a real-time location of a user's mobile device that is associated with one or more assets housed in a facility. Such an exemplary embodiment is described in FIG. 16. Screenshots illustrating the alternate embodiment are shown in FIG. 29-FIG. 32, and are described in detail later herein.

Referring first to FIG. 11A, region 1102 is a menu bar displaying various clickable menu selection choices, “Home”, “Policies”, “Devices”, “Reports”, “Apps”, “Settings”. The “Home” menu selection choice is shown highlighted because current screen shot displays the home page of an EMS 110 interface that reveals a dashboard summary of energy management. The “Policies” menu selection choice generally provides an interface to an EMS administrator 116 to interact and define various energy management policies. The “Devices” menu selection choice generally provides an interface to an EMS administrator 116 to review and manage power consumed by individual devices, and also to review non-power-related device-specific information. The “Reports” menu selection choice displays various reports related to power consumption, energy savings and various other analytics extracted from device profiles and/or power profiles of individual devices. As explained previously in detail in FIG. 5 and FIG. 6, in one embodiment, device profiles and power profiles are collected from individual devices by device monitoring engine 210 and policy engine 212 respectively, and pre-stored in an EMS database 112.

The “Apps” menu selection choice provides additional features and functionalities for the usage of mobile phone apps to monitor energy consumption and engage in energy savings and sustainability initiatives. Additionally, “Apps” menu selection choice also provides ways to improve the accuracy of measurement of consumed power of assets. As will be understood by a person skilled in the art, many legacy printers, PC's and other devices do not provide accurate measurement of consumed power, and hence for such devices, power consumed for devices is approximated by the EMS 110. Thus, for example, recommendations to improve the accuracy of measurement of consumed power of such assets, are also provided to an EMS administrator by clicking on the “Apps” menu selection choice.

The “Settings” menu selection choice generally provides an interface to an EMS user 116 to configure multiple options for the EMS 110, in connection with several functionalities. Examples of such functionalities include changing the username/password for an EMS administrator, importing asset information into the EMS 110, defining time zone settings and energy pricing for various assets, providing a list of “protected” assets that are excluded from being subjected to energy management policies, setting up network connections, and many other options that will occur to one skilled in the art.

Still referring to FIG. 11A, region 1104 displays an “energy bar” that reveals a brief summary of energy savings information (“Saved Energy” icon 1122), cost savings information (“Saved Cost” icon 1124), and savings in greenhouse footprint (“Saved C02” icon 1126) based on use of the EMS. For example, it can be seen from screen shot 1100A that 589.99 kWh of energy is saved that translates to $1200.36 savings in cost, and 0.24 kg of CO2 gases of savings in greenhouse footprint. Accordingly, region 1104 provides an overview of various energy and cost savings information that are a result of managing the devices in an organization via an embodiment of the EMS, such as be executing various energy-savings policies with respect to organization devices.

Furthermore, region 1104 also illustrates functionality for adding widgets to a homepage screen, using an “Add a Widget” button. System users reviewing a homepage screen click on this button which opens a dialog box (displaying several widgets) from which they can choose one or more widgets to customize the display of a homepage screen. In one embodiment, widgets provide specific information related to power savings, cost savings, power consumed, energy management rules, and even real time device and power-related information and various other attributes. Because the EMS performs the task of monitoring and managing different types of devices that are located at various facilities, locations, business units etc., different reports and analytics can be extracted connecting a variety of device-related and power-related attributes. By way of example, widgets may show information in relation to real time power utilization, detailed device information, statistics of energy consumption by device type, device location, and many more such informative statistics and reports, as will occur to those skilled in the art. An EMS administrator configures his or her screen shot, based on various statistics and reports that he or she may want to see. As will be understood by a person skilled in the art, an EMS interface is configured with a set of statistics and reports, by default. Exemplary screenshots shown in FIGS. 11A, 11B, 13 and 14 is configured using several widgets.

Still referring to FIG. 11A, region 1106 reveals an overview of current energy/power consumption as a consequence of executing energy management policies, and also a maximum energy/power that would have been consumed if energy management policies were not applied. For example, it can be seen that 0.32 kW of power is being currently consumed whereas 0.40 kW of power would have been consumed if energy management policies were not applied. In another embodiment, region 1106 provides information relating simply to an organization's current power utilization versus its maximum available power available.

Region 1108 in screen shot 1100A reveals graphical statistics in the form of a circular pie-diagram comprising various sectors representing various types of devices that are currently consuming power within an organization or facility. For example, one sector of the pie represents all WINDOWS™ devices, another sector represents switches, and so on. Generally, the area of each sector is proportional to the number (quantity) of devices within a facility of the same type, or to the total power being consumed by devices of that type. For example, it can be seen (in region 1108) that approximately half of the circular pie-diagram is occupied by WINDOWS™ devices, implying that WINDOWS™ devices are about a half of the total number of devices. Quantities of other devices, for example, switches, generic devices (that do not have an associated asset management system), Linux operating system-based devices, etc. are also shown in the circular pie-diagram. As will be understood and appreciated, total power consumed by devices of different types, can also be shown with the help of a pie-diagram or other graphical display.

Referring now to region 1110 in FIG. 11A, a graph reveals a current total power demanded by all devices, as a function of time of the day. For example, in region 1110 it can be seen that total power demanded prior to 8 am is virtually zero (0) kilowatt, but this value increases to about 0.3 kilowatt by 8:30 am, and remains at that value till 9:30 am, after which it increases slightly. Thus, it becomes clear that the power for this exemplary organization increases significantly as employees arrive at the office and power on their respective devices (or as the EMS begins powering on various devices automatically based on predetermined power policies/rules). Further, region 1112 in FIG. 11A indicates total power consumption and associated cost, broken down by various types of devices. For example, it can be seen that switches consume 18.42 kWh of energy, and associated cost is $3.23 (per some predefined time period, e.g., per hour). Also, it can be seen from region 1112 that WINDOWS™ PC's consume 8.98 kWh of energy, and associated cost is $1.31. Power consumed by various types of devices are also represented with shaded horizontal bars, wherein the ratio of the length of the shaded region to the length of the bar graph corresponds to the power consumed by a type of device. As will be understood and appreciated, various power and device information display regions (widgets) may be utilized according to various embodiments of the EMS.

Now referring to FIG. 11B, a screen shot 1100B revealing another dashboard summary of energy management of an embodiment of the EMS 110 is shown. In screen shot 1100B, region 1114 (comprising icons 1128, 1130, 1132, and 1134) displays summary information of devices that are monitored and managed by the EMS. As shown, the total number (quantity) of devices is displayed in region 1128, number of devices that are powered on is displayed in region 1130, number of devices that are powered off is displayed in region 1132, and number of devices that are subject to policies is displayed in region 1134. As will be understood, the regions and quantities shown in regions 1128, 1130, 1132, and 1134 are for illustrative purposes only, and embodiments of the EMS 110 are not limited to the specific information shown.

Continuing with exemplary screen shot 1100B, region 1116 displays current status information of an embodiment of the EMS, for example, whether the EMS is executing energy management policies or not. As shown in exemplary region 1116, a “Running” icon 1136 indicates that policies are currently being executed on various assets. An EMS administrator can click the “Stop” button 1138 to stop executing energy management policies on various assets. In addition, region 1116 also displays a current date and time reported by the EMS.

Still referring to FIG. 11B, region 1118 displays information pertaining to real time energy consumption of assets. This information can be displayed based on different geographical locations, different types of devices, and several other factors. Furthermore, such information can be reported every minute, every hour, every two hours, or at virtually any other defined time interval. Menu button 1140 provides functionality to choose various time intervals at which information pertaining to real time energy consumption of assets is reported. Menu button 1142 is used to choose various power-related statistics and metrics, for example, minimum and maximum average power consumed, real time power consumed by all devices, average power consumed by devices that are turned on, and various other metrics. These metrics are further illustrated graphically. For example, as shown in region 1118, real time power consumed by all devices housed at various locations are illustrated with a circular pie-diagram in which sectors of the pie-diagram represent various locations that are managed by the EMS. As will be understood, assets (devices) are housed in facilities at different geographical locations, for example, Paris, Berlin, Tokyo, London, etc. Energy consumed by individual assets are measured, monitored and controlled by the EMS. As can be understood by a person skilled in the art, energy consumed by individual assets located at a geographical location is used to obtain a total energy consumed by assets located at that geographical location. Thus, total energy consumed by assets is displayed as a pie-diagram (comprising of several sectors) where area of a sector of the pie-diagram is proportional to the total energy consumed by assets at a geographical location. As will be understood and appreciated, other reporting and analytical tools, such as bar graphs, line diagrams, number displays, and the like may be used as opposed to a pie chart.

Referring to FIG. 12, comprising FIGS. 12A, 12B, and 12C, illustrative screenshots 1200A, 1200B, and 1200C are shown of exemplary EMS interfaces for creating and managing policies (or rules) for management of energy efficiency for various devices. In an exemplary alternate embodiment, such policies (or rules) for management of energy efficiency for various devices relate to an instantaneous location of a user's mobile device that is associated with one or more devices. Policies involving usage of a location of a user's mobile device are described in connection with FIG. 28.

As shown in FIG. 12A, in one embodiment, a rule is specified by clicking button 1203 (“Add New Rule”). Although not shown here, it will be understood that clicking button 1203 opens up a dialog box for specifying a name of a rule, and also conditions (by clicking on a “Conditions” button) and actions (by clicking on an “Actions” button) associated with a rule. For example, it will be understood that clicking on “Conditions” button 1205 opens up a dialog box, and an EMS administrator can specify, define, or select one or more conditions. As recited previously, conditions are based on a combination of one or more of the following attributes: asset type, asset location, date and/or time, or even a time-pattern (daily, weekly, hourly, etc.), software programs running on assets, and various others. According to one embodiment of the present disclosure, scripts can be used to specify conditions, rules, actions, perform queries, and various computational tasks, written by a software developer, and provided to the EMS through an interface. In another embodiment, various available conditions and actions are selected from a predetermined list or drop down menu of available conditions and actions. In addition, as will be understood by one skilled in the art, conditions can be triggered by specific red-flag events like emergencies, fires in a facility, power outages, any various other events. Generally, the EMS obtains information regarding the occurrence of such event(s) from asset management systems located at facilities, or from other sources. A pre-stored script written by a programmer may instruct the EMS to override regular EMS operating rules.

In screen shot 1200A, region 1202 displays a “Rules Menu” that is used to control the creation, management, and display of various rules. For example, a system user reviewing this interface can choose to review rules that are enabled, or, rules that are disabled, or all rules consisting of both enabled as well as disabled rules. As recited previously, enabling a rule causes a rule to be activated, whereas disabling a rule causes it to be deactivated. In other words, if a rule is disabled, it is not executed by the EMS, although it is specified in a policy table in EMS Database 112. According to one embodiment of the present disclosure, an EMS administrator enables (or disables) rules using a slider button 1207. As can be understood by a person skilled in the art, a slider button is a graphical user interface control that moves horizontally to the right/left inside a region and is used to turn on/turn off features in an interface. Thus, a policy is enabled or disabled by moving Slider button 1207 to an ON or OFF position. For example, an exemplary rule displayed in region 1212 is turned off (disabled), whereas another rule displayed in region 1208 is turned on (enabled). As can be seen from region 1202, “All Rules” is shown highlighted indicating that a human EMS administrator chooses to review both enabled and disabled rules. As will be further understood, a “slider button” is but one exemplary way for a system user to manipulate rules to control whether they are activated or deactivated, and any other conventional mechanism for doing so is within the scope of the present disclosure.

Still referring to screen shot 1200A, button 1204 (“Conditions and Actions”) and button 1206 (Statistics) provide control of display (to an EMS administrator) of various rules. In particular, clicking on button 1204 causes the conditions and actions associated with a rule to be displayed. Further, clicking on button 1206 causes various statistics (related to number of devices being controlled by the EMS and savings obtained, as explained later) to be displayed.

As can be seen from screen shot 1200A, region 1212 displays a rule that is entitled “ALL Hibernate For Lunch”. Associated conditions (displayed in region 1205) for this rule indicate conditions including assets on which this rule is executed (WINDOWS™ PCs and LINUX™ PCs which have a screensaver program running on weekdays). Although not shown in screen shot 1200A, it will be understood that times of the day during which this rule is executed is also specified, for example, between 12 noon and 1 pm. Additionally, it will be understood that this rule is executed on assets housed at every location (given that a location is not specified). Associated actions (displayed in region 1205) for this rule indicate hibernation of assets (“Hibernate” icon 1213). Further, it can also be seen that additional statistics related to the number of devices being controlled, cost savings and energy savings are also displayed. For the exemplary rule displayed in region 1208, it can be seen that the total number of devices being controlled by this rule is “980”, and as a consequence of hibernating these devices between 12 noon and 1 pm, total saved cost is $2500.63 and total saved energy is 35.9 kWh.

As can be seen from exemplary screen shot 1200A, region 1208 displays another rule entitled “Sales Atlanta Off”. It can be further seen in region 1208 that conditions (displayed in region 1205) for this rule indicate “All devices in Sales Unit in Atlanta”, and actions (displayed in region 1209) for this rule indicate “Power Off”. As will be understood, this rule involves switching off all devices in the sales business unit located in the Atlanta location. Furthermore, additional statistics relating to the number of devices being controlled, cost savings and energy savings are also displayed. For the exemplary rule displayed in region 1208, it can be seen that the number of devices being controlled in the sales business unit in Atlanta is “75”, and as a consequence of powering off these devices, total saved cost is “$450.32” and total saved energy is 5.2 kWh.

A third exemplary rule is displayed in region 1210 that indicates “WINDOWS™ managed OFF” implying devices that are controlled by WINDOWS™ software are turned off. As can be seen from region 1210, conditions associated with this rule apply to all WINDOWS™ PCs that have a screen saver program as well as additional programs that are shown in FIG. 12B. In other words, by clicking on “Screen-Saver Is On, Check Apps” icon opens up a dialog box as displayed in FIG. 12B (described below). Further, actions associated with this rule follow a time-based pattern, the details of which are explained in connection with FIG. 12C. For the exemplary rule displayed in region 1210, the number of devices that are managed by this rule are indicated as “255”, total savings in cost is “$695.30”, and total saved energy is 10.5 kWh.

As will be understood and appreciated, embodiments of the EMS may utilize virtually unlimited numbers of rules to control assets managed by the EMS, and those shown in connection with FIG. 12A are provided merely for illustrative purposes. In an exemplary alternate embodiment of the EMS, aspects of the present disclosure relate to remote management of power consumed by assets located at various geographically distributed facilities on the basis of an instantaneous location of a user's mobile device that is associated with one or more assets housed in a facility. An exemplary policy table comprising rules that involve remote management of assets on the basis of an instantaneous location of a user's mobile device, is shown in FIG. 28.

Now referring to FIG. 12B, a screen shot 1200B of an interface is shown, illustrating conditions for creating energy management policies. In the exemplary interface 1200B, a policy based on various software programs on PCs is illustrated. As shown, region 1217 (comprising regions 1218, 1220 and 1222) in screen shot 1200B displays several software programs that comprise conditions associated with a rule. In one embodiment, these software programs are defined by an EMS administrator through the interface shown. For example, as can be seen from region 1218 in screen shot 1200B, a condition indicates that the EMS determines the status of a screen saver program only when screen saver program is running. This condition is chosen by an EMS administrator by clicking on a toggle check box. Alternatively, un-clicking on the toggle check box in region 1218 results in the EMS determining the status of a screen saver program when screen saver program is not running.

Region 1220 in screen shot 1200B indicates software programs that are to be running on PCs to initiate an action associated with a rule. Exemplary software programs include “IDLE.EXE”, and several other such programs that can be specified by an EMS administrator through the interface. As can be understood by a person skilled in the art, “IDLE.EXE” is a program that is run by a WINDOWS™ Operating System when a PC is idle. Hence, it will be understood that for the exemplary rule displayed in region 1210 of screen shot 1200A, one of the conditions required for an action (powering off) to be executed is that software programs as indicated in region 1220 are to be running on PCs. Further, region 1222 in screen shot 1200B indicates software programs that are not running on PCs for executing an action. For example, it can be seen that “Word.exe”, “Powerpoint.exe”, and “Excel.exe” are not to be running on PCs for an action (powering off) to be executed. As will be understood, the information, conditions, software programs, and other parameters indicated in FIG. 12B are for illustrative purposes only. Embodiments of the present disclosure can include various other types of information and different display interfaces, as will occur to those skilled in the art.

Still referring to FIG. 12B, a “Submit” button 1224 submits conditions (for defining various rules), for example, as indicated in screen shot 1200B, to the EMS. As will be understood, these conditions are saved in the EMS database 112 to be executed with respect to assets. A “Cancel” button 1226 cancels conditions as specified in screen shot 1200B, and as a result, the rule would not be created or saved.

Now referring to FIG. 12C, an exemplary interface is shown for specifying time-based conditions associated with energy management policies. As will be understood, this exemplary interface is used to specify an action involving a change in power state (for example, turning on, turning off, hibernate mode, standby mode), days of the week (for example, Monday, Tuesday, etc.), and time(s) of the day when a change in power state is executed over a twenty-four time period for various devices covered by this rule. A menu selection button 1228 indicates that conditions follow a time-based pattern (for example, as displayed in region 1234) for executing actions corresponding to energy management policies. As can be seen from region 1234, assets are turned on at 7 am on weekdays, put in hibernate mode between 12 noon and 1 pm, turned back on at 1 pm, and turned off at 7 pm. Region 1232 indicates a legend that explains the meaning of various icons used in the time-based pattern shown in region 1234. So, for example, there is one icon for turning on, another icon for turning off, a third icon for hibernate mode, and a fourth icon for standby mode. As will be understood, devices can be in different time zones, and even an EMS administrator can be in a different time zone. Hence, a toggle check box 1240 is used to select an option that indicates that a time-based pattern in region 1234 follows same time zone as devices being managed by the EMS. A “Submit” button 1236 is used to submit a time-based, for example as indicated in region 1234, to the EMS. A “Cancel” button 1238 is used to cancel selection of time-based condition, for example as specified in screen shot 1200C.

Referring now to FIG. 13, an exemplary EMS interface for management of power consumed by individual devices is shown in screen shot 1300. As described previously, an embodiment of the device monitoring engine 210 monitors power consumed by various devices and saves it in the EMS database. Reporting engine 214 then retrieves values of power consumed by various devices along with additional device attributes from the EMS database and displays this information through an interface as displayed in screen shot 1300. As can be seen, a “Select Devices” navigation pane is used to select device related information, based on various attributes. Accordingly, power consumed by various devices is displayed (in region 1332), along with various associated attributes for such devices in region 1306. Referring to “Select Devices” navigation pane, all devices are selected by clicking on “All Device” button 1304, or devices are selected based on system types by clicking on “System Types” button 1318. Exemplary system types (work station, network printer, etc.) and other device attributes are illustrated in FIG. 9 and FIG. 27.

In screen shot 1300, devices are selected by manufacturer by clicking on “Manufacturer” button 1320, or by location by clicking on “Location” button 1322. Further, in screen shot 1300, devices are selected by business unit by clicking on “Business Unit” button 1324, or by type of device by clicking on “Device Type” button 1326. As will be understood, clicking on buttons (for example “Location” button 1322, or “Business Unit” button 1326) in the navigation pane causes the information to be displayed as a list in region 1306. Devices are selected by power state (e.g., on/off/hibernate etc.) by clicking on button “Status” button 1328. As can be understood by a person skilled in the art, devices can also be selected based on the energy management rules with which they are associated. Exemplary energy management rules are described in FIG. 10, FIGS. 12A-12C and FIG. 28. “Rule” button 1320 in screen shot 1300 is used to select devices that are associated with or covered by a given rule.

Further, as can be seen, a search box 1301 along with a “Search” button 1302 provides functionalities to search for devices based on several attributes like device ID, host name, and various other attributes, in order to add such devices to a list. According to one embodiment of the present disclosure, a query language can be used to query devices. Examples of query languages include Sql, MySql, and many others. In region 1306, clicking on “Add Device” button 1308 adds a device to a list of devices displayed in region 1306. Clicking on “View/Edit” button 1310 allows an EMS administrator to view or edit additional device related information. Further, a delete button 1312 removes a device from management by the EMS. In a situation in which a large number of devices are managed by an EMS, a forward and backward scroll button 1342 is provided in screen shot 1300 to scroll through multiple reports displayed in multiple screens of an interface. Further, it can be seen that a scroll bar 1344 is provided to allow an EMS administrator who is reviewing reports to vertically scroll up and down a screen.

FIG. 14 illustrates an exemplary EMS interface 1400 showing summary reports of power consumption, energy savings, and various system statistics in real and non-real time. As shown, a left navigation pane (region 1404) allows an EMS administrator to review such summary reports daily (by clicking on “Today” button 1406), weekly (by clicking on “Week” button 1408), or monthly (by clicking on “Month” button 1406) for analysis. As can be seen, button 1406 is highlighted indicating that a current screen is displaying daily summary reports. Exemplary daily summary reports are shown in regions 1420, 1422, 1424, and 1426. Region 1420 displays a daily summary report showing average saved energy cost as a function of time of the day. For example, it can be seen that average saved energy cost (e.g., per device) is zero until about 18:00 hrs (military time) and then increases to $0.04, afterwards. Total energy consumption by all devices (as a function of time) is reported in real time as displayed in region 1422. For example, it can be seen that total energy consumption is 250 kWh between 9 am and 11 am. Savings in energy cost and total energy consumption for assets located in various geographical locations are illustrated in regions 1424 and 1426 with horizontal bar plots. As will be understood by a person skilled in the art, statistics related to costs and power consumption can be displayed in various other ways.

Furthermore, it can be seen from region 1404 that an EMS administrator can obtain detailed reports by clicking on “Detailed Reports” button 1412. Various combinations of energy consumption, costs, savings, device types, carbon emissions, device models, and other such attributes can be used to obtain detailed reports. According to one embodiment of the present disclosure, the EMS analyzes device and power-related data and provides recommendations for obtaining additional savings. Results of such analysis and recommendations are obtained by clicking on “Energy Savings” button 1414. An EMS administrator can choose a pre-determined set of custom reports (both summary as well as detailed reports) that he or she wishes to review. Generally, such reports are automatically saved by the EMS in an EMS Database. A list of such reports are displayed when “Favorite Reports” button 1416 is clicked. Although not shown here, it will be understood that EMS also allows custom reports to be exported to a folder in an EMS administrator's computer. Region 1418 displays a current energy pricing rate used in calculating costs and savings, in connection with displaying various reports. As can be see, a default energy pricing rate assumed by EMS is $0.1 which can be edited by an EMS administrator by clicking on an “Edit” button 1500C. Further details of the interface for editing or setting energy pricing rates are illustrated in FIG. 15C.

Now referring to FIG. 15A, an exemplary interface 1500A for importing device information from a facility (and an asset management system) into an embodiment of the EMS is shown. As described previously, according to one embodiment, information regarding various devices is retrieved via an implementation engine within the EMS management module, as described earlier in FIGS. 4 and 5. In FIG. 15A, a left navigation “Settings” pane 1502 provides configuration settings for various features of the EMS. Examples of such configuration settings include functionalities to import devices (i.e., retrieve device information and store it in an EMS database) into the EMS, exporting device data from EMS to an EMS administrator's local computer, and providing custom data fields in the EMS. Generally, custom data fields are additional data fields that an EMS administrator chooses to extract from various devices during monitoring of such devices. Additionally, settings to provide a list of protected devices that are not subjected to energy management rules may be provided by an EMS administrator by clicking on “Protected Devices” button 1500B (described in greater detail in FIG. 15B). Configuration settings pane 1502 also include options to specify device locations explicitly, or in cases when device locations are not obtained from asset management systems. Further configuration settings include options to provide energy pricing rates (by clicking on button 1500C) for various markets, utilities or geographical locations. An exemplary screen shot showing energy pricing rates is shown in FIG. 15C.

Configuration settings pane 1502 also provides functionalities for indicating time zones in which devices are located. Options for setting software updates are also provided in configuration settings pane 1502. In one embodiment, the EMS also provides a crowd-sourcing capability to anonymously share device and power-related information for facilities amongst various organizations and entities. Internet connections and proxy server settings to enable crowd-sourcing functionality are also provided in configuration settings pane 1502. As recited previously, embodiments of the EMS are typically installed at a computer server in a facility. According to one embodiment of the present disclosure, an EMS administrator remotely manages the EMS through a web interface. Internet settings are provided (“Systems/Networking” button 1500D, described in FIG. 15D) in configuration settings pane 1502 to set up remote management of the EMS. Additionally, one or more EMS administrators may be involved in managing the EMS. Settings for providing email addresses of such administrators and time intervals when email notifications are sent by an EMS is configured through configuration settings pane 1502.

As can be seen in screen shot 1500A, settings for importing devices are shown highlighted in the current screen shot. As recited previously, asset connectors generally comprise a suite of software tools that are used to discover and import asset information into the EMS, with the help of asset management systems. Examples of functions of asset connectors include import of all WINDOWS™ computers from an asset management system such as Active Directory, etc. Asset connectors are added by clicking on “Add Asset Connector” button 1506 in the EMS interface 1500A.

As will be understood by a person of ordinary skill in the art, multiple asset connectors are pre-stored in an EMS for discovering, communicating with, and importing information relating to various types of assets. Further, information pertaining to an asset can involve multiple asset connectors. A “Refresh All Devices” button 1508 synchronizes and updates information from various devices in the EMS. As recited previously (with reference to discussion on energy management rules, in FIG. 7), asset connectors can be enabled or disabled. Region 1510 in screen shot 1500A displays an exemplary list of asset connectors. Region 1512 indicates whether an asset connector in this list is enabled (on) or disabled (off). Region 1514 displays names of asset connectors (for example, VoIP phones, WINDOWS™ PC, or even Networking Management for managing assets like switches and routers), region 1516 displays types of assets for which an asset connector is associated.

Still referring to FIG. 15A, a “Status” field 1518 indicates the number of assets controlled by an asset connector. Further, settings button 1521 is used to provide additional settings with a respective asset connector. Generally, different asset connector settings are configured differently, as they communicate with different asset management systems. For example, a WINDOWS™ PC based asset connector integrates with a WINDOWS™ based asset management system like Active Directory. Configuring a WINDOWS™ based asset connector generally requires a domain name, a host name of a network where Active Directory is located, along with username and password of individuals who are allowed to access Active Directory. In another example, an asset connector for VoIP phones integrates with a CISCOWORKS™ asset management system at one or more facilities. Configuring such asset connectors generally requires a CISCOWORKS™ URL, along with a username and password of individuals who are allowed to access CISCOWORKS™ asset management system.

After devices are imported using asset connectors (i.e., after device information is retrieved), an EMS administrator clicks on “Save Changes” button 1520 in order to store associations (in an EMS database) between asset connectors and individual assets, as shown for example in region 1510. Alternatively, an EMS administrator can cancel changes done (in this screen) in relation to importing assets, by clicking on “Revert All Changes” button 1522. Detailed flowcharts showing steps of importing assets by an implementation engine are described in FIGS. 4 and 5.

In many scenarios, an important asset needs to be powered on at all times. Such a situation arises, for example, in facilities like hospitals where surgeries are performed, or in scientific or defense laboratories where critical experiments are being conducted, or even for some servers, HVAC equipment, or other devices in a facility that should always remain operational. For these types of devices, it is crucial to monitor and maintain an uninterrupted power supply for these critical devices, and ensure they are not accidentally powered off or hibernated. Thus, these devices generally should be excluded from otherwise applicable energy policies, and not be exposed to a change in power state. FIG. 15B shown an exemplary screenshot 1500B of an interface that is used to specify such assets. As can be seen, region 1524 shows various ways of specifying devices that are “protected” from energy management rules. Ways of specifying such devices include IP address associated with a device, or, by type of device (for example, LINUX™ PCs), or devices can be specified based on their location. Further, if multiple devices are to be protected, then a range of IP addresses associated with such devices are specified.

FIG. 15C shows an exemplary screen shot 1500C of EMS configurations for setting an energy pricing rate for purposes of generating various metrics and statistics used in energy management reports. As will be understood, an EMS administrator provides inputs for various quantities as displayed in screen shot 1500B. A “Currency” box 1528 is used to enter a currency (for example, dollar, euro, etc.) for a pricing rate. “Add location” button 1530 is clicked to add a geographical location (for example, London, Melbourne, Tokyo etc.). A pricing rate (measured in price per kWh) used at a location, along with equivalent greenhouse gas emission (measured in kg per kWh) as a result of energy consumed, are also entered. After a location, a pricing rate and greenhouse footprint is added, they are displayed in regions 1536 (“Locations”), 1538 (“Price Per kWh”), and 1540 (“CO2 Emission [Kg/kWh]”). Locations are edited by clicking on “Edit” button 1532, and deleted by clicking on “Delete” button 1534. After EMS administrator provides a location, energy pricing rate and greenhouse emission value, “Save Changes” button 1542 is clicked, and thereafter they are saved in an EMS database. However, an EMS administrator cancels saving them by clicking on “Revert All Changes” button 1544.

As will be understood, pricing information for energy rates may be provided in a default setting without any customization by an EMS user. However, the functionality illustrated in screen 1500C enables an EMS user to customize its energy pricing information and displays according to the user's preferences. For example, a standard energy cost may be provided to the EMS by a local utility company as the default cost. However, an EMS user that has negotiated a cheaper energy rate with the utility company can customize the energy cost settings according to this new rate to provide accurate energy savings analytics.

Referring now to FIG. 15D, an exemplary screen shot 1500D is shown with various system settings relating to storage of information, notifications and errors, networking settings, and the like. As can be seen, clicking on button 1548 displays a drop down menu which contains various options for creating log files. Examples of such options include a “DEBUG” option in case of errors and simplifies troubleshooting, a “WARNING” option displaying log warnings, errors and fatal errors, as well as a “NONE” options for not logging any entries. As will be understood, log files that are created from recording various events and errors, are stored in the EMS database.

Region 1550 in screen shot 1500D shows various buttons to configure different settings of the EMS. As will be understood, generally speaking, embodiments of the EMS perform network based management of electrical and electronic devices (assets) for purposes of providing energy efficiency. In order to perform such management, EMS (specifically, asset connectors and/or device proxies) continually poll devices at periodic intervals of time to determine their power state (on/off/hibernate etc.). Button 1552 is provided to determine the periodic interval of time at which power state of devices are polled. In exemplary screen shot, it can be seen that this interval is set at “5 minutes”. Further, button 1554 provides settings to adjust periodic time intervals at which power consumed by a device is measured. This is shown as “30 minutes” in screen shot 1500D. As previously recited, asset connectors communicate with existing asset management systems at the facilities to import new assets into EMS, and also determine whether existing assets are connected or not. As a result, button 1556 is provided to set time intervals at which assets are refreshed. In exemplary screen shot 1500D, time intervals at which assets are refreshed is set at “30 minutes”.

Region 1558 provides various toggle check boxes in order to select specific network settings. As described previously, assets (devices) are typically connected to an IT infrastructure at a facility. Thus, the EMS accesses various devices using their hostnames and IP addresses. In many scenarios, devices like laptops switch from a Local Area Network (LAN) to a Wireless Local Area Network (WLAN), for example when individuals move their laptops from their office desks to conference rooms. As will be understood by those skilled in the art, IP address of devices that are moved changes. Consequently, a “DNS Resolve” option is provided in one embodiment of the EMS that resolves a hostname of a device to a current IP address every time a device is accessed.

As will be understood by a person skilled in the art, the Ethernet is a computer networking standard for communication between two computers. According to this standard, communication between two computers involves the exchange of information packets that essentially are a sequence of data bits in the form of zeros and ones. In one particular embodiment, when managing PCs located in a facility, the EMS uses a special kind of Ethernet network packet for turning on PCs over a computer network (i.e., for controlling the PCs remotely via the EMS). This special network packet is broadcast to a PC's Medium Access Control (MAC) address. A network interface card connected to a PC continually (even when a PC is turned off) probes for incoming packets. In region 1558 in FIG. 15D, a toggle check box option is provided that allows an EMS administrator to choose whether or not to change the power state of a PC by sending such a special network packet. Configuration settings provided by an EMS administrator are saved in an EMS database by clicking on “Save” button 1559 provided in the interface. As will be understood, system configuration settings presented in FIG. 15 are intended for illustrative purposes only, and other system configurations are possible according to various embodiments of the present systems.

In one exemplary alternate embodiment of the disclosed EMS, aspects of the present disclosure relate to remote management of power consumed by assets located at various geographically distributed facilities, on the basis of an instantaneous location of a user's mobile device that is associated with one or more assets housed in a facility. Such an exemplary embodiment and related aspects will be discussed next in greater detail in connection with FIG. 16-FIG. 32.

### Alternative Exemplary Embodiment

### Control of Assets Remotely Based on Mobile Device Location

As recited previously in this disclosure, embodiments of an EMS 110 that are installed within an organization's infrastructure include functionality to manage, monitor, and control pre-existing assets (devices) connected to an organization's infrastructure, wherein the devices can be from different vendors, makes, and models, and are housed at one or more facilities that are distributed at different geographical locations. An additional system embodiment (described in greater detail below) enables a user to remotely manage energy usage of such devices via a mobile device, wherein remote energy management of electronic devices is performed according to a physical location of a user's mobile device. Examples of mobile devices include mobile phones, PDAs, tablet computing devices, building entry cards, etc.

One aspect of the present system includes technology configured to leverage the current geographic location of a user based on a mobile device in proximity to the user (e.g., mobile phone, PDA, laptop computer, etc.) to determine if the user's workplace computer (and/or other electronic devices) should be powered off, powered on, or otherwise have its energy state changed. For example, if the user leaves a certain area or geographical region (e.g., 1 mile around the user's computer) the user's computer could automatically power off. Also, if the user enters the area or geographical region, the computer could automatically power on. As will be understood and appreciated by those of ordinary skill in the art, aspects of the present system may be implemented in non-workplace settings, such as a user's home, second residence, etc. For example, appliances and other electronics at a user's vacation home could recognize when a user is within a certain distance from the home, and could “power on” at that time. Or, the lighting and HVAC equipment at a user's workplace could power on when the user approaches work, and power off when the user leaves work (again, based on the physical location of the user's mobile device).

The power management features of the present system are generally controlled by predefined policy rules (stored inside a database and/or in a mobile device) and/or on-demand, dynamic power management commands based on the instantaneous location of mobile device as will be described in greater detail below. According to one aspect, such dynamic power management commands are transmitted by the user's mobile device to an energy management system (EMS) that controls and monitors power consumed by devices in a facility. According to another aspect, location information corresponding to the mobile device's location is transmitted to an EMS, and the EMS then processes that information to identify whether certain pre-stored commands should be implemented. Although the discussions herein primarily refer to an EMS 110, it will be noted that in alternate embodiments, an energy management system that provides functionality to manage, monitor, and control pre-existing assets (devices) connected to an organization's infrastructure, will operate in accordance with aspects of the present disclosure, as will occur to those of ordinary skill in the art. Consequently, no limitation is imposed on the choice of an energy management system.

Referring now to the figures, FIG. 16 illustrates an overview 1600 of an embodiment of an energy management system (EMS) 110 having mobile device functionality in an exemplary environment, constructed and operated in accordance with various aspects of the present disclosure. It will be recalled that details of the workings of the EMS 110 (and related components present in an exemplary environment) were described earlier in connection with FIG. 1, and several other figures. Thus, it is believed that such details are not necessary to be repeated in what follows herein.

According to one exemplary embodiment, an organization has multiple facilities 102A and 102B at different geographical locations. An EMS 110 is installed on a physical server or a general purpose computer in a facility that is connected with facilities 102A and 102B. As will be understood from the previous discussion, the EMS monitors, manages and controls power consumed by assets or devices 104 that are housed at the facilities. As will be recalled from the earlier discussion in connection with FIG. 9, devices 104 located in a facility are identified by unique IDs, exemplarily called as device IDs. As shown in FIG. 16, a desktop PC is exemplarily identified as ID:PC1, a laptop PC as ID:PC2, a lighting device as ID:PC3, and so on. Typically, and as shown in FIG. 16 (although not always), the devices 104 are stationary devices that remain at a given facility. As will be understood, various numbers and types of electrical and electronic devices can be housed in a facility, and there is no limitation imposed on the number of devices, device types, brands, vendors and manufacturers that may be included within an organization or the organization's facilities. Further, no limitation is imposed on the number of facilities that can be controlled by the EMS, or the locations of such facilities.

As shown in FIG. 16, these facilities and the EMS 110 are interconnected via network(s) 108 that is also connected with the IT infrastructure 106. Although not shown in FIG. 1 and FIG. 16, it can be understood that IT infrastructure 106 at facilities 102 may include one or more gateways/firewalls that provide information security (from unwarranted intrusions and cyber attacks) to facilities and also ensures operating compatibility between an IT infrastructure 106 and networks 108. Generally, in those embodiments in which a firewall is used, the EMS operates behind the firewall of the organization.

As recited previously, one aspect of the present system includes technology configured to leverage the current geographic location of a user based on a physical location of a user's mobile device that will remotely manage one or more devices located in a facility that are managed by the EMS 110. With reference to FIG. 16, a user 1605 traveling in a vehicle uses a mobile device 1601 to remotely manage one or more devices 104 such as those housed in facilities 102A and 102B, based on the instantaneous location of the mobile device 1601. For the purpose of the discussions in this disclosure, a reference to a user's location will be considered synonymous to the location of the user's mobile device (as it will be assumed that a user is almost always in close proximity to his mobile device). An exemplary sequence of interactions involving devices 104, a mobile device 1601, an embodiment of the EMS 110, and a EMS administrator 116 will be explained with the help of a sequence diagram in FIG. 19.

According to one embodiment, remotely managing devices involves providing the user's instantaneous or real-time physical location (or information relating to the user's instantaneous physical location) to the EMS. Such information is then used by the EMS to apply power management commands to various devices 104 that are associated with the user's mobile device 1601. In another embodiment, a user's mobile device 1601 directly provides on-demand, power management commands (based on the instantaneous location of a user's mobile device) to the EMS, wherein such commands are typically pre-configured into the users' mobile devices 1601 by users according to their preferences. As will be understood, the power management commands will be then applied by the EMS on the various devices 104 that are associated with the user's mobile device 1601. Detailed steps followed by the EMS to execute power management commands (directly received on-demand from a user's mobile device, or pre-stored in the EMS) will be discussed as exemplary embodiments in connection with FIG. 21 (including FIG. 21A, FIG. 21B, and FIG. 21C).

One example of a power management command is a POWERON command, which powers on (or turns on) the associated electronic devices 104. Another command can be POWEROFF to power off (or turn off) the electronic devices 104. Other commands include those that are used to set the electronic devices to various power states, such as SETPOWERSTATE LOW (sets the power state(s) of the electronic devices to a low, but not off, power setting), SETPOWERSTATE MEDIUM (sets the power state(s) of the electronic devices to an intermediate setting), SETPOWERSTATE HIGH (sets the power state(s) of the electronic devices to a high setting), HIBERNATE (sets the power state(s) to a hibernate mode), and other various commands as will occur to one of ordinary skill in the art. Further, other commands can be used to retrieve information about the current power state of an electronic device (e.g., GETPOWERSTATE, which retrieves power state information from assets).

Yet another set of commands might retrieve various statistical or historical information from the given electronic device 104, for example, times at which the electronic devices 104 was powered on or powered off. Further still, users can configure very specific power management commands, such as setting a certain command to set a given device at a certain set of operating parameters. For example, a command could be used to set a HVAC unit to a predetermined temperature. As will be understood and appreciated, virtually any command relating to power management, including actual powering on or off of a device, setting intermediate power states, obtaining power information, and other similar commands are possible according to various embodiments of the present system. Thus, generally speaking, remote management of devices including provision of various power management commands to such devices involves communicating the instantaneous physical location of a user's mobile device, or information relating to the physical location of a user's mobile device.

It will be understood by one of ordinary skill that a physical location of a user's mobile device can be obtained via a location sensor on the device (such as an on-board GPS receiver), or can be provided from a third-party location-based service provider (such as LOCAID™, of San Francisco, Calif., for example). According to one aspect of the present disclosure, the location sensor is integrated into a user's mobile device. In other words, it will be understood that information corresponding to an instantaneous location of a user's mobile device is transmitted by a mobile device application program running on the user's mobile device, wherein the instantaneous location is obtained with the help of a location sensor embedded in the mobile device that communicates with the mobile device application program running on the user's mobile device. Alternately, a mobile device application program running on the user's mobile device communicates with a third-party location-based service provider which then provides the instantaneous physical location of a user's mobile device to the EMS.

According to another aspect, the location sensor can use software to determine its current location by using network information, such as Internet addresses or WIFI network addresses. According to yet another aspect, the real-time location of the user's mobile device can be retrieved by using mobile cell tower information, cell tower triangulation information, or mobile network information. In still another aspect, RFID and near-field sensors can be used to determine the instantaneous location of the mobile device (for example, use of an employee swipe card or access card used for entrance to a building or secure area within a building). As will be understood and appreciated by one of ordinary skill in the art, various mechanisms can be utilized to identify the instantaneous geographic location of a user's mobile device according to various aspects of the present system, and embodiments of the present system are not limited to the specific mechanisms described herein.

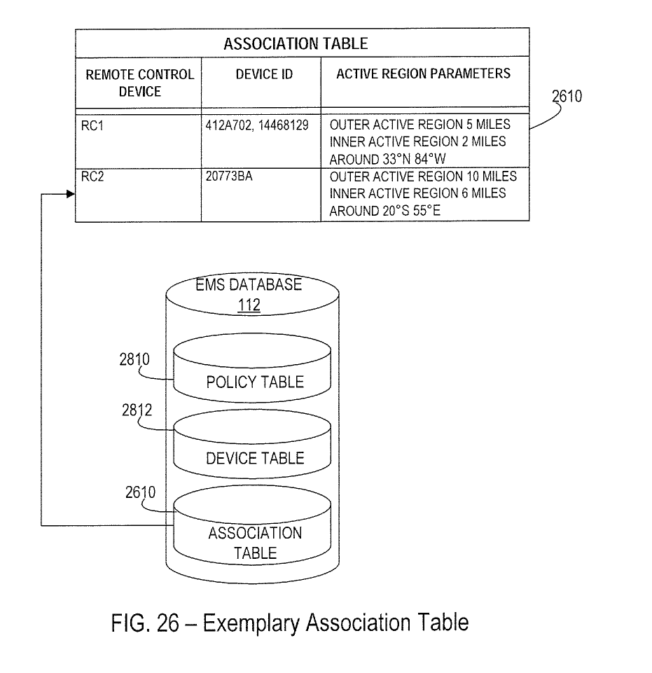

It will be understood and appreciated that remote management of devices 104 housed in a facility involves creating an association between a user's mobile device 1601 and such devices that will be remotely controlled/managed by the user's mobile device. Such an association is typically a one-time “handshake” process that is needed to create a unique mapping between the user's mobile device and such devices that will be remotely controlled/managed by the user's mobile device. Subsequent changes to the association can be performed over-the-air automatically, or by manual changes performed by persons. In FIG. 16, a logical association table 1607 is shown between a user's mobile device 1601 and such devices. (An exemplary association table is discussed in greater detail in connection with FIG. 26.) As seen from FIG. 16, logical association 1607 comprises information identifying a user's mobile device (for example, ID:RC1, wherein “RC1” represents the user's mobile (or “remote control”) device), a user's assets/devices, and a network address of the EMS (for example, EMS 10) on the Internet. Although not shown in FIG. 16, it will be understood that various other information relating to various electronic devices, and/or information relating to location of a mobile device can be indicated through a logical association. Examples of information relating to various electronic devices include (but are not limited to) identifiers such as a network name, a network address (e.g., URL, IP address, MAC address, I2C bus address) or any similar identifier which can be used to identify and access devices via a network.

According to one aspect of the present system, information relating to a location of a user's mobile device is specified in the form of “active regions” (as defined previously herein). In other words, active regions correspond to (typically predefined) geographical areas that, when a user's mobile device is located therein, triggers location-based power management of the user's assets. Such geographical areas comprise various spatial geometries, for example, circular active region, annular active regions with an inner and an outer radius, city blocks, office building floors, zones within a facility, etc. (Exemplary active regions illustrative of various spatial geometries are shown in FIG. 18A, FIG. 18B, FIG. 18C, and FIG. 18D.) According to another aspect of the present system, logical association information comprises information relating to one or more active regions of users' mobile devices.

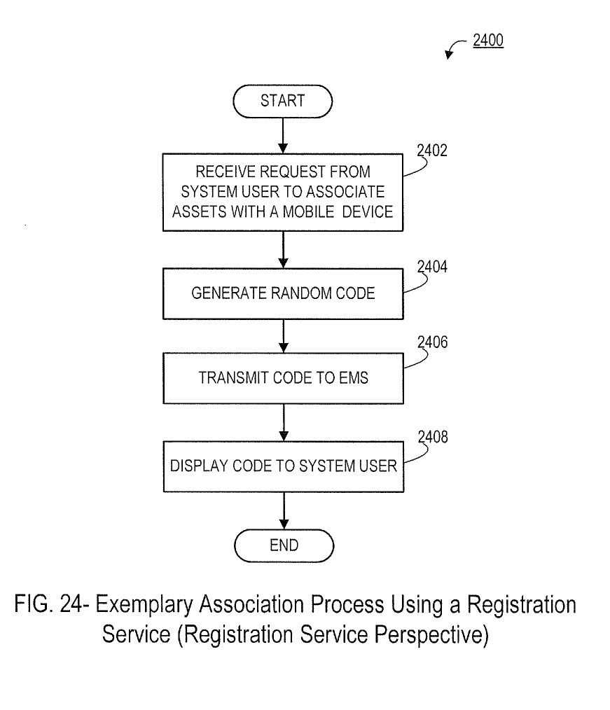

It will be understood that after a logical association is created for the first time, association information (as exemplarily described above) is generally stored in a database within the user's device and/or an EMS database 112. In one aspect, an association is created after information is entered manually by a user or a human EMS administrator through an interface, or some other person with knowledge and authorization relating to various electronic devices at an organization. In another aspect, an association is created via a registration service that is either housed within the EMS 110, or a registration service is a third-party entity located somewhere else. Further details of an association process will be discussed in connection with FIG. 24 and FIG. 25. In yet another aspect, an association is created directly through a software program (for example, a mobile application program) running on the user's mobile device, and the EMS 110. Association information is used in performing remote power management of devices 104 housed in a facility with the help of location information relating to a user's mobile device 1601. In one aspect, remote power management is performed using various exemplary power management commands as described previously. Detailed steps followed by a mobile device to perform location-based power management will be discussed in connection with FIG. 22 and FIG. 23. Additionally, steps followed by an EMS 110 in processing information relating to a location of a mobile device will be explained in connection with FIG. 20. As recited previously, association information is generally stored in a database within the user's mobile device and/or a EMS database 112.

It will be recalled from the earlier discussions that embodiments of the EMS 110 first integrate assets 104 into the EMS 110, and further also collect various power-related information from assets 104 on a continuous and/or periodic basis. Examples of information include collected from assets include the hardware configurations of assets, additional devices connected to assets like printers, monitors, scanners, audio speakers, current load/utilization information of respective asset, operational temperatures of assets, etc. As will be understood, this information is typically used by the EMS 110 to execute various pre-determined energy management rules/policies based on satisfaction of certain conditions or criteria that govern how and when assets 104 are to be controlled (e.g., turned off/on) in order to achieve energy efficiency. Generally, these policies are created by a system user within the EMS 110 during initialization, or during normal operation, and stored in the EMS database 112 for subsequent use.

It will be understood that in alternate embodiments of the present system, power management commands (as described above) can also be integrated into pre-determined energy management rules/policies. As will be understood, in such scenarios, the energy management rules/policies include association information comprising information relating to the user's mobile device 1601 and the devices 104 that are managed by the user's mobile device 1601. Exemplary policy tables involving a mobile device are shown in FIG. 28. Generally, an EMS administrator specifies such policies (or, generally speaking, rules) and reviews energy efficiency management reports provided by EMS 110. In an aspect of the present system, the EMS 110 is configured to apply priority considerations to policies involving users' mobile devices, as will be shown with the help of a flowchart in FIG. 20.

In an alternate embodiment, power management commands can be provided by a user's mobile device in the form of an on-demand, dynamic instruction to the EMS 110 corresponding to whether or not an instantaneous location of a user's mobile device is within a pre-specified active region. Such an active region is usually specified by users and stored in a user's mobile device. In various embodiments, however, the active region may be predefined by an EMS administrator or other user, and stored in the EMS database. Detailed steps followed by the EMS to execute power management commands based on an active region will be discussed in connection with FIG. 21C. As will be understood, the instantaneous location of a user's mobile device is continuously monitored by a location sensor embedded on the user's mobile device, or by a location service provider. Detailed steps followed by a mobile device to continuously monitor a user's location and thereby perform location-based power management will be discussed in connection with FIG. 22.

In FIG. 23, an exemplary mobile device table is illustrated showing exemplary data and information stored on a mobile device 1601. Steps of an exemplary association process are shown in FIG. 24. Also, steps of an association process performed by a mobile device are shown in FIG. 25. An association table showing exemplary association information for devices (housed in a facility) and their associated mobile devices is shown in FIG. 26. In FIG. 27, an exemplary device table showing several attributes related to devices housed in a facility, is shown. An exemplary policy table comprising policies involving mobile devices is shown in FIG. 28.

It will be understood and further explained below that in an exemplary embodiment, one method of creating associations between users' mobile devices and respective assets involves the use of a registration service. Such a registration service can be a stand-alone third party provider, or can be integrated with a EMS, wherein the registration service acts as an intermediary system for creating associations. An exemplary screenshot of an user-interface of a registration service is shown in FIG. 29. Exemplary screenshots displaying several user-interfaces of a mobile device in connection with aspects of performing location-based management are shown in FIG. 30-FIG. 32.

The materials discussed above in association with FIG. 1 merely provide an overview of an embodiment of the present system for energy efficiency management, and are not intended to limit in any way the scope of the present disclosure. Accordingly, further embodiments of the systems and methods and more detailed discussions thereof is provided below and in the accompanying figures.

Generally speaking, one form of the present disclosure describes a system for remotely managing and monitoring the energy consumed by network-connected devices and systems 104, via a user's mobile device 1601, wherein the energy management is based on a physical location (typically real-time or virtually real-time) of the user's mobile device 1601.

Turning to FIG. 17, an exemplary architecture (including different network-connected devices) is shown for an alternate embodiment of the EMS 110 that is used for remote management and monitoring of the energy consumed by network-connected devices and systems housed in a facility, via a user's mobile device 1601. Such assets (devices) and systems 104 include (but are not limited to) laptop computers, desktop computers, servers, mainframe computers, Voice-Over-Internet-Protocol (VoIP) phones, routers, switches, printers, copiers, scanners, lighting equipment (bulbs, lamps, fluorescent tubes, etc.), HVAC equipment, fans, generators, motors, electrical machines, etc. From the embodiment of the EMS 110 discussed in connection with FIG. 2, it will be recalled that the EMS 110 architecture comprises several software engines and modules for managing power consumed by different devices in a facility. Such software engines and modules typically comprise an EMS (exemplarily EMS 110) that monitors, analyzes, and controls individual assets at a single facility or at multiple facilities, wherein the facilities can be located at different geographical locations. It is shown in FIG. 17 that individual assets 104 (devices that will be first associated and then controlled by user's mobile devices) are connected to asset management systems 202 that are further connected to an IT infrastructure 106 at facility 102. Details of asset management systems were discussed previously in reference to FIG. 2, and several other figures. It can also be seen from FIG. 17 that an EMS architecture comprises asset connectors and device proxies which communicate with individual assets.

As will be understood, users 1605 communicate with the EMS via a network 108 to remotely monitor and manage various assets 104 housed in a facility. According to one aspect, this communication proceeds via one or more intermediate servers that create the network connection. For example, a user's mobile device 1601 communicates with a server that belongs to a mobile phone operator (or any kind of data network provider), or even a third party server in the cloud. Such a server facilitates a network connection between a mobile device and a server on which the EMS 110 is installed, and which can be on a corporate network (corporate LAN, for example) of an organization. Although not shown in FIG. 17, it will be understood that network communication can further include various network components such as routers, hubs, switches, etc.

According to one embodiment of the present disclosure, and as will be recalled, device proxies are used to connect to individual assets. As described above, a device proxy generally comprises a communication algorithm that is specific to a particular device type to enable communications with a given device 104. According to another embodiment of the present disclosure, both asset connectors and device proxies are used to connect to individual assets. In embodiments in which both device proxies and asset connectors are used, asset management systems connected to such assets provide power profile information of respective assets 104. As mentioned above, examples of power profile information include (but are not limited to) real-time power consumption of a device, duration of time for which a device has been operational, etc.

In addition to device proxies and asset connectors, it is shown in FIG. 17 that the EMS architecture comprises several software engines and modules that were also utilized in the embodiment described in connection with FIG. 2. For the sake of brevity, details of such software engines and modules that were described previously in detail will not be repeated herein in connection with FIG. 17. As shown in FIG. 17, the EMS 110 (for example, an EMS engine 216) further comprises an association engine 209 and a mobile device engine 213, in addition to various software engines and modules (such as implementation engine 208, device monitoring engine 210, policy engine 212, reporting engine 214) that were previously shown and discussed in connection with FIG. 2. It will however be understood that the policy engine 212 will be modified to accommodate policies involving location-based energy management of assets associated with users' mobile devices. According to one aspect, policies can be implemented in a “static” framework wherein such rules/policies are pre-stored in the EMS and involve receiving communications about an instantaneous location of users' mobile devices 1601. Thus, for instance, in an exemplary scenario, policies that involve receiving communications about an instantaneous location of users' mobile devices 1601 are given priority considerations over the other rules/policies.

According to another aspect, a mobile device engine 213 processes dynamic, on-demand power management commands relating to an instantaneous location of users' mobile devices. Detailed steps of exemplary processes performed by a mobile device engine 213 will be explained in connection with FIG. 20 and FIG. 21 (consisting of FIG. 21A, FIG. 21B, and FIG. 21C).

It will be understood that aspects of the present disclosure involve creating a unique association between a user's mobile device 1601 and devices 104 that will be remotely controlled/managed by the user's mobile device 1601. In one embodiment of the present system, an association engine 209 creates such an association, and which will be described in connection with FIG. 20. Additional details of an exemplary association process (involving a registration service) from a mobile device's perspective will be discussed in FIG. 25. It will be understood that a registration service typically functions as a data storage for the association information. An exemplary association table is discussed in greater detail in connection with FIG. 26. Examples of association information generally include identifying a user's mobile device 1601 (for example, ID:RC1), a user's assets 104, and/or a network address of the EMS (for example, EMS 110) on the Internet. Although not shown in FIG. 16, it will be understood that various other types of information relating to various electronic devices, and/or information relating to instantaneous locations of a mobile device can be indicated through a logical association. Examples of information relating to various electronic devices include (but are not limited to) identifiers such as a network name, a network address (e.g., URL, IP address, MAC address, I2C bus address) or any similar identifier which can be used to identify and access devices via a network. Examples of information identifying regions wherein location-based power management is performed include various pre-specified spatial geometries corresponding to those regions. In one aspect, such spatial geometries are specified in the form of one or more “active regions”. (Exemplary active regions illustrative of various spatial geometries are shown in FIG. 18A, FIG. 18B, FIG. 18C and FIG. 18D.)

Now referring to another module maintained within the EMS engine 216, an embodiment of the mobile device engine 213 performs the task of receiving information relating to an instantaneous location of a mobile device, wherein such information will be used in connection with power management of the various devices 104 that are housed in the facility, and are associated with the mobile device 1601. According to one aspect, such information comprises the location information of a user's mobile device in the form of latitude, longitude, or some other coordinate system, and can either be received from the mobile device, or alternately, can be received from a third-party location service provider. According to another aspect, such information includes on-demand, dynamic power management commands (as previously discussed) that will be executed on the various devices 104 that are housed in the facility, and are associated with the mobile device. One example of a power management command is a POWERON command, which powers on the associated electronic devices 104. Another command can be POWEROFF to power off the electronic devices 104. Other commands include those that are used to set the electronic devices to various power states, such as SETPOWERSTATE LOW (sets the power state(s) of the electronic devices to a low, but not off, power setting), SETPOWERSTATE MEDIUM (sets the power state(s) of the electronic devices to an intermediate setting), SETPOWERSTATE HIGH (sets the power state(s) of the electronic devices to a high setting), and other various commands as will occur to one of ordinary skill in the art.

According to yet another aspect of the present disclosure, information relating to an instantaneous location of a mobile device includes an indication (for example, either a “yes” or a “no”) corresponding to a condition whether the mobile device is within a pre-specified active region for the mobile device, or not. For example, such location information could include an indication of “ACTIVE REGION STATE=YES, corresponding to a user's mobile device being located within a pre-specified active region, or some other similar indication. As will be understood, information in connection with the active region is normally stored inside the mobile device memory and/or an exemplary EMS database 112. As will be understood by one of ordinary skill in the art, various other modules, software engines, and data tables can comprise an embodiment of the EMS 110. The modules, and software engines discussed in connection with FIG. 2 are for exemplary purposes only, alternate embodiments are not limited to the specific modules and software engines discussed herein. Even further, various information relating to a location of a mobile device can be stored in the EMS database 112, and are not limited to the ones described herein. According to one aspect, the EMS database stores information relating to an active region of a user's mobile device. As will be recalled from the discussions in connection with FIG. 16, active regions correspond to geographical areas wherein location-based power management is performed. In one aspect, such geographical areas comprise various spatial geometries. Exemplary active regions illustrative of various spatial geometries are shown in FIG. 18A, FIG. 18B, FIG. 18C, and FIG. 18D and will be described in detail next.

As recited above, “active regions” generally relate to predefined physical areas that, when a mobile device is physically located therein, trigger one or more actions relating to a user's assets. FIGS. 18A-18D illustrate various exemplary types of active regions. It will be understood and appreciated, however, that the examples shown in FIGS. 18A-18D are provided merely for illustrative purposes only, and are in no way intended to limit the scope of the present disclosure. Thus, in one example, the “active region” is defined as a circular region 1800A (such as that shown in FIG. 18A) around a defined center coordinate 1805 with a defined radius 1810. Accordingly, active region 1800A defines a geographical region or area which should be considered the region in which the user's electronic devices 104 that are housed in a facility and are associated with a user's mobile device 1601 should be powered on (or have some other power management command activated) when the user's mobile device is inside the active region 1800A. In one aspect, the active region is defined as a circular region 1800A (such as that shown in FIG. 18A) around a defined center coordinate 1805 with a defined active region radius 1810. It will be understood that users or a system administrator (such as an organization manager or IT employee) generally specify (define) their active regions prior to performing location-based power management, based on their personal preferences.

In another aspect, an active region 1800B is defined by one or more complex geospatial areas, such as one or more geospatial polygons (as shown for example in FIG. 18B) to define boundaries of cities, districts in urban settings, city blocks, counties, etc. In yet another aspect, an active region 1800C is defined based on specific rooms and/or room numbers, floors, etc. inside a building or other structure (see, for example, FIG. 18C). For example, if a user's mobile device 1601 is a building swipe card (or a badge), then the card-reading system of a structure may identify when the card (or badge) is swiped (indicating the user has entered the building), and a “power on” command (or other power management command) may be delivered to the electronic devices (assets) at that point in time. In an exemplary scenario, an intelligent building with RFID sensors track users based on a user's phone, card, or badge, and accordingly an EMS (or, its equivalent) applies various power management commands for providing energy efficiency.

In another exemplary aspect, an active region may be defined based on a variety of physical or geospatial parameters, as will occur to one of ordinary skill in the art. Additionally, as shown in FIG. 18D, an active region can be defined as an annular region having an outer active region 1802, an inner active region 1801, around a defined center coordinate 1805 with a defined active region radius 1810. In this case, the active region itself might comprise the annulus defined between inner active region 1801 and outer active region 1802. Or, there could be multiple active regions in effect at one time. For example, the region inside of inner active region 1801 may indicate that a user's devices 104 should be in the “power on” state, whereas the region between inner active region 1801 and outer active region 1802 may indicate that a user's devices 104 should be in the “hibernate” state. Thus, as a user travels towards the center coordinate 1805 (e.g., a facility) and enters the outer active region 1802, the user's devices will turn from an off position to hibernate mode. Then, as the user travels even closer to coordinate 1805 and enters inner active region 1801, the user's devices may turn to full “power on” mode. Various other active regions can be defined, as will occur to those of ordinary skill in the art. Detailed steps of an exemplary location-based energy management process, as performed by a user's mobile device will be explained in connection with FIG. 22. Interactions involving a user's mobile device 1601 and various components of an embodiment of the present system will next be described with the help of a sequence diagram.

In FIG. 19, a sequence diagram 1900 describing interactions between exemplary assets (devices), an embodiment of the EMS 110, a human EMS administrator, and a user's mobile device, is shown. Starting at step 1 in FIG. 19, during an initial configuration phase, the EMS management module 114 (specifically, an embodiment of the implementation engine 208) polls an Asset 1 using asset connectors and asset management systems over an IP network to retrieve device information relating to Asset 1. Details of steps performed by an embodiment of the implementation engine are explained with flowcharts in FIGS. 4, 5A and 5B. Similarly, during another initial configuration phase at step 2, an Asset 2 is polled by the EMS management module 114. As recited previously, Asset 1 and Asset 2 are connected to asset management systems at a facility, and the EMS management module 114 uses asset connectors to poll Asset 1 and Asset 2. At steps 3 and 4, information from both assets is retrieved by asset management systems connected to these assets and transferred over a network to the EMS 110. In one embodiment of the present disclosure, retrieved information includes (but is not limited to) network address (URI/URL) of the assets, hostnames of assets, locations, business units, etc. As will be understood and appreciated, embodiments of the present disclosure are not limited to the energy efficiency management of two (2) assets. Embodiments of the present disclosure are applicable on any number of assets, comprising a variety of asset types, brands, vendors and manufacturers, and the simplistic view of two assets shown in FIG. 3 is provided for illustrative purposes only.

At step 5, the EMS management module 114 (specifically, an embodiment of the implementation engine 208) stores (saves) retrieved asset information (related to both assets in this example) in the EMS database 112 to enable subsequent monitoring and control by various software modules, as explained below. An exemplary data table showing asset information stored in the EMS database is shown in FIG. 9. At step 6, a user's mobile device 1601 communicates association information to the EMS. Association information is used in performing remote power management of devices 104 housed in a facility with the help of location information relating to a user's mobile device 1601. Examples of association information include information identifying a user's mobile device, network address of the EMS, a network address (e.g., URL, IP address, MAC address, I2C bus address) or any similar identifier which can be used to identify and access devices via a network. Additionally, association information comprises information relating to a location of a user's mobile device, for example, specified in the form of active regions, etc. As recited previously, an association is typically a one-time “handshake” needed to create a unique mapping between the user's mobile device 1601 and such devices 104 that will be remotely controlled/managed by the user's mobile device.

As shown in FIG. 19, at step 7, the EMS stores association information in the EMS database. An exemplary association table will be discussed in greater detail in connection with FIG. 26. At next step 8, the EMS management module 114 (specifically, an embodiment of the device monitoring engine 210) retrieves asset information in addition to the previously stored association information from the EMS database 112. This information is used to locate/identify (using various attributes like IP address, hostname, etc.) individual assets and connect to them with the help of asset connectors and/or device proxies.

According to one aspect of the present disclosure, information relating to the user's mobile device is communicated to the EMS, at step 9. Such information can be communicated directly by the user's mobile device, or a third party location service provider. According to another aspect of the present disclosure, on-demand, dynamic, power management commands are provided by the user's mobile device to the EMS. According to yet another aspect, information identifying geographical regions (for example, in the form of active regions) wherein location-based energy management is performed, is provided by the mobile device to the EMS. An exemplary process showing various steps included in location based power management involving active regions, from the perspective of a mobile device, is discussed in FIG. 22.

At steps 10 and 11, the EMS management module connects to Asset 1 and Asset 2 with the help of asset connectors and/or device proxies, as necessary. Next, at steps 12 and 13, information relating to energy usage or consumption of Asset 1 and Asset 2 is retrieved from Asset 1 and Asset 2 by the EMS management module 114 (specifically, the device monitoring engine 210) and stored in a respective power profile for each respective device. In addition to power profile information, embodiments of the EMS management module 114 also collect other types of information from assets. Examples of additional information include the hardware configurations of assets, additional devices connected to assets like printers, monitors, scanners, audio speakers, current load/utilization information of respective asset, operational temperatures of assets, etc. After such information is obtained from the assets, the EMS management module 114 saves or updates the device profile and/or power profile corresponding to the newly-identified information, at step 14. As will be understood, this information may be utilized by an embodiment of the policy engine 212 to execute various energy management policies for various devices. As described above, these policies are generally created by a system user within the EMS 110 during initialization, or during normal operation, and stored in the EMS database 112 for subsequent use.

Still referring to FIG. 19, at step 15, the EMS management module 114 (specifically, an embodiment of the policy engine 212) retrieves energy management policies, power profile information, device profile information, association information and additional information (if any) that has been saved earlier. According to one embodiment of the present disclosure, these energy management policies were created by a (human) EMS administrator 116 and saved in the EMS database 112. It will be understood that such policies might comprise energy management policies involving aspects of remote power management based on instantaneous locations of users' mobile devices. An exemplary data table saved in the EMS database 112 including exemplary policies for remote power management of devices is shown in FIG. 28. Association information (usually communicated by mobile devices) are shown exemplarily with a data table in FIG. 26.

At steps 16 and 17, respectively, the EMS management module 114 connects to individual assets 104 located at facilities, using asset connectors and/or device proxies maintained within the EMS, and applies/executes energy management policies on respective assets. Finally, at step 18, the EMS displays energy management reports of assets to an EMS administrator 116.

Although not shown in FIG. 19, it will be understood that in alternate aspects of the present disclosure, a user's mobile device 1601 communicates power management commands and/or mobile device location information to the EMS 110 to apply/execute energy management policies on respective assets 104 controlled by the user's mobile device. For example, after step 13, the mobile device 1601 may transmit specific commands to the EMS, or it may transmit location information to the EMS for inclusion in processing of policies. It will be further understood that such power management commands typically comprise on-demand, dynamic commands and related to the instantaneous location of a user's mobile device. It will be recalled from the discussions in FIG. 16, examples of such on-demand, dynamic power management commands include (but are not limited to) POWERON, POWEROFF, SETPOWERSTATE LOW, SETPOWERSTATE MEDIUM, SETPOWERSTATE HIGH and various other commands.

In another exemplary aspect, a mobile device communicates location information corresponding to an indication of whether or not the instantaneous location of the mobile device is within the active region associated with the mobile device. Such an indication can be made periodically by a location sensor embedded in the mobile device and/or based on location of the mobile device as tracked by a third party location-service provider. In other words, it will be understood that information corresponding to an instantaneous location of a user's mobile device is transmitted by a mobile device application program running on the user's mobile device, wherein the instantaneous location is obtained with the help of a location sensor embedded in the mobile device that communicates with the mobile device application program running on the user's mobile device. Alternately, a mobile device application program running on the user's mobile device communicates with a third-party location-based service provider which then provides the instantaneous physical location of a user's mobile device to the EMS.

An exemplary process showing various steps included in location based power management from the perspective of a mobile device involving determination of whether or not a mobile device is located inside pre-specified active regions, is discussed in FIG. 22. As will be understood and appreciated, embodiments of the present disclosure are not limited to the specific processes or sequences for energy efficiency management as discussed in FIG. 19, and other embodiments may implement other processes as will occur to one of ordinary skill in the art. Further, embodiments of the present disclosure are applicable on any number of assets, comprising a variety of asset types, brands, vendors and manufacturers, and further on any number of mobile devices from different brands and manufacturers.

Turning now to FIG. 20, a flowchart is shown representing a high-level process 2000 of remote energy management of devices housed in a facility performed by various EMS modules and EMS software components on the basis of information relating to a user's mobile device. Examples of information relating to a user's mobile device comprise the instantaneous location of a user's mobile device, various on-demand, dynamic power management commands provided by a user's mobile device 1601, or any other communication received from a user's mobile device in connection with location-based energy management of assets 104 housed in a facility and that are associated with a user's mobile device 1601. For example, if the user leaves a certain area or geographical region (e.g., 1 mile around the user's computer) the user's computer could automatically power off. Also, if the user enters the area or geographical region, the computer could automatically power on.

As will be understood and according to one embodiment, location-based energy management of assets 104 housed in a facility and that are associated with a user's mobile device 1601 involves various software modules, databases and components that comprise the EMS 110. It will be recalled that details of the workings of the individual software modules, databases and components of the EMS were explained previously in connection with FIG. 4 and also FIGS. 5A-7B. Thus, it is believed that such details are not necessary to be repeated in what follows herein. However, it will be further noted that the workings of certain software modules that were previously explained in connection with FIG. 4, and also FIGS. 5A-7B will be modified for accommodating the mobile device embodiment discussed herein. Consequently, in the discussions that follow, various software modules that have been newly introduced, and/or modified from previous embodiments in order to accommodate the alternate embodiment will be discussed in greater detail. As recited previously in the description of FIG. 4, various process steps performed by individual software modules are generally asynchronous and independent, computer-implemented, tied to particular machines, and not necessarily performed in the order shown.

Starting at step 2002 in FIG. 20A, the EMS (specifically, an embodiment of the implementation engine 208) is configured by retrieving asset information from various assets and storing the retrieved information in the EMS database 112 using asset management systems and asset connectors. As recited previously, during this configuration phase, asset information retrieved may comprise various attributes related to asset type, model number, manufacturer, network name/address associated with device, and the like. Further details of the process steps 2002, 2004, and 2006 that are followed by the implementation engine 208 were discussed previously at steps 402, 406, and 410 in connection with FIG. 4 and were further explained in even greater detail in FIGS. 5A, 5B.

It will be recalled from the discussions in connection with FIG. 16 and FIG. 19 earlier that a user's mobile device typically provides association information for creating a mapping between the user's mobile device 1601 and the devices 104 housed in a facility. Association information is used in performing remote power management of such devices 104 housed in a facility with the help of location information relating to the user's mobile device 1601. Examples of association information include information identifying a user's mobile device, network address of the EMS, a network address (e.g., URL, IP address, MAC address, I2C bus address) or any similar identifier which can be used to identify and access devices via a network. As shown in FIG. 20 an association engine 209 receives association information from a user's mobile device, and further stores the received association information in an EMS database, at steps 2008 and 2010 respectively.

Still continuing with FIG. 20, it can be further seen that a sequence of next steps executed within the EMS are performed by an embodiment of the device monitoring engine 210, policy engine 212, and a mobile device engine 213 concurrently. Generally, the steps performed by the policy engine 212 include applying/executing policies for energy efficiency management of individual assets, whereas, steps performed by the device monitoring engine 210 are executed primarily for purposes of monitoring power consumption of individual assets. Also, steps performed by the mobile device engine 213 involve processing dynamic, on-demand power management commands relating to an instantaneous location of users' mobile devices. Detailed steps of exemplary processes performed by a mobile device engine 213 will again be explained in connection with FIG. 21 (consisting of FIG. 21A, FIG. 21B, and FIG. 21C).

Thus, it can be understood that, in one embodiment, the steps performed by the device monitoring engine 210, policy engine 212, and mobile device engine 213 occur in parallel and may be dependent upon each other. It will be recalled that steps performed by the device monitoring engine 210 (comprising steps 2012, 2014, 2016, 2018) are identical to the steps 414, 418, 422, and 426 that were explained in FIG. 4 previously, and additionally with greater detail in FIGS. 6A, 6B. Thus, for the sake of brevity, details of such steps are not recited in the description of FIG. 20.

Additionally, it will be understood that steps followed by policy engine 212 have been modified (from that discussed previously in connection with FIG. 4) in accordance with aspects of the presently-described mobile device embodiment, and such steps will now be described. As recited previously, steps followed by policy engine 212 may occur in parallel with the steps followed by device monitoring engine 210 and mobile device engine 213. At step 2020, policy engine 212 receives policies for performing energy efficiency management. (Exemplary policies involving usage of instantaneous location of a user's mobile device is shown in FIG. 28. It will be understood that policies can be entered though a policy creation interface on a user's mobile device, or through a policy-creation interface on a general purpose computing device by an EMS administrator 116 or user.) At optional step 2022, the policy engine 212 receives current location information relating to a user's mobile device. As recited previously, such information can be provided directly by the user's mobile device, or by a third party location service provider. It will occur to one of ordinary skill that in several scenarios, users may desire to opt out of remote management of assets in a facility. Such assets, then would be subjected to energy management policies that do not involve location information relating to a mobile device. Thus, in such scenarios, it will occur to one of ordinary skill that step 2022 is a redundant step (and, thus has been indicated in FIG. 20 with a dotted rectangle as optional).

Accordingly, at step 2024, policy engine 212 determines whether or not policies for performing energy efficiency management of assets involve using location information relating to a mobile device. If the policy engine 212 determines that location information relating to a mobile device is not necessary, then the policy engine 212 applies policies for performing energy efficiency management of assets, using associated power profile information and/or device profile information stored in the EMS database 114. As recited previously, examples of power profile information include (but are not limited to) real-time power consumption of the device, duration of time for which the device has been operational, etc. Also, examples of device profile information relate to power attributes of a given device at a certain time (or over a period of time). Examples of different attributes of power information include real-time power consumption of a device, duration of time for which a device has been operational, power state of a device (on/off/hibernate modes), and various other such power-related details.

Before continuing further with the description of FIG. 20, a brief description of policies is provided next. Policies or rules for performing energy efficiency management of assets govern various aspects of the energy state or power state of a device, including how and when assets are to be turned off/on in order to achieve energy efficiency. Various other embodiments of rules relate to other actions to be taken with respect to devices, including providing information relating to the device to a system user, or storing certain information automatically in a database, receiving information relating to a current location of a user's mobile device 1601, or providing an alert to a system user, etc. These rules are processed by the EMS and actions associated with rules are communicated with the help of asset connectors and/or device proxies in order to be executed on the individual assets/devices 104 in step 2032.

A policy (or synonymously, a rule) is comprised of one or more associated conditions and actions. Generally, rules include directions to conduct one or more specific actions on one or more assets depending on satisfactions of one or more conditions. Generally, conditions are criteria that are required to be satisfied to enable actions for energy efficiency management to be executed with respect to assets. For example, an exemplary rule might dictate that energy consumption of assets housed in an organizational facility belonging to a hypothetical user called John Doe will be turned off if a current location of John Doe's mobile phone is beyond 2 (two) miles of the facility, and will be turned on otherwise. As will be understood, in this exemplary rule, the action involved is turning off and turning on assets. The set of conditions include a determination of whether or not a current location of John Doe's mobile phone corresponds to within two miles of the respective facility. In order to execute this exemplary policy, it will be understood that John Doe's mobile phone (or a location service provider that tracks John Doe's mobile phone) should provide current location of John Doe's mobile phone to the EMS at regular intervals of time. In this scenario, the location information is simply one other criteria used by an embodiment of the policy engine 212 to determine whether a given policy should or should not be implemented.

Still to FIG. 20, if at step 2024, policy engine 212 determines that location information relating to a mobile device 1601 is necessary to execute policies for performing energy efficiency management of assets 104, then in one embodiment, the policy engine 212 applies priority considerations according to a predetermined sequence so that one rule has higher priority over other rules in the policy table. Thus, if two or more policies apply to a given asset simultaneously, the higher “ranked” (e.g., more important) policy is the one that will control and ultimately be implemented with respect to the asset. For example, a policy could indicate turning off assets in a certain facility on weekends. However, another rule in the policy table could indicate such assets are to be turned off if a current location of user's mobile phone is beyond 2 (two) miles of the facility, and such assets are to be turned on otherwise. A predetermined priority consideration sequence would assign a higher priority to policies involving a user's mobile device. So, if for instance, instantaneous location of a user's mobile device indicates that the user is within 2 (two) miles of the facility on a weekend, then the assets 104 associated with that mobile device 1601 will be turned on. Further, priority considerations given to policies are generally created by an EMS user or administrator when policies are created. Thus, an EMS administrator can dictate whether location-based policies will control over other policies, or vice versa. It will be recalled that the EMS 110 identifies the assets 104 associated with a mobile device 1601 based on association information received by the association engine 209, as indicated previously in FIG. 20.

Continuing with FIG. 20, at step 2030, the policy engine verifies that the set of conditions in a give rule have been satisfied. In the above example, if the instantaneous location of a user's mobile device 1601 satisfies these conditions, then the associated assets 104 are turned on immediately. If the instantaneous location of a user's mobile device does not satisfy the conditions, the policy engine 212 proceeds to process the next rule by reverting back to step 2034, until all rules have been processed. In the above example, if the instantaneous location of a user's mobile device is more than (2) two miles from the facility on a weekend, then the associated assets remain turned off based on the other policy in the policy table. An exemplary policy table is shown in FIG. 28.

If the conditions of a given rule have been satisfied, then action(s) associated with that rule are executed (at step 2032) with respect to aspects that are encompassed by the rule. As recited previously, policy engine 212 periodically synchronizes with assets for the purposes of applying rules vis-à-vis controlling individual assets, and thus reverts back to step 2020 periodically.

According to an aspect of the present disclosure, a mobile device engine 213 processes dynamic, on-demand power management commands relating to an instantaneous location of users' mobile devices. As shown in process 2100 of FIG. 20, a mobile device engine can follow various processes, according to different exemplary aspects. Different exemplary processes performed by a mobile device engine are described in connection with FIG. 21A, FIG. 21B, and FIG. 21C.

Generally, the mobile device process 2100 run in parallel with aspects of the policy engine 212. Thus, in some embodiments of the EMS, the system does not perform optional steps 2022, 2024, and 2028 if on-demand power management commands are received from the mobile device 1601 via process 2100. In alternate embodiments, rather than receiving explicit power management commands (e.g., turn assets “ON”), the EMS simply receives location information identifying a location of the user's mobile device, or active region state information indicating whether or not the mobile device is within an active region. In these embodiments, steps 2022, 2024, and 2028 may need to be performed to process the received location information or active region state information according to predetermined policies. As will be understood and appreciated, various embodiments of the present system enable utilization of mobile device processes 2100, policy engine 212, or both.

Finally, it can be seen from FIG. 20 that resultant effects of monitoring, processing of dynamic, on-demand location-based power management commands, and/or execution of location-based as well as non-location-based power management policies on assets are displayed in the form of reports at step 2036 by (in one embodiment) reporting engine 214. According to one embodiment of the present disclosure, the EMS generates various reports and analytical tools relating to device profile information and power profile information, and a system user reviews the energy efficiency management reports through a graphical-user-interface, along with detailed analytics related to power consumption and cost savings. Exemplary screenshots showing various reports are indicated in FIGS. 11A, 11B, FIG. 13 and FIG. 14.

Now referring to FIG. 21A, a flowchart showing computer-implemented method steps involved in an exemplary mobile device engine process 2100A is described. Starting at step 2102, an embodiment of the mobile device engine receives instantaneous location information relating to a mobile device. It will be understood by one of ordinary skill that an instantaneous location of a user's mobile device can be obtained via a location sensor (such as an on-board GPS receiver), or can be provided from a third-party location-based service provider (such as LOCAID™, for example). According to one aspect of the present disclosure, the location sensor is integrated into a user's mobile device. In other words, it will be understood that information corresponding to an instantaneous location of a user's mobile device is transmitted by a mobile device application program running on the user's mobile device, wherein the instantaneous location is obtained with the help of a location sensor embedded in the mobile device that communicates with the mobile device application program running on the user's mobile device. Alternately, a mobile device application program running on the user's mobile device communicates with a third-party location-based service provider which then provides the instantaneous physical location of a user's mobile device to the EMS.

According to another aspect, the location sensor can use software to determine its current location by using network information, such as Internet addresses or WIFI network addresses. According to yet another aspect, the instantaneous location of the user's mobile device can be retrieved by using mobile cell tower information, cell tower triangulation information, or mobile network information. In still another aspect, RFID and near-field sensors can be used to determine the instantaneous location of the mobile device (for example, use of an employee swipe card or access card used for entrance to a building or secure area within a building). As will be understood and appreciated by one of ordinary skill in the art, various mechanisms can be utilized to identify the instantaneous geographic location of a user's mobile device according to various aspects of the present system, and embodiments of the present system are not limited to the specific mechanisms described herein.

At step 2104, the mobile device engine 213 retrieves association information stored in EMS database. It will be recalled that association information creates a mapping between a mobile device 1601, and assets 104 housed in a facility that will be controlled by a mobile device 1601. Such association information was received by an association engine 209, as was discussed earlier in FIG. 20. As mentioned previously, examples of association information generally include an identification of a user's mobile device 1601, a user's assets 104, a network address of the EMS, and the like.

At step 2106, the mobile device engine 213 uses the mobile device's location information and the association information to determine whether the mobile device is within an active region. If so, then the EMS applies predetermined power management commands to respective assets indicating an action to be taken with respect to the asset. In one embodiment, the location information received at step 2102 is utilized within an embodiment of the policy engine to determine whether certain policies are satisfied. If so, then power management commands associated with those policies are implemented. Thus, as will be understood, in process 2100A, all that the EMS receives is location information identifying the spatial location of a mobile device. The EMS 110 then processes that information against predetermined policies and commands to determine whether actions with respect to a user's assets 104 should be taken.

Again, one example of a power management command is a POWERON command, which powers the associated electronic devices 104 on. Another command can be POWEROFF to power the electronic devices 104 off. Other commands include those that are used to set the electronic devices to various power states, such as SETPOWERSTATE LOW (sets the power state(s) of the electronic devices to a low, but not off, power setting), SETPOWERSTATE MEDIUM (sets the power state(s) of the electronic devices to an intermediate setting), SETPOWERSTATE HIGH (sets the power state(s) of the electronic devices to a high setting), and other various commands as will occur to one of ordinary skill in the art. As recited in FIG. 21A, according to one aspect, predetermined power management commands are stored in a EMS database. In what will be described next, power management commands are provided by a user's mobile device, according to one exemplary embodiment of the present disclosure.

Now referring to FIG. 21B, a flowchart showing computer-implemented method steps involved in an exemplary mobile device engine process 2100B is described. Generally, the process 2100B shown in FIG. 21B relates to a scenario in which a user's mobile device identifies whether or not the mobile device is within an active region, and if so, transmit power management commands explicitly to the EMS. In this scenario, simple location information is not transmitted to the EMS, but actual commands for taking action with respect to a user's assets is transmitted. Accordingly, the processing for determining whether a mobile device is within an active region or not occurs within the mobile device software (application).

Starting at step 2110, an embodiment of the mobile device engine receives one or more on-demand, dynamic power management commands from a mobile device. It will be understood that in one aspect, such commands are the result of processing of a current location of the mobile device. Examples of power management commands have been mentioned in connection with FIG. 1, FIG. 21A, and several other places in this document. At step 2112, the mobile device engine 213 retrieves association information stored in EMS database, and then applies (at step 2114) these power management commands to respective assets based on association information.

Described next (in connection with FIG. 21C) is another exemplary process followed by a mobile device engine involving active regions. It will be recalled that information relating to a location of a user's mobile device can be specified in the form of active regions, according to one aspect of the present disclosure. Generally, active regions correspond to geographical areas wherein location-based power management is performed. Such geographical areas comprise various spatial geometries, for example, circular active region, annular active regions with an inner and an outer radius, etc. (Exemplary active regions illustrative of various spatial geometries are shown in FIG. 18A, FIG. 18B, FIG. 18C, and FIG. 18D.)

According to one exemplary aspect, a mobile device (or a location service provider) can make a determination whether or not a mobile device is inside a predetermined active region. Thus, in FIG. 21C, at step 2118, a mobile device engine receives from a user's mobile device communication corresponding to an indication of whether or not instantaneous location of a mobile device is inside a predetermined active region. Then, the EMS (via the mobile device engine 213, for example) retrieves (at step 2120) association information pre-stored in EMS database. Subsequently at step 2122, the mobile device engine applies predetermined power management commands to the respective assets, based on indication received from mobile device (at step 2118), and association information retrieved at step 2120. Specifically, the EMS uses the indication that a user's mobile device is or is not inside an active region to determine whether or not certain policies and/or power management commands have been satisfied for the user' assets. According to one embodiment, power management commands are pre-stored in an EMS, wherein the power management commands are configured by a EMS administrator or a system user.

It will be understood that in one exemplary aspect, the steps performed by the policy engine 212 and mobile device engine 213 occur in parallel. In other words, in an exemplary embodiment, the EMS applies dynamic, on-demand power management commands (as exemplarily discussed in FIG. 21A, FIG. 21B, and FIG. 21C) to assets in conjunction with a more static approach wherein power management is performed based on pre-stored rules/policies (as discussed exemplarily in connection with a policy engine in FIG. 20). As understood from the earlier discussions in connection with FIG. 21A, FIG. 21B, and FIG. 21C, the EMS performs power various kinds of power management policies to assets based on the information received from mobile devices. Steps performed by a mobile device in relation to location-based energy management of assets will now be described next in FIG. 22.

Now referring to FIG. 22, an exemplary process 2200 is shown describing location-based energy management from the perspective of a mobile device. According to one exemplary aspect, it will be understood that a mobile device can transmit various kinds of power management commands and/or location information depending on its location relative to one or more active regions. The process 2200 shown in FIG. 22 relates to processes occurring within a mobile device 1601 to determine whether or not the mobile device is within an active region (such as regions 1800 in FIG. 18) or not. It will be recalled from the previous discussions (particularly with reference to FIG. 18A, FIG. 18B, FIG. 18C, and FIG. 18D) that active regions correspond to geographical areas wherein location-based power management is performed. Such geographical areas comprise various spatial geometries, for example, circular active region, annular active regions with an inner and an outer radius, etc. It will be understood and appreciated that the steps in FIG. 22 describe a generic flowchart, and are not limited to a particular number of active regions, or even, any particular geometric shape of active regions.

For the description of the steps in FIG. 22, it will be assumed that associations between a mobile device 1601 and assets 104 in a facility have been created at an earlier instance of time. Computer-implemented method steps in an exemplary association process are discussed in connection with FIG. 24 and FIG. 25. An exemplary association table will be discussed later in FIG. 26.

Starting at step 2202 in process 2200, a mobile device 1601 updates its current location using a location sensor embedded in the mobile device, or alternatively, with the help of a location-based service such as LOCAID™. It can be assumed that an initial or previous location of the mobile device must have been determined at some point prior to step 2202, such that the “current location” of the mobile device is updated to reflect the actual current location of the mobile device. Then, at step 2204, the mobile device retrieves pre-stored parameters corresponding to active regions associated with the mobile device. According to one aspect, an EMS administrator or a system user has configured the mobile device to store such parameters corresponding to various active regions. Examples of active region parameters are shown with a data table (stored in the mobile device memory) in FIG. 24. These active region parameters are stored within the mobile device 1601 in a mobile device memory or database.

Next at step 2206, a mobile device determines whether or not current location of the mobile device is outside an active region pre-specified for the mobile device. In other words, a mobile device assigns a current active region state as “inside” if current location of the mobile device is inside the active region, and “outside” if the current location is outside an active region. It will be understood that various other types of terminology could be assigned to define the current active region state of the mobile device. It will be understood by one of skill in the art that location-based power management (of assets in a facility) is triggered by a mobile device when the current active region state and a previously stored active region state of a mobile device are different. Generally, at times when the current and previously stored active region states of a mobile device are identical, the mobile device periodically updates its location, and therefore its active region state, but does not transmit any kind of information to the EMS.

Consequently, as shown in FIG. 22, at step 2208, the mobile device retrieves a previously stored active region state. Generally, the previously-stored active region state corresponds to a prior location of the mobile device (and whether or not it was within an active region). Depending upon the frequency of process 2200, this previously-stored active region state may have been identified and stored a few minutes prior to the identification of the current location and active region state, or a few seconds before, or virtually instantaneously before, or at some other time period. At step 2210, the mobile device compares its current active region state (as determined in step 2206) to a previously stored active region state. If the mobile device determines that the current active region state and the previously stored active region state are the same, then no specific action is taken and no information is sent to the EMS 110. In this case, the mobile device simply updates its current location by reverting back to step 2202, and the process continues thereafter.

However, if the mobile device determines at step 2210 that the current active region state is different from the previously-stored active region state, then the process moves to step 2212. As will be understood by one of ordinary skill in the art, the current and previously stored active regions will be different if one active region indicates “inside” whereas the other indicates “outside”, or vice-versa. If the mobile device determines that its current active region and previously-stored active region are different, then it retrieves (at step 2212) information relating to such changes in active region state. According to one embodiment, information relating to changes in active region states correspond to various pre-stored power management commands (provided by the mobile device to the EMS). Examples of such power management commands include POWERON, POWEROFF, STANBY, HIBERNATE, SETPOWERSTATE LOW, SETPOWERSTATE MEDIUM, SETPOWERSTATE HIGH and various other commands.

According to another embodiment, instead of retrieving a power management command, information relating to changes in active region states correspond to a mobile device simply informing the EMS of a change in its active region state. For example, the information retrieved at step 2212 may simply comprise an indication to be sent to the EMS indicating movement of the mobile device from “inside” the active region to “outside” the active region, or vice-versa. In this embodiment, the EMS utilizes the active region state information to identify appropriate power management commands and implement the same with respect to various assets. Next, at step 2214, the mobile device transmits information relating to changes in active region state to the EMS.

Additionally, it is also shown in FIG. 22, that at step 2216, the mobile device updates its previously stored active region state to reflect the current active region state. In other words, the mobile device replaces a previously-stored active region state with a current active region state. It will be understood that information transmitted by a mobile device (for example, at steps 2214 in FIG. 22) is utilized for power management of devices in a facility as explained with flowcharts in FIG. 20, FIG. 21A, FIG. 21B, and FIG. 21C. It will be understood that no limitation is imposed on the number of devices that a user's mobile device can be associated with, and can include multiple device types, brands, vendors and manufacturers, and not remain specific to certain devices, or manufacturers. Even a user's mobile device can correspond to mobile phones, badges, user's smart cards for entry into buildings, or any other device that corresponds to location-based or proximity-based technology. Further, embodiments of the present disclosure are not limited to a particular number of active regions, or even, any particular geometric shape of active regions. An exemplary data table showing various active region parameters is shown in FIG. 23, and will be described next in further detail.

Referring to FIG. 23, an exemplary data table 2300 is shown comprising various types of data as stored in the memory/database of a mobile device 1601. As recited previously, a mobile device typically communicates with an EMS via a network address. Thus, as shown in data table 2300, a network address of an EMS is indicated in the column titled “EMS Network Address”. It will be understood and appreciated that a mobile device 1601 can manage power consumed by assets 104 belonging to different facilities, that are in turn managed by different energy management systems (EMSs). Therefore, an exemplary mobile device table 2300 shown in FIG. 23 stores two entries corresponding to two different EMSs, for example a home EMS at network address 10.1.2.221, and a work EMS at network address 68.10.34.50.

In addition to an EMS Network Address column, the mobile device table 2300 shown in FIG. 23 also stores a current active region state and a previous active region state for its respective mobile device 1601, as indicated in columns “Current Active Region State” and “Previous Active Region State” respectively. It will be recalled that states identifying current and previous active regions are typically indicated as “inside” and/or “outside”, corresponding to whether a mobile device is inside/outside an active region currently/previously. Details of processing steps taken by a mobile device in utilizing the above-mentioned states to perform location-based energy management of assets in a facility have been explained earlier with a flowchart in connection with FIG. 22.

Moreover, in the embodiment shown in FIG. 23, a mobile device stores its current location in a “Current Location” column, and information corresponding to a mobile device's active region in an “Active Region Parameters” column. Exemplarily, it is shown in FIG. 23 that in one instance, a mobile device's active region is an annular circle, with an outer radius of 5 miles, and an inner radius of 2 miles around a location identified as 33° N 84° W. As discussed previously herein, it will be understood that active regions can correspond to various other spatial geometries, boundaries of cities, districts in urban settings, counties, etc., and even room numbers or locations of a building, factory etc. According to one aspect of the present disclosure, the current location of a mobile device is updated by the mobile device periodically (for example, every few seconds or any other time interval), and consequently it will be understood that the contents of various columns in FIG. 23 are updated periodically as well.

According to another aspect, information corresponding to a mobile device's active region is also stored as a part of association table 2610 inside the EMS database 112, as shown exemplarily in FIG. 26. It will be understood from the earlier discussions in connection with FIG. 1 that aspects of the present disclosure relate to creation of associations between a user's mobile device 1601 and various assets 104 (computers, phones, printers, lighting equipment etc.) that will be controlled by the user's mobile device 1601. It will be better understood from an exemplary association table in FIG. 26 that the user's mobile device as well as the various assets in a facility are usually identified with the help of an identifier, which can be a name, a network address (e.g., URL, IP address, MAC address, I2C bus address) or any similar code which can be used to identify and access the devices through a network.

According to one aspect, one way of creating associations between users' mobile devices 1601 and the associated assets 104 involves manually entering, through a user-interface, respective identifiers for the various assets and the users' mobile devices. Typically, a user or an EMS administrator enters such identifiers either from a user's mobile device 1601 or directly through an EMS user-interface. Depending on the design of the underlying network, the identifiers can be network addresses (IP address, MAC address, etc.) or more complex data structures, e.g., a combination of multiple addresses in the case of a complex system having many intermediary systems (like proxy servers, routers, etc.) and several EMSs.

It will be understood and further explained below that another method of creating associations between users' mobile devices 1601 and respective assets 104 involves the use of a registration service. Such a registration service can be a stand-alone third party provider, or can be integrated with a EMS, wherein the registration service acts as an intermediary system for creating associations. As will occur to one of skill in the art, a registration service typically functions as a data storage for the association information. In what follows next, steps of an association process involving a registration service will be described.

Now referring to FIG. 24, a flowchart is shown with computer-implemented steps of an association process 2400 from the perspective of a registration service. At step 2402, the process starts by receiving a request from a system user to associate assets 104 with a mobile device 1601. According to one aspect, the registration service is accessible via the Internet, and further the registration service is installed on or previously-associated with assets 104 that will be associated with a mobile device 1601. (Steps performed by a mobile device in an exemplary association process involving a mobile device will be described in FIG. 25.) Generally, a system user interacts with the registration service via a user-interface attached to the asset (for example, a monitor). In an exemplary scenario, system users access the registration service from their desktop PCs and laptops (via the Internet) so that such assets will be associated with a user's mobile device. It will be understood and appreciated that in one exemplary aspect of the present disclosure, the registration service extracts the identifying information (such as network address, MAC address etc.) of the particular asset that is used to access the registration service. In another aspect, device and/or association information is pre-stored in a registration service data storage, as entered by a system user or a system administrator, or even automatically provided by the EMS.

As shown in FIG. 24, at next step 2404, the registration service generates a code automatically and transmits (at step 2406) the same to the EMS 110. It will be understood that such a code will be used by the EMS 110 to identify mobile devices 1601 that communicate for the first time with the EMS 110. In other words, after the mobile device 1601 communicates with the EMS for the first time and provides the code, in turn, the EMS 110 will provide association information (for example, network address, MAC address, and other identifiers) of the respective assets 104 that will be controlled by the mobile device to the mobile devices. Next, at step 2408 the system displays the code to the system user. According to an aspect, a system user will enter the code through a mobile device interface when the mobile device communicates with the EMS for the first time, and provides the code to the EMS 110.

Described next is an exemplary process involving steps of an association process 2500 as performed by a mobile device 1601. Referring to FIG. 25, a flowchart is shown describing computer-implemented steps performed by a mobile device, in an exemplary association process 2500 involving a code received from a registration service.

Starting at step 2502, a mobile device receives a code entered by a system user. It will be recalled that such a code was provided earlier by a registration service, as discussed in connection with FIG. 24. At step 2504, the mobile device transmits the code along with the identifier for the mobile device (for example, device ID, IMEI number, and/or other information identifying the mobile device) to the registration service. According to one aspect, a mobile device application program running on the user's mobile device transmits the code along with the identifier to the registration service. As will be understood and appreciated, in one aspect, such a code allows for transfer of association information from the registration service to the user's mobile device. It will be further understood that a registration service functions as a data storage intermediary between a user's mobile device and the EMS. Thus, at step 2506, the user's mobile device receives the association information relating to the assets that will be controlled by the mobile device, and thereafter stores (at step 2508) such association information in a database. As recited previously, one way of creating associations between users' mobile devices 1601 and the associated assets 104 involves entering identifiers and/or other information for the various assets and the users' mobile devices through a user-interface. Typically a user or an EMS administrator enters such identifiers either from a user's mobile device or directly into a EMS user-interface. Usually, after an association is created, association information is stored at one or more of the following: user's mobile device, EMS database, and registration service. Subsequent changes to the association can be performed automatically and/or remotely, or by manual changes performed by persons through a mobile device user-interface, or a EMS user-interface, or through some other mechanism.

Now referring to FIG. 26, an exemplary association table 2610 (stored in an EMS database 112) comprising exemplary association information, is shown. As recited previously, an association is typically a one-time “handshake” needed to create a unique mapping between the user's mobile device 1601 and such devices 104 that will be remotely controlled/managed by the user's mobile device. As shown, the association table comprises columns named “Remote Control Device”, “Device ID”, “Device Type”, and “Active Region”. For example, the Remote Control Device column stores information identifying users' mobile devices uniquely (e.g., the user's cellular phone and intelligent employee entry badge). A Device ID column stores unique identifiers for the user's devices 104, and Active Region Parameters column stores information defining active region(s) for the particular mobile device. Such geographical areas comprise various spatial geometries, for example, circular active region, annular active regions with an inner and an outer radius, etc. According to one aspect, various commands or communication will be transmitted by the user's mobile device to manage power consumption of the associated assets when the user's mobile device is located in its active region. (Exemplary active regions illustrative of various spatial geometries are shown in FIG. 18A, FIG. 18B, FIG. 18C, and FIG. 18D.)

As shown by the exemplary data stored in the columns in FIG. 26, a user's mobile device identified as RC1 is associated with assets identified as 412a702 and 14b8129, the user's mobile device having an active region comprising of an outer active region 5 miles, and an inner active region 2 miles around a location 33° N 84° W. In an example, such a location identifies the geographical co-ordinates (in latitude, longitude) of a facility that houses the devices identified as 412a702 and 14b8129.

Although not shown in FIG. 26, it will be understood that a user's mobile device 1601 can be associated with one or more active regions, and with a plurality of assets 104. Further, active regions can correspond to various other spatial geometries, boundaries of cities, districts in urban settings, counties, etc., and even room numbers or locations of a building, factory etc. It will be understood that no limitation is imposed on the number of devices 104 that a user's mobile device can be associated with, and can include multiple device types, brands, vendors and manufacturers, and not remain specific to certain devices, or manufacturers. Even a user's mobile device can correspond to mobile phones, badges, user's smart cards for entry into buildings, or any other device that corresponds to location-based or proximity-based technology.

Turning now to FIG. 27, an exemplary device table 2812 is shown comprising exemplary attributes associated with devices 104 and associated mobile devices 1601 that control such devices. It will be recalled that a similar table was discussed in reference to FIG. 9, and such a table is merely repeated here with slight modifications to accommodate alternate embodiments of the present disclosure. The information shown in the device table 2812 generally represents the types of information maintained in a device profile for each asset. As shown, the device table comprises columns named “Date/Time Stamp”, “Device ID”, “Mobile Device ID”, “Device Type”, “Status Type”, “Asset Connector”, “Host Name”, “URL”, “Model type”, and “System Type”. For example, the Date/Time Stamp column indicates a date and a time when a device was polled, or when a device profile was last updated. A Device ID column stores a unique identifier for a device, a Remote Control Device column stores information identifying users' mobile devices uniquely, etc. Further, it will be understood that a Device Type column identifies a type of device, a Status type column indicates a power state (for example, on/off/hibernate etc.) of a device at the date and time it was polled, and an Asset Connector column specifies an associated asset connector for the device. It will be recalled from the earlier discussions that asset connectors correspond to EMS software that is used to discover and import information relating to assets into the EMS, with the help of one or more asset management systems, wherein asset management systems are usually IT-management tools provided by an existing network system and/or facility infrastructure.

Continuing with the descriptions of various columns in FIG. 27, a Host Name indicates a device label for various forms of IT network communication that a device utilizes, a URL (Uniform Resource Locator) identifies a network address for a device, a Model Type column indicates a model number for a device, and a System Type specifies a generic system or purpose associated with a device.

For example, as can be seen from the data entries in device table 2812, on a Date/Time Stamp “2011-02-24 10:50 AM” corresponding to a device identified by a Device ID “412a702” that is associated with a user's mobile device identified as “RC1”, the above-mentioned Device ID corresponding to a Device Type “PC.Windows”, i.e., a WINDOWS™ PC, in a Status Type (power state of device) “3”. As will be recalled from FIG. 9, various power states may be represented in the EMS 110 as numbers, for example “0” may indicate a device is powered off, “1” indicates a device is on standby power mode, “2” indicates a device is in hibernate power mode, “3” indicates a device is powered on, etc. It will be recalled that information corresponding to various power states of a device are obtained by a device monitoring engine 210 as described in FIG. 2 earlier. It will be further understood that other numbering schemes can be used to represent various power states of a device, or that no numbering scheme be used.

Continuing with further columns of a device identified by a Device ID “412a702” in device table 2812, an Asset Connector “83907b8” is associated with this device, a Host Name “Test-PC2” labeling the device at a URL “10.64.54.27”. Further, Model Type for said device is specified as “DELL LATITUDE™ E6410”, said device having a System Type “Workstation”. It can be seen in FIG. 28 that values for Device ID and Asset Connector are expressed in hexadecimal number format, as is customarily used in representation of most electronic computing devices. However, as will be understood, other numbering systems can also be used, for example, decimal number format, etc. Additionally, it will be further understood that a URI (Uniform Resource Identifier) column can alternatively be used to identify a network address for a device, in place of URL (Uniform Resource Locator) column, as shown in device table 2812. Furthermore, as will be understood by one having ordinary skill in the art, the device table 2812 is presented for illustrative purposes only, and embodiments of the present system 110 are not limited to data, information, and fields in the specific data table shown.

According to one aspect of the present disclosure, location-based energy management of assets (exemplarily described with various attributes in FIG. 27 and having corresponding associations as illustrated in FIG. 26) are performed according to various policies as will be described next in FIG. 28. Referring to FIG. 28, a policy table 2810 (stored in an EMS database 112) is shown comprising a collection of policies or rules. It will be recalled that a similar table was discussed in reference to FIG. 8, and such a table is merely repeated here with slight modifications to accommodate alternate embodiments of the present disclosure. As recited previously, these policies are generally created either during initialization of the EMS 110, or during normal operation, and stored in the EMS database 112. These policies/rules can be created/specified by an EMS administrator, or can be configured through a script developed using a scripting language, or preconfigured within the EMS, preconfigured via a user's mobile device, or developed in some other manner.

As explained previously, it will be understood that a collection of policies can be prioritized according to various predetermined sequences. For example, rather than iterating through devices for a given rule, a particular policy rule can be selected, and the devices that could pertain to that rule may be iterated. Once complete, a second rule could be selected, and so on. In an alternative example, policies can be prioritized according to whether or not a particular policy involves usage of instantaneous location-based information from a user's mobile device. For example, a predetermined priority consideration sequence would assign a higher priority to policies involving a user's mobile device. An exemplary scenario wherein such a priority consideration is accorded is explained below.

For example, an exemplary rule 1 (in policy table 2810) could indicate turning off PC's in an Atlanta facility between 7 pm and 7 am. However, another exemplary rule 5 in the policy table 2810 could indicate John Doe's office PC is controlled by John Doe's mobile phone. It can also be seen that actions and conditions comprising rules 1 and 5 are specified in tables 2811 and 2813.

Table 2811 indicates various actions and conditions corresponding to rules specified in policy table 2810. For example, it is shown in table 2811 that conditions corresponding to a rule in policy table 2810 comprise the following: PC's, Atlanta facility, 7 pm, 7 am. Also, actions associated with a rule in policy table 2810 comprise the following: turn on, turn off, etc.

It can be further seen that table 2813 indicates that John Doe's office PC is to be turned off if a current location of John Doe's mobile phone is outside the active region of John Doe's mobile device, and John Doe's office PC is to be turned on if a current location of John Doe's mobile phone is inside the active region of John Doe's mobile device, and moreover, John Doe's office PC is never in hibernate power state.

So, if in an exemplary scenario, the instantaneous location of a John Doe's mobile phone indicates that John Doe's mobile phone is inside the associated active region after 7 pm and before 7 am, then John Doe's office PC will be turned on. It will be recalled that the EMS determines the active regions for a user's mobile device as well as the assets associated with a user's mobile device based on association information received by the association engine 209, as indicated previously in FIG. 20.

Continuing with FIG. 28, at step 2030, the policy engine verifies that the set of conditions in a give rule has been satisfied. In the above example, if the instantaneous location of a user's mobile device satisfies these conditions then the associated assets are turned on immediately. If the instantaneous location of a user's mobile device does not satisfy the conditions, the policy engine 212 proceeds to process the next rule by reverting back to step 2034, until all rules have been processed. In the above example, if an instantaneous location of John Doe's mobile device is outside the associated active region, then John Doe's office PC remains turned off, based on the other policy in the policy table. It will be further understood that by providing various methods of energy management for various types of devices housed in a facility, for example using on-demand, dynamic power management commands as well as using pre-stored set policies, enables individual users to set their desired preferences to manage energy and even further, an organization to easily and efficiently manage power of all its devices organization-wide.

FIG. 29 illustrates an exemplary screenshot of an association interface 2900 for creating associations between devices housed in a facility and a user's mobile device. In the screen shot shown in FIG. 29, the interface contemplates performing the association process via a registration service. It will be recalled from previous discussions that a registration service provides a method of creating associations between users' mobile devices 1601 and respective assets 104 housed in a facility. Details of the steps performed by a registration service in creating such associations were described previously in connection with FIG. 24. Also, details of steps performed by a user's mobile device were described previously in connection with FIG. 25. It will be recalled from the previous discussions that a registration service can be a stand-alone third party provider, or can be integrated with an EMS 110, wherein the registration service acts as an intermediary system for creating associations. As will occur to one of skill in the art, a registration service typically functions as a data storage for association information. In one embodiment, in addition to being stored in an EMS database 112, data identifying the devices 104 in a facility 102 are stored with the registration service. Such data can be entered by a system administrator, or by an automatic transfer from the EMS (more specifically, an EMS database.)

As shown in FIG. 29, and according to one embodiment of the present disclosure, a system user accesses a registration via the Internet using an asset 104 that is connected to or has a display interface (for example, a general purpose computer) housed in a facility. In turn, the registration service generates a registration code (or, simply a code) and displays it to the user. For example, as displayed in region 2902 of screenshot 2900, the code is 18889. As will be understood from the discussions in connection with FIG. 25, the displayed code will be subsequently entered by a user on the user's mobile device. Various instructional steps guiding the user to link the user's mobile device 1601 to an asset 104 is also shown in region 2904. For example, step 1 indicates that a user can download an app (i.e., a mobile phone application software program) that enables registration and/or remote control of a user's assets at a facility. Subsequently, at step 2 the user will register the user's mobile phone (exemplarily called MYPHONE) to the user's asset (e.g., computer).

Although the screenshot in FIG. 29 indicates that the displayed code would link a user's computer with the user's mobile phone (exemplarily indicated as MYPHONE), it will be understood that alternate embodiments of the present disclosure allow all kinds of assets (not only computers) and all kinds of users' mobile devices to be associated (linked) with each other. Further, there is no limitation on the make, brand, manufacturer or type of the assets, or users' mobile devices. It will also be understood that use of a registration service is but one way that a user's mobile device 1601 may be associated with the user's assets 104. For example, embodiments of the EMS 110 are able to automatically link a user's assets 104 to the user's mobile device 1601 upon receiving identifying information from the user relating to the user's mobile device. Such identifying information may include, for example, a MAC address of the mobile device. As will be understood and appreciated, the registration/association process shown and described herein is provided merely for illustrative purposes, and is not intended to limit the scope of the present disclosure in any way.

It is also shown in region 2906 in FIG. 29 that a user can choose between various tabs. Displayed exemplary tabs include a Welcome tab, an Opt In/Out tab, a tab pointing to a MYPHONE app, and a dashboard tab. It will be recalled that a dashboard app was discussed earlier in connection with FIGS. 11A and 11B. Further, it will be understood that Opt In/Out tab allows a system user to opt in or out of allowing remote management of devices 104 housed in a facility that are associated with a user's mobile device 1601. As recited previously, a code (for example, 18889) will be entered by a system user through an interface of a user's mobile device, in order to associate devices (for example, a user's computer, printer, lights, and other devices in the user's office) with a user's mobile phone. Details of the steps performed by a registration service in creating associations were described previously in connection with FIG. 24. Also, details of steps performed by a user's mobile device were described previously in connection with FIG. 25. A data table displaying exemplary association information is shown in FIG. 26.

Now referring to FIG. 30, a screenshot 3000 is shown of a mobile device prior to creating associations (or registration) of a user's mobile device 1601 with assets 104 housed in a facility. Specifically shown is an interface of a user's mobile device with an exemplary code 18889. Typically, and as will be understood by one of ordinary skill, a system user accesses an interface as shown in screenshot 3000 via a mobile device application program installed on the user's mobile device, or via an interface reachable through a web browser on a user's mobile device.

According to one aspect, a user enters a code in a box 3002, and subsequently clicks on a Register button 3004 that associates a user's mobile device 1601 with assets 104 housed in a facility that are to be associated with a user's mobile device. It will be recalled that such an exemplary code was displayed to an user at an earlier instance (as shown in FIG. 29). Detailed steps of a process followed by a registration service in creating associations is explained in connection with FIG. 24. Steps followed from the perspective of a mobile device in an exemplary association process for associating assets 104 with the mobile device 1601 is discussed in FIG. 25. Although the interface displayed in connection with FIG. 30 represents a mobile phone, it will be understood that various other mobile devices can be used in alternate embodiments of the present system. Such mobile devices can either have an in-built display module (for example, a monitor), or can be connected to a display module. Example of such devices include badges, user's smart cards for entry into buildings, or any other device that corresponds to location-based or proximity-based technology for performing remote power management of assets.

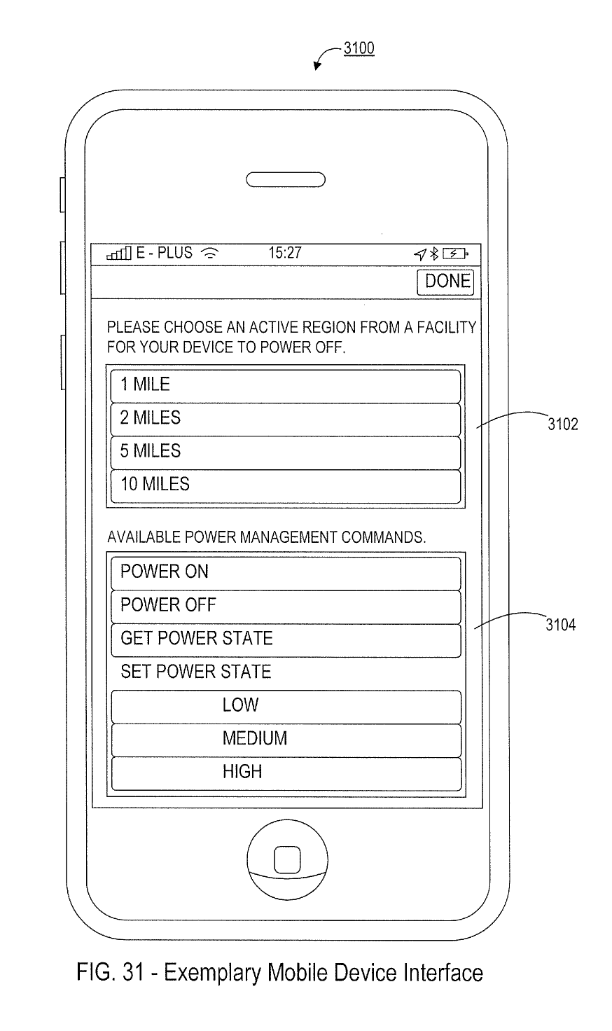

Next referring to FIG. 31, an exemplary screenshot 3100 of a user's mobile device 1601 showing various configuration options for performing remote power management of devices 104 housed in a facility based on an instantaneous location of a user's mobile device, in shown. It will be recalled that according to one aspect of the present system, information relating to a location of a user's mobile device is specified in the form of active regions. Such geographical areas comprise various spatial geometries, for example, circular active region, annular active regions with an inner and an outer radius, etc. (Exemplary active regions illustrative of various spatial geometries are shown in FIG. 18A, FIG. 18B, FIG. 18C, and FIG. 18D.) Thus, in region 3102 in FIG. 31, it is shown that a user can select an active region from a list of preset choices. For example, it can be seen that the preset choices for an active region (as measured in terms of distance from a facility) include 1 mile, 2 miles, 5 miles, 10 miles. Alternate embodiments of the present system have the functionality of allowing a user to enter an active region by typing inside a box on the interface of a user's mobile device. Even further active region selections enable a user to interactively draw or sketch certain regions on a map interface, or list them in a list format, or otherwise format various active regions as will occur to one of ordinary skill in the art.

As shown in region 3104 in FIG. 31, a user can select various power management commands to correspond to the selected active region. As will be understood, the power management commands will be then applied by the EMS on the various devices 104 that are associated with the user's mobile device 1601 when the particular active region is triggered. Also, details of steps performed by a user's mobile device in creating associations were described previously in connection with FIG. 25. A data table displaying exemplary association information is shown in FIG. 26.

Detailed steps followed by the EMS to execute power management commands (directly received on-demand from a user's mobile device, or pre-stored in the EMS) were discussed in connection with FIG. 21 (including FIG. 21A, FIG. 21B, and FIG. 21C). One example of a power management command, as shown in FIG. 31, is a POWERON command, which powers the associated electronic devices on. Another command shown is a POWEROFF to power the electronic devices off. Further, other commands can be used to retrieve information about the current power state of an electronic device (e.g., GETPOWERSTATE).

Other exemplary commands shown include those that are used to set the electronic devices to various power states, such as SETPOWERSTATE LOW (sets the power state(s) of the electronic devices to a low, but not off, power setting), SETPOWERSTATE MEDIUM (sets the power state(s) of the electronic devices to an intermediate setting), SETPOWERSTATE HIGH (sets the power state(s) of the electronic devices to a high setting), and other various commands as will occur to one of ordinary skill in the art. Yet another set of commands might retrieve various statistical or historical information from the given electronic device, for example, times at which the electronic device was powered on or powered off. As will be understood and appreciated, virtually any command relating to power management, including actual powering on or off of a device, setting intermediate power states, obtaining power information, and other similar commands are possible according to various embodiments of the present system. Although not shown in FIG. 31, it will be understood that in alternate embodiments, a user's mobile device can communicate its instantaneous location to the EMS, which then applies various rules/policies for energy management, or even, various predetermined power management commands.

In other words, in an exemplary embodiment, the EMS applies dynamic, on-demand power management commands (as exemplarily discussed in FIG. 21A, FIG. 21B, and FIG. 21C) and shown with exemplary screenshots in FIG. 31 to assets 104 in conjunction with a more static approach wherein power management is performed based on pre-stored rules/policies (as discussed exemplarily in connection with a policy engine in FIG. 20). As understood from the earlier discussions in connection with FIG. 21A, FIG. 21B, and FIG. 21C, the EMS performs power various kinds of power management policies to assets 104 based on the information received from mobile devices 1601. Steps performed by a mobile device 1601 in relation to location-based energy management of assets 104 were described previously in connection with FIG. 22 and FIG. 23. Thus, generally speaking, remote management of devices including provision of various power management commands to such devices 104 involves communicating the instantaneous physical location of a user's mobile device 1601, or information relating to the physical location of a user's mobile device 1601.

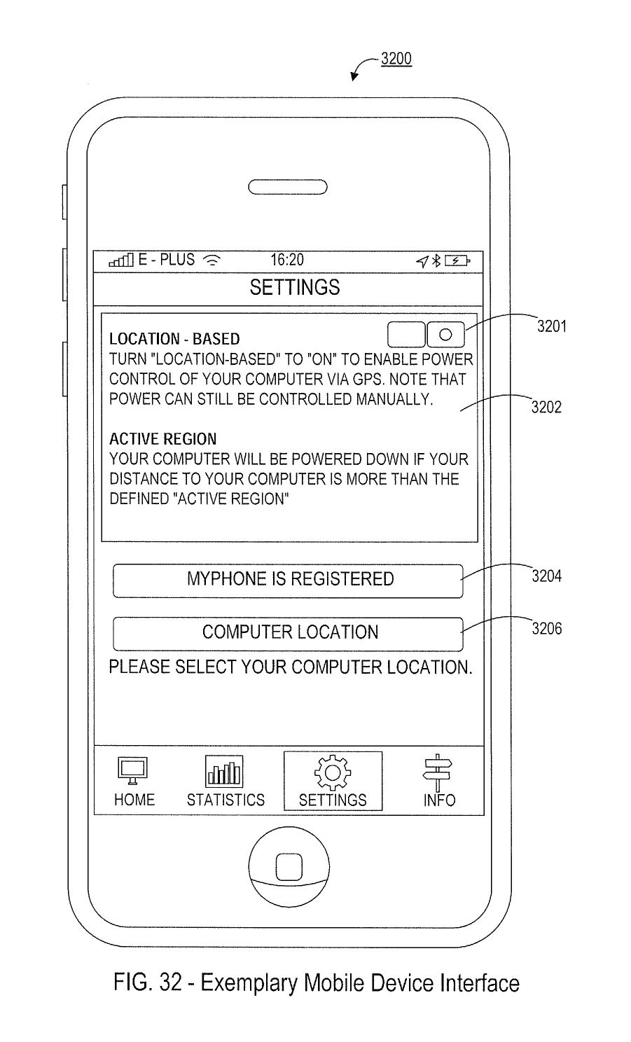

Now referring to FIG. 32, an exemplary screenshot 3200 of a user's mobile device 1601 is shown after the user's mobile device 1601 is associated with devices 104 housed in a facility. As shown in region 3202, a user can opt to turn off remote power management of devices 104 by turning a location sensor off on the user's mobile device 1601. A toggle switch 3201 for performing such functionality is displayed in region 3202 titled Location-based. If the user wants to perform remote power management of devices that are associated with a user's mobile device, then the user turns the toggle switch to an on position. Region 3202 also displays to the user a message indicating that the user's computer will be powered down if the location of the user's mobile phone is outside the defined active region (set by the user, exemplarily as shown in FIG. 31).

Additionally, it can also be seen in region 3204 in FIG. 32 that the mobile device interface displays a message to the user indicating that the user's mobile device (for example, MYPHONE) is registered with the EMS. In other words, associations linking the user's mobile device 1601 to assets 104 housed in a facility that will be managed by the user's mobile device 1601, have been created by the EMS in conjunction with the user's mobile device 1601.

Further, it can be seen in region 3206 that in one exemplary embodiment, the mobile device displays a geographical map with a location of a user's computer. Also, various tabs are displayed on the interface of the user's mobile device. For example, as shown a Home tab, a Statistics tab, a Settings tab, and an Info (Information) tab. As will be understood by one of ordinary skill, such features are typical of mobile device application programs running on users' mobile devices.

Additionally, in one embodiment, a user may simply elect to turn on, turn off, or otherwise affect the power state of the user's assets 104 at a facility via the user's mobile device 1601, regardless of the user's physical location. In such a scenario, rather than sending power management commands automatically based on the movement of a user (and his or her mobile device) within an active region, power management commands can be sent from the mobile device to an embodiment of the EMS directly by the user by simply generating such commands on the mobile device. Accordingly, a mobile device interface would include options for enabling a user to affect the power state of his or her assets on-the-fly, regardless of any location information. For example, a user may remember that he inadvertently left the lights in his office “on” over the weekend. If so, the user could simply send a command to the EMS indicating that the lights should be turned off. As will be understood and appreciated, other such manual controls are contemplated via various aspects of the present disclosure.

As recited repeatedly throughout this disclosure, embodiments of the EMS are able to communicate with varying types of electronic devices remotely via predetermined communications algorithms (e.g., device proxies). This communication often entails sending instructions to the respective devices to initiate some action with respect to the power states of the devices. It will be understood and appreciated that, in one embodiment, this control is accomplished by providing instructions to IP-enabled devices that are pre-programmed to enable remote control and functioning based on the provided instructions. As will be understood, remote control of devices can occur via any specific mechanism as will occur to one of ordinary skill in the art.

As described in detail above, aspects of the present disclosure generally relate to systems and methods for managing and monitoring a plurality of assets (in real time as well as in non-real time) using an energy management system (EMS). Additional aspects relate to easily and efficiently installing (for example, with a simple plug-and-play mechanism) an EMS to manage, monitor, and control pre-existing assets at one or more facilities. Also, aspects of the present disclosure relate to normalizing asset information across varying vendors, makes, and models of assets that are located at various geographically distributed facilities, for management of heterogeneous, distributed assets via a single interactive dashboard interface. Further, aspects of the present disclosure are directed to generating various reports containing operational information relating to the assets, actual (and projected) cost savings and greenhouse emissions based on actions taken with respect to the assets, and analytics related to energy management that are utilized by organizations (entities) and private individuals to develop strategies for optimum energy efficiency management.

In an alternate exemplary embodiment, aspects of the present disclosure relate to remote management and control of assets and of power consumed by assets located at various geographically distributed facilities on the basis of an instantaneous location of a user's mobile device. Such remote management of power consumed by assets involves changing the power state of the assets based on a location of a user's mobile device. To accomplish such functionality, periodic updates of a user's mobile device location are typically performed by a location sensor embedded in the user's mobile device and/or based on location of the user's mobile device as tracked by a third party location-service provider.

Accordingly, it will be understood that various embodiments of the present system described herein are generally implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

What is claimed is:

1. In an energy management system (EMS), a method for automatic remote power management of one or more assets located at one or more facilities based on a geographic location of a mobile device, wherein the EMS includes predefined association information indicating an association between the one or more assets located at the one or more facilities and the mobile device, the method comprising the steps of:
receiving location information at the EMS corresponding to a current geographic location of the mobile device;
identifying at least one particular asset associated with the mobile device based on the predefined association information;
determining whether action should be taken with respect to the at least one particular asset based on the received location information corresponding to the current geographic location of the mobile device; and
if it is determined that action should be taken with respect to the at least one particular asset, executing the action with respect to the at least one particular asset.

2. The method of claim 1, wherein the location information comprises spatial coordinates identifying a particular geographic location.

3. The method of claim 1, wherein the location information indicates whether or not the mobile device is within a predefined active region.

4. The method of claim 1, wherein the location information comprises a command indicating an action to be taken with respect to the at least one particular asset.

5. The method of claim 1, wherein the step of determining whether action should be taken with respect to the at least one particular asset further comprises the step of determining whether or not the mobile device is within a predefined active region.

6. The method of claim 1, wherein the step of determining whether action should be taken with respect to the at least one particular asset further comprises the step of determining whether a change in an active region state of the mobile device of the has occurred.

7. The method of claim 1, wherein the step of determining whether action should be taken with respect to the at least one particular asset further comprises the steps of:
retrieving one or more predetermined policies relating to the at least one particular asset; and
determining whether the one or more predetermined policies have been satisfied based on the location information.

8. The method of claim 1, wherein the step of executing the action with respect to the at least one particular asset further comprises one or more of the following: transmitting a power management command to the at least one particular asset, modifying or changing the power state of the at least one particular asset, retrieving power state information from the at least one particular asset, notifying an EMS administrator that a change in power state has occurred with respect to the at least one particular asset.

9. The method of claim 1, wherein the location information is transmitted to the EMS by the mobile device via an application program running on the mobile device.

10. The method of claim 1, wherein the location information is obtained via a location sensor embedded in the mobile device that communicates with the application program running on the mobile device.

11. The method of claim 1, wherein the location information is obtained from one or more of the following: a third party location service provider that communicates with the mobile device, RFID and near-field sensors, mobile cell tower information, cell tower triangulation information, mobile network information, a mobile device carrier.

12. The method of claim 1, wherein the step of executing the action with respect to the at least one particular asset relies on asset information or current energy consumption information for the at least one particular asset.

13. The method of claim 1, wherein the predefined association information is generated via the use of a registration service that provides a unique code corresponding to a unique association between the mobile device and the one or more assets.

14. The method of claim 1, wherein the predefined association information is generated automatically after an initial communication between the mobile device and the EMS.

15. In a mobile device, a method for automatic remote power management of one or more assets located at one or more facilities based on a geographic location of a mobile device, wherein the mobile device is in wireless communications with an energy management system (EMS) that includes operative connections with the one or more assets, comprising the steps of:
identifying a current physical location of the mobile device;
retrieving active region parameters indicating one or more predefined active regions relating to the mobile device, wherein each active region defines a geographic boundary that corresponds to one or more actions to be taken with respect to the one or more assets based on the location of the mobile device;
determining whether the active region parameters are satisfied based on the current physical location of the mobile device;
if the active region parameters are satisfied, retrieving commands corresponding to the one or more actions to be taken with respect to the one or more assets; and
transmitting the commands to the EMS to perform the corresponding one or more actions with respect to the one or more assets.

16. The method of claim 15, wherein the step of determining whether the active region parameters are satisfied based on the current physical location of the mobile device further comprises the steps of:
identifying a current active region state for the mobile device corresponding to whether or not the mobile device is currently within an active region;
retrieving a previous active region state for the mobile device indicating whether or not the mobile device was previously within the active region;
comparing the current active region state to the previous active region state; and
if the current active region state is different from the previous active region state, providing an indication that the active region parameters are satisfied.

17. The method of claim 15, wherein the EMS includes predefined association information indicating an association between the one or more assets located at the one or more facilities and the mobile device to enable action to be taken with respect to appropriate assets.

18. The method of claim 15, wherein the one or more actions are selected from the group comprising: transmitting power management commands to the one or more assets, modifying or changing the power states of the one or more assets, retrieving power state information from the one or more assets, notifying an EMS administrator that a change in power state has occurred with respect to the one or more assets.

19. The method of claim 18, wherein the power management commands are selected from the group comprising: power on, power off, initiate hibernate mode, initiate standby mode, initiate startup mode, initiate shutdown mode, initiate reduced power mode, initiate idle mode, initiate charging mode, query current power state.

20. In a mobile device, a method for automatic remote power management of one or more assets located at one or more facilities based on a geographic location of a mobile device, wherein the mobile device is in wireless communications with an energy management system (EMS) that includes operative connections with the one or more assets, comprising the steps of:
determining an instantaneous location of a user's mobile device;
retrieving association information comprising one or more active regions identifying geographical areas that, when the user's mobile device is located therein, indicate one or more actions to be taken with respect to the one or more assets; and
in the event that the instantaneous location is within an active region, transmitting to the EMS information relating to the instantaneous location of the user's mobile device,
whereby the EMS applies various predefined power management commands to the one or more assets corresponding to the one or more actions associated with the active region.

21. The method of claim 20, wherein information relating to the instantaneous location of the user's mobile device comprises one or more the other of the following: a current physical location of the user's mobile device, an indication of whether or not the instantaneous location falls within the active region.
